(19) United States
(12) Patent Application Publication
(10) Pub. No.: US 2025/0016841 A1
(43) Pub. Date: Jan. 9, 2025

(54) METHOD AND APPARATUS FOR HANDLING RANDOM ACCESS IN NTN IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW)

(21) Appl. No.: 18/760,834

(22) Filed: Jul. 1, 2024

Related U.S. Application Data
(60) Provisional application No. 63/525,561, filed on Jul. 7, 2023.
(60) Provisional application No. 63/525,564, filed on Jul. 7, 2023.
(60) Provisional application No. 63/525,566, filed on Jul. 7, 2023.
(60) Provisional application No. 63/527,507, filed on Jul. 18, 2023.

(51) Int. Cl. H04W 74/0833; H04W 84/06

(52) U.S. Cl. CPC H04W 74/0833; H04W 84/06

(57) ABSTRACT

Methods, systems, and apparatuses are provided for handling Random Access (RA) in Non-Terrestrial Networks (NTN) in a wireless communication system, with a method of a User Equipment (UE) comprising initiating a RA procedure in a first cell, determining, in response to initiating the RA procedure, whether second type RA resources are available, and during the RA procedure, in response to determining that Global Navigation Satellite System (GNSS) status of the UE is not qualified: the second type RA resources are selected for the RA procedure if the second type RA resources are available, or cell selection or reselection is performed if the second type RA resources are not available.

### CROSS-REFERENCE TO RELATED APPLICATIONS

The present application claims priority to and the benefit of U.S. Provisional Patent Application Ser. No. 63/525,561, filed Jul. 7, 2023, U.S. Provisional Patent Application Ser. No. 63/525,564, filed Jul. 7, 2023, U.S. Provisional Patent Application Ser. No. 63/525,566, filed Jul. 7, 2023, and U.S. Provisional Patent Application Ser. No. 63/527,507, filed Jul. 18, 2023; with each of these referenced applications and disclosures full incorporated herein by reference.

### FIELD

This disclosure generally relates to wireless communication networks and, more particularly, to a method and apparatus for handling random access in NTN in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling Random Access (RA) in Non-Terrestrial Networks (NTN) in a wireless communication system such that a User Equipment (UE) with Global Navigation Satellite System (GNSS) capability could perform a RA procedure and/or fallback action under some conditions, e.g., based on validity of GNSS. The UE could handle the inconsistent knowledge of GNSS capability between the UE and a Network (NW). The coexistence between the UE with and without GNSS could be supported in NTN. The UE could access cells based on GNSS capabilities. The non-GNSS UE could be supported in NTN with resource efficiency. The RA resources usage could be handled between the GNSS UE and the non-GNSS UE. The UE could maintain a Timing Advance (TA) value without GNSS operation. A GNSS-less UE could know its location, acquire a TA parameter (e.g., N_{TA,adj}^{UE}), maintain its full TA value (e.g., T_{TA}), and/or perform UL transmission in NTN.

Methods, systems, and apparatuses are provided for handling random access in NTN in a wireless communication system, with a method of a UE comprising initiating a RA procedure in a first cell, determining, in response to initiating the RA procedure, whether second type RA resources are available, and during the RA procedure, in response to determining that GNSS status of the UE is not qualified: the second type RA resources are selected for the RA procedure if the second type RA resources are available, or cell selection or reselection is performed if the second type RA resources are not available.

In various embodiments, a method of a UE comprises receiving first type RA resources and second type RA resources from a network, initiating an RA procedure, selecting, in response to initiating the RA procedure, the first type RA resources based on GNSS status of the UE being qualified, determining, during the RA procedure, that the GNSS status of the UE becomes not qualified, and in response to the determination that the GNSS status of the UE becomes not qualified: stopping the RA procedure, initiating or reinitiating the RA procedure, and/or selecting or reselecting the second type RA resources.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 16.14.2.1-1: Illustration of timing relationship (for collocated gNB and NTN Gateway), from 3GPP TS 38.300 V 17.5.0, “NR, NR and NG-RAN Overall Description, Stage 2”.

FIG. 6 is a reproduction of FIG. 5.3.7.1-1: RRC connection re-establishment, successful, from 3GPP TS 38.331 V 17.5.0, “NR, RRC protocol specification”.

FIG. 7 is a reproduction of FIG. 5.3.7.1-2: RRC re-establishment, fallback to RRC establishment, successful, from 3GPP TS 38.331 V 17.5.0, “NR, RRC protocol specification”.

FIG. 8 is a reproduction of FIG. 4.3.1-1: Uplink-downlink timing relation, from 3GPP TS 38.211 V 17.5.0, “NR, Physical channels and modulation”.

FIG. 9 is a flow diagram of a method of a UE comprising receiving an RRC message comprising first type RA resources from a network, and, in response to receiving the RRC message, determining to use the first type RA resources based on a first condition not being fulfilled and determining to perform a fallback action based on a first condition being fulfilled, in accordance with embodiments of the present invention.

FIG. 10 is a flow diagram of a method of a UE comprising initiating an RA procedure in a first cell, determining, in response to initiating the RA procedure, whether second type RA resources are available, and during the RA procedure, in response to determining that GNSS status of the UE is not qualified, in accordance with embodiments of the present invention.

FIG. 11 is a flow diagram of a method of a UE comprising receiving first type RA resources and second type RA resources from a network, initiating an RA procedure, selecting, in response to initiating the RA procedure, the first type RA resources based on GNSS status of the UE being qualified, determining, during the RA procedure, that the GNSS status of the UE becomes not qualified, and in response to the determination that the GNSS status of the UE becomes not qualified: stopping the RA procedure, initiating or reinitiating the RA procedure, and/or selecting or reselecting the second type RA resources, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TR 38.821 V 16.1.0, “Solutions for NR to support non-terrestrial networks (NTN)”; [2] 3GPP TS 38.300 V 17.5.0, “NR, NR and NG-RAN Overall Description, Stage 2”; [3] 3GPP TS 38.321 V 17.5.0, “NR, MAC protocol specification”; [4]3GPP TS 38.331 V 17.5.0, “NR, RRC protocol specification”; [5] R2-2306951, “Running CR for R18 IoT NTN”; [6] R2-2306962, “Stage-3 running CR for TS 36.321 for Rel-18 IoT-NTN”; [7] R2-2306954, “Running CR—Introduction of IoT NTN enhancements”; [8] 3GPP TS 38.304 V 17.5.0, “NR, UE procedures in Idle mode and RRC Inactive state”; [9] 3GPP TS 38.213 V 17.5.0, “NR, Physical layer procedures for control”; [10] 3GPP TS 38.211 V 17.5.0, “NR, Physical channels and modulation”; [11] 3GPP TS 38.305 V 17.5.0, “NG-RAN, Stage 2 functional specification of UE positioning in NG-RAN”; and [12] 3GPP TS 36.331 V 17.5.0, “E-UTRA, RRC protocol specification”. The standards and documents listed above are hereby expressly and fully incorporated herein by reference in their entirety.

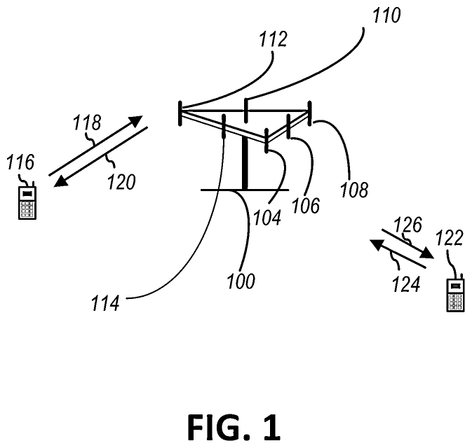

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

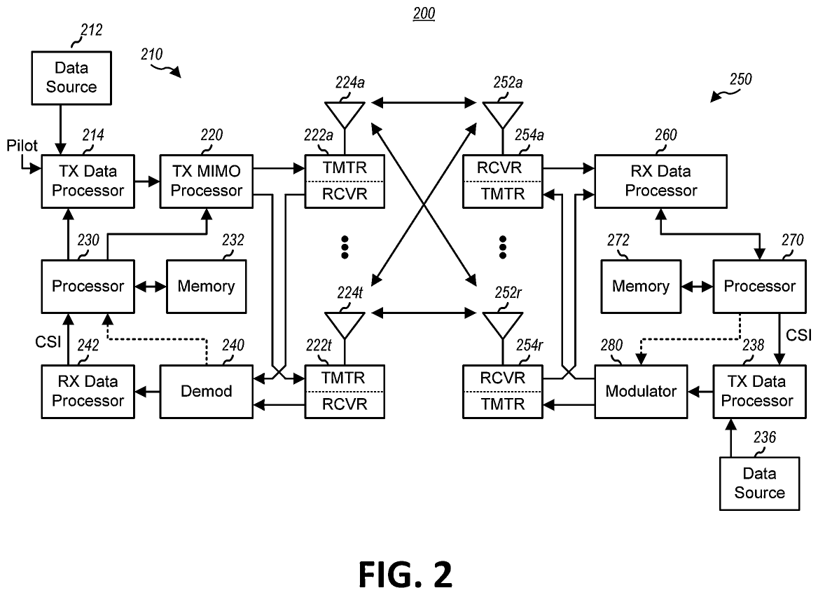

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

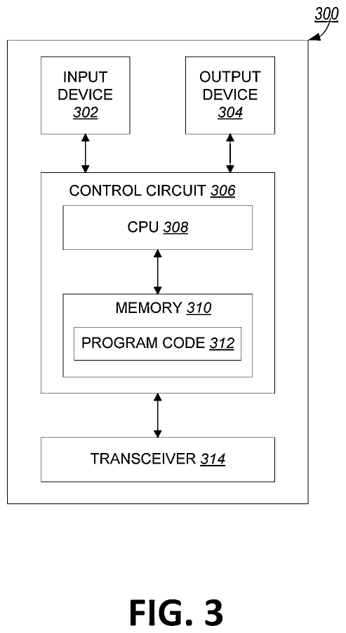

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

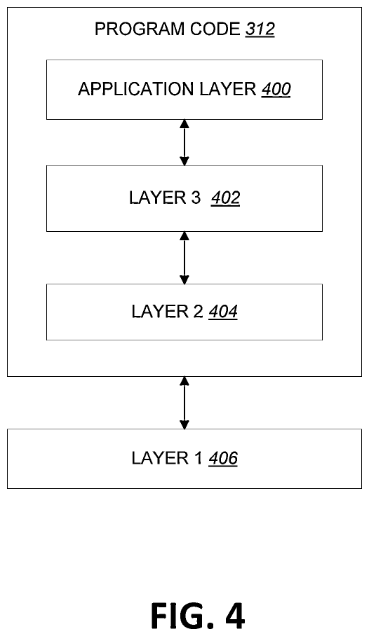

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The general description of NR non-terrestrial networks (NTN) in 3GPP release 17 is specified in TS 38.300 ([2] 3GPP TS 38.300 V 17.5.0, “NR, NR and NG-RAN Overall Description, Stage 2”) as below:

### Quotation Start [2]

### 16.14 Non-Terrestrial Networks

### 16.14.1 Overview

. . .

Three types of service links are supported:
Earth-fixed: provisioned by beam(s) continuously covering the same geographical areas all the time (e.g., the case of GSO satellites);
Quasi-Earth-fixed: provisioned by beam(s) covering one geographic area for a limited period and a different geographic area during another period (e.g., the case of NGSO satellites generating steerable beams);
Earth-moving: provisioned by beam(s) whose coverage area slides over the Earth surface (e.g., the case of NGSO satellites generating fixed or non-steerable beams).

With NGSO satellites, the gNB can provide either quasi-Earth-fixed service link or Earth-moving service link, while gNB operating with GSO satellite can provide Earth fixed service link.

In this release, the UE supporting NTN is GNSS-capable.

### 16.14.2 Timing and Synchronization

### 16.14.2.1 Scheduling and Timing

DL and UL are frame aligned at the uplink time synchronization reference point (RP) with an offset given by N_{TA,offset} (see clause 4.2 of TS 38.213).

To accommodate the propagation delay in NTNs, several timing relationships are enhanced by a Common Timing Advance (Common TA) and two offsets K_{offset} and k_{mac}:
Common TA is a configured timing offset that is equal to the RTT between the RP and the NTN payload.
K_{offset} is a configured scheduling offset that needs to be larger or equal to the sum of the service link RTT and the Common TA.
k_{mac} is a configured offset that is approximately equal to the RTT between the RP and the gNB.

The scheduling offset K_{offset} is used to allow the UE sufficient processing time between a downlink reception and an uplink transmission, see TS 38.213.

The offset k_{mac} is used to delay the application of a downlink configuration indicated by a MAC CE command on PDSCH, see TS 38.213, and in estimation of UE-gNB RTT, see TS 38.321. It may be provided by the network when downlink and uplink frame timing are not aligned at gNB. The k_{mac} is also used in the random access procedure, to determine the start time of RAR window/MsgB window after a Msg1/MsgA transmission (see TS 38.213).

The Service link RTT, Feeder link RTT, RP, Common TA, k_{mac} and T_{TA} (see clause 16.14.2.2) are illustrated in FIG. 16.14.2.1-1.

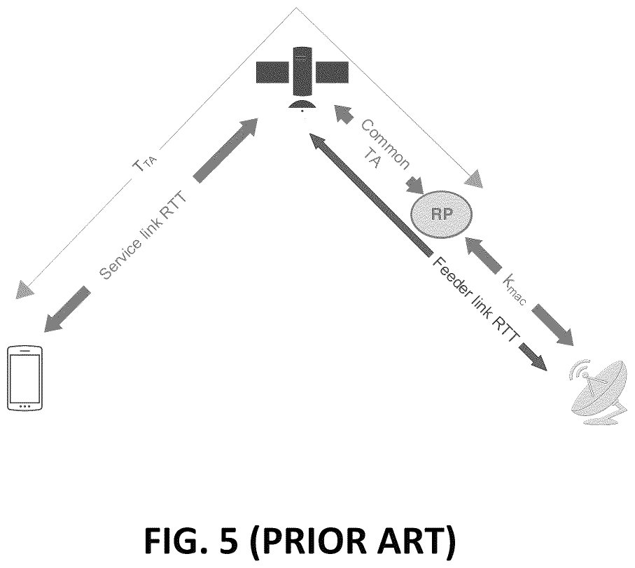

FIG. 5 is a Reproduction of FIG. 16.14.2.1-1: Illustration of Timing Relationship (for Collocated gNB and NTN Gateway), from 3GPP TS 38.300 V 17.5.0, “NR, NR and NG-RAN Overall Description, Stage 2”.

. . .

### 16.14.2.2 Timing Advance and Frequency Pre-Compensation

For the serving cell, the network broadcast valid ephemeris information and Common TA parameters. The UE shall have valid GNSS position as well as ephemeris and Common TA before connecting to an NTN cell. To achieve synchronisation, before and during connection to an NTN cell, the UE shall compute the RTT between UE and the RP based on the GNSS position, the ephemeris, and the Common TA parameters (see clause 4.2 in TS 38.213), and autonomously pre-compensate the T_{TA} for the RTT between the UE and the RP as illustrated in FIG. 16.14.2.1-1 (see clause 4.3 of TS 38.211).

The UE shall compute the frequency Doppler shift of the service link, and autonomously pre-compensate for it in the uplink transmissions, by considering UE position and the ephemeris. If the UE does not have a valid GNSS position and/or valid ephemeris and Common TA, it shall not transmit until both are regained.

In connected mode, the UE shall be able to continuously update the Timing Advance and frequency pre-compensation. The UE may be configured to report Timing Advance during Random Access procedures or in connected mode. In connected mode, event-triggered reporting of the Timing Advance is supported.

### Quotation End

In NTN, the NW could provide NTN information and/or NTN configuration to the UE as specified in TS 38.331 ([4] 3GPP TS 38.331 V 17.5.0, “NR, RRC protocol specification”):

### Quotation Start [4]

### NTN-Config

The IE NTN-Config provides parameters needed for the UE to access NR via NTN access.

NTN-Config information element

| | |
|---|---|
| NTN-Config-r17 | SEQUENCE { |
| epochTime-r17 | EpochTime-r17 |

OPTIONAL, -- Need R

| | |
|---|---|
| ntn-UISyncValidityDuration-r17 | ENUMERATED{ s5, s10, s15, s20, s25, s30, s35, |
| | s40, s45, s50, s55, s60, s120, s180, s240, s900} |

OPTIONAL, -- Cond SIB19

| | |
|---|---|
| cellSpecifickoffset-r17 | INTEGER(1..1023) |

OPTIONAL, -- Need R

| | |
|---|---|
| kmac-r17 | INTEGER(1..512) |

OPTIONAL, -- Need R

| | |
|---|---|
| ta-Info-r17 | TA-Info-r17 |

OPTIONAL, -- Need R

| | |
|---|---|
| ntn-PolarizationDL-r17 | ENUMERATED {rhcp,lhcp,linear} |

OPTIONAL, -- Need R

| | |
|---|---|
| ntn-PolarizationUL-r17 | ENUMERATED {rhcp,lhcp,linear} |

OPTIONAL, -- Need R

| | |
|---|---|
| ephemerisInfo-r17 | EphemerisInfo-r17 |

OPTIONAL, -- Need R

| | |
|---|---|
| ta-Report-r17 | ENUMERATED {enabled} |

OPTIONAL, -- Need R
...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |

OPTIONAL, -- Need R

| | |
|---|---|
| ta-CommonDriftVariant-r17 | INTEGER(0..28949) |

OPTIONAL -- Need R
}
NTN-Config field descriptions
Ephemerisinfo
This field provides satellite ephemeris either in format of position and velocity state vector or in format of orbital
parameters. This field is excluded when determining changes in system information, i.e. changes to ephemerisInfo
should neither result in system information change notifications nor in a modification of valueTag in SIB1.
epoch Time
Indicate the epoch time for the NTN assistance information. When explicitly provided through SIB, or through dedicated
signaling, the EpochTime is the starting time of a DL sub-frame, indicated by a SFN and a sub-frame number signaled
together with the assistance information. For serving cell, the field sfn indicates the current SFN or the next upcoming
SFN after the frame where the message indicating the epochTime is received. For neighbour cell, the sfn indicates the
SFN nearest to the frame where the message indicating the epoch Time is received. The reference point for epoch time
of the serving or neighbour NTN payload ephemeris and Common TA parameters is the uplink time synchronization
reference point. If this field is absent, the epoch time is the end of SI window where this SIB19 is scheduled. This field is
mandatory present when ntn-Config is provided in dedicated configuration. If this field is absent in ntn-Config provided
via NTN-NeighCellConfig the UE uses epoch time of the serving cell, otherwise the field is based on the timing of the
serving cell, i.e. the SFN and sub-frame number indicated in this field refers to the SFN and sub-frame of the serving cell.
In case of handover or conditional handover, this field is based on the timing of the target cell, i.e. the SFN and sub-
frame number indicated in this field refers to the SFN and sub-frame of the target cell. For the target cell the UE
considers epoch time, indicated by the SFN and sub-frame number in this field, to be the frame nearest to the frame in
which the message indicating the epoch time is received. This field is excluded when determining changes in system
information, i.e. changes to epochTime should neither result in system information change notifications nor in a
modification of value Tag in SIB1.
cellSpecificKoffset
Scheduling offset used for the timing relationships that are modified for NTN (see TS 38.213). The unit of the field
K_offset is number of slots for a given subcarrier spacing of 15 kHz. If the field is absent UE assumes value 0.
kmac
Scheduling offset provided by network if downlink and uplink frame timing are not aligned at gNB. If the field is absent UE
assumes value 0. In FR1, the unit of kmac is number of slots for a given subcarrier spacing of 15 kHz.
ntn-UISyncValidityDuration
A validity duration configured by the network for assistance information (i.e. Serving and/or neighbour satellite ephemeris
and Common TA parameters) which indicates the maximum time duration (from epoch Time) during which the UE can
apply assistance information without having acquired new assistance information.
The unit of ntn-UISync ValidityDuration is second. Value s5 corresponds to 5 s, value s10 indicate 10 s and so on. This
parameter applies to both connected and idle mode UEs. If this field is absent in ntn-Config provided via NTN-
NeighCellConfig, the UE uses validity duration from the serving cell assistance information. This field is excluded when
determining changes in system information, i.e. changes of ntn-UISyncValidityDuration should neither result in system
information change notifications nor in a modification of value Tag in SIB1. ntn-UISyncValidityDuration is only updated
when at least one of epochTime, ta-Info, ephemerisInfo is updated.
ta-Common
Network-controlled common timing advanced value and it may include any timing offset considered necessary by the
network. ta-Common with value of 0 is supported. The granularity of ta-Common is 4.072 × 10\hat{ }(−3) μs. Values are given
in unit of corresponding granularity. This field is excluded when determining changes in system information, i.e. changes
of ta-Common should neither result in system information change notifications nor in a modification of value Tag in SIB1.
ta-CommonDrift
Indicate drift rate of the common TA. The granularity of ta-CommonDrift is 0.2 × 10\hat{ }(−3) μs/s. Values are given in unit of
corresponding granularity. This field is excluded when determining changes in system information, i.e. changes of ta-
CommonDrift should neither result in system information change notifications nor in a modification of valueTag in SIB1.
ta-CommonDriftVariant
Indicate drift rate variation of the common TA. The granularity of ta-CommonDriftVariant is 0.2 × 10\hat{ }(−4) μs/s\hat{ }2.
Values are given in unit of corresponding granularity. This field is excluded when determining changes in system information,
i.e. changes of ta-CommonDriftVariant should neither result in system information change notifications nor in a modification
of value Tag in SIB1.
ta-Report
When this field is included in SIB19, it indicates reporting of timing advanced is enabled during Random Access due to
RRC connection establishment or RRC connection resume, and during RRC connection reestablishment. When this field
is included in ServingCellConfigCommon within dedicated signalling, it indicates TA reporting is enabled during Random
Access due to reconfiguration with sync (see TS 38.321, clause 5.4.8).

### Quotation End

In release 18 IoT NTN, the UE does not initiate an RRC connection if the GNSS position is invalid. The enhancements on GNSS operation are introduced for IoT NTN as described in running CRs of TS 36.300 ([5] R2-2306951, “Running CR for R18 IoT NTN”), TS 36.321 ([6] R2-2306962, “Stage-3 running CR for TS 36.321 for Rel-18 IoT-NTN”), and TS 36.331 ([7] R2-2306954, “Running CR—Introduction of IoT NTN enhancements”):

### Quotation Start [5]

### 23.21.2.2 Timing Advance and Frequency Pre-Compensation

. . .

In connected mode, the UE shall continuously update the Timing Advance and frequency pre-compensation, and the UE can be configured to perform GNSS acquisition. While the UE is performing GNSS acquisition, RLM is suspended. In connected mode, upon outdated ephemeris and common Timing Advance, the UE shall acquire the broadcasted parameters and upon outdated GNSS position the UE shall move to idle mode. Upon completing the GNSS acquisition, the UE shall trigger remaining validity duration reporting.

Editor's Note: Besides RLM, AS operations shall be suspended and that can be captured in stage 2 unless that is sufficiently captured in stage 3 (MAC and/or RRC).

### Quotation End

### Quotation Start [6]

### 5.xx GNSS Measurement

The network may request a NB-IoT UE, a BL UE or a UE in enhanced coverage in a non-terrestrial network to perform GNSS measurement by sending the GNSS Measurement Command MAC CE described in clause 6.1.3.xx.

The MAC entity shall:
if the MAC entity receives a GNSS Measurement Command MAC CE on a Serving Cell:
   indicate to upper layers to require the UE to perform GNSS measurement.

Editor's Note: Some AS operations (e.g., DataInactivityTimer, Random Access, SR, BSR) are suspended when UE is performing GNSS measurement during the GNSS measurement gap.

### 5.yy Remaining GNSS Measurement Validity Duration Reporting

The MAC entity of a NB-IoT UE, a BL UE or a UE in enhanced coverage in a non-terrestrial network may be triggered by upper layer to report the remaining GNSS measurement validity duration upon completing the GNSS measurement.

If the Remaining GNSS measurement validity duration reporting procedure has been triggered:
if the MAC entity has UL resources allocated for new transmission for this TTI, and;
if the allocated UL resources can accommodate the Remaining GNSS Validity Duration Report MAC control element plus its subheader, as a result of logical channel prioritization:
instruct the Multiplexing and Assembly procedure to generate the Remaining GNSS Validity Duration Report MAC control element as defined in clause 6.1.3.yy.

### Quotation End

### Quotation Start [7]

### 5.3.3.4 Reception of the RRCConnectionSetup by the UE

. . .
1> set the content of RRCConnectionSetupComplete message as follows:
   . . .
   2> if the UE is connected to NTN:
      3> include gnss-validityDuration in accordance with the remaining time of the GNSS validity duration;
      3> include gnss-PositionFixDuration in accordance with the time duration required for the UE to acquire a GNSS position;

### Next Quotation

### 5.3.3.21 UE Actions Upon Indication of Out-of-Date GNSS Position

Upon indication that the GNSS position has become out-of-date while in RRC_CONNECTED, the UE shall:
1> if the UE does not support performing GNSS fix in GNSS measurement gap:
   2> perform the actions upon leaving RRC_CONNECTED as specified in 5.3.12, with release cause ‘other’.

Editor's Note: Agreement:UE can stay in RRC_CONNECTED state when current GNSS position becomes out-of-date if the UE enters a GNSS measurement gap.

### Next Quotation

### 5.3.7.5 Reception of the RRCConnectionReestablishment by the UE

. . .
1> except for a NB-IoT UE for which AS security has not been activated:
   . . .
   2> if the UE is connected to NTN:
      3> include gnss-validityDuration in accordance with the remaining time of the GNSS validity duration;
      3> include gnss-PositionFixDuration in accordance with the time duration required for the UE to acquire a GNSS position;
   . . .
1> for a NB-IoT UE for which AS security has not been activated:
   . . .
   2> if the UE is connected to NTN:
      3> include gnss-validityDuration in accordance with the remaining time of the GNSS validity duration;

### Quotation End

The description related to enhancements on GNSS independent (or GNSS-less, non-GNSS) operation is specified in TR 38.821 ([1] 3GPP TR 38.821 V 16.1.0, “Solutions for NR to support non-terrestrial networks (NTN)”) as below:

### Quotation Start [1]

### 6.3.3 Random Access

According to the simulation assumptions in Table 6.1.2-2, the performance of Rel-15 PRACH design is verified in several typical scenarios for NTN as listed in Table 6.1.2-3.

. . .

However, in case pre-compensation of timing and frequency offset is not performed at UE side for UL transmission, enhanced PRACH formats and/or preamble sequences should be supported with following options:
Option-1: A single Zadoff-Chu sequence based on larger SCS, repetition number. Additional usage of CP and Ncs can be further determined in normative work.
Option-2: A solution based on multiple Zadoff-Chu sequences with different roots.
Option-3: Gold/m-sequence as preamble sequence with additional process, e.g., modulation and transform precoding.
Option-4: A single Zadoff-Chu sequence with combination of scrambling sequence.

### Next Quotation

7.2.1.1.4 Co-Existence with Different Random Access Capabilities

### Problem Statement

If there are both UEs that have GNSS and non-GNSS capabilities and given that the random access scheme for these might be different, then it should be possible for the network to separate the resources and control access to the network given that the random access procedures and the resource may look very different.

### Possible Solution

One possible solution is for the network to be able to configure separate resources and differentiate these based on GNSS capabilities.

### Quotation End

Moreover, RA configurations are specified in TS 38.331 ([4] 3GPP TS 38.331 V 17.5.0, “NR, RRC protocol specification”) as below:

### Quotation Start [4]

### BWP-UplinkCommon

The IE BWP-UplinkCommon is used to configure the common parameters of an uplink BWP. They are “cell specific” and the network ensures the necessary alignment with corresponding parameters of other UEs. The common parameters of the initial bandwidth part of the PCell are also provided via system information. For all other serving cells, the network provides the common parameters via dedicated signalling.

BWP-UplinkCommon information element

| | |
|---|---|
| BWP-UplinkCommon ::= | SEQUENCE { |
| ... | SetupRelease { RACH-ConfigCommon } |

```
  rach-ConfigCommon
OPTIONAL, -- Need M
  ...
```

| | |
|---|---|
| msgA-ConfigCommon-r16 | SetupRelease { MsgA-ConfigCommon-r16 } |

OPTIONAL -- Cond SpCellOnly2
...

| | |
|---|---|
| additionalRACH-ConfigList-r17 | SetupRelease { AdditionalRACH-ConfigList-r17 } |

OPTIONAL, -- Cond SpCellOnly2

| | |
|---|---|
| rsrp-ThresholdMsg3-r17 | RSRP-Range |

OPTIONAL, -- Need R

| | |
|---|---|
| numberOfMsg3-RepetitionsList-r17 | SEQUENCE (SIZE (4)) OF NumberOfMsg3-Repetitions-r17 |

OPTIONAL, -- Cond Msg3Rep
...
}

| | |
|---|---|
| AdditionalRACH-ConfigList-r17 ::= | SEQUENCE (SIZE(1..maxAdditionalRACH-r17)) OF AdditionalRACH- |

Config-r17

| | |
|---|---|
| AdditionalRACH-Config-r17 ::= | SEQUENCE { |
| rach-ConfigCommon-r17 | RACH-ConfigCommon |

OPTIONAL, -- Need R

| | |
|---|---|
| msgA-ConfigCommon-r17 | MsgA-ConfigCommon-r16 |

OPTIONAL, -- Need R
. . .
}

| | |
|---|---|
| NumberOfMsg3-Repetitions-r17::= | ENUMERATED {n1, n2, n3, n4, n7, n8, n12, n16} |

BWP-UplinkCommon field descriptions
additionalRACH-ConfigList
List of feature or feature combination-specific RACH configurations, i.e. the RACH configurations configured in addition
to the one configured by rach-ConfigCommon and by msgA-ConfigCommon. The network associates all possible
preambles of an additional RACH configuration to one or more feature(s) or feature combination(s). The network does
not configure this list to have more than 16 entries. If both rach-ConfigCommon and msgA-ConfigCommon are
configured for a specific FeatureCombination, the network always provides them in the same additionalRACH-Config.
msgA-ConfigCommon
Configuration of the cell specific PRACH and PUSCH resource parameters for transmission of MsgA in 2-step random
access type procedure. The NW can configure msgA-ConfigCommon only for UL BWPs if the linked DL BWPs (same
bwp-Id as UL-BWP) are the initial DL BWPs or DL BWPs containing the SSB associated to the initial DL BWP or for
RedCap UEs DL BWPs associated with nonCellDefiningSSB or the RedCap-specific initial downlink BWP.
rach-ConfigCommon
Configuration of cell specific random access parameters which the UE uses for contention based and contention free
random access as well as for contention based beam failure recovery in this BWP. The NW configures SSB-based RA
(and hence RACH-ConfigCommon) only for UL BWPs if the linked DL BWPs (same bwp-Id as UL-BWP) are the initial DL
BWPs or DL BWPs containing the SSB associated to the initial DL BWP or for RedCap UEs DL BWPs associated with
nonCellDefiningSSB or the RedCap-specific initial downlink BWP. The network configures rach-ConfigCommon,
whenever it configures contention free random access (for reconfiguration with sync or for beam failure recovery). For
RedCap-specific initial uplink BWP, rach-ConfigCommon is always configured when msgA-ConfigCommon is configured
in this BWP.

### Next Quotation

### CellGroupConfig

The CellGroupConfig IE is used to configure a master cell group (MCG) or secondary cell group (SCG) . . . .

CellGroupConfig information element

| CellGroupConfig ::= | SEQUENCE { |
|---|---|
| ... | |
| spCellConfig | SpCellConfig |
| OPTIONAL, -- Need M | |
| ... | |
| } | |
| SpCellConfig ::= | SEQUENCE { |
| ... | |
| reconfigurationWithSync | ReconfigurationWithSync |
| OPTIONAL, -- Cond ReconfWithSync | |
| ... | |
| } | |
| ReconfigurationWithSync ::= | SEQUENCE { |
| ... | |
| rach-ConfigDedicated | CHOICE { |
| uplink | RACH-ConfigDedicated, |
| supplementaryUplink | RACH-ConfigDedicated |

```
  }
OPTIONAL, -- Need N
  ...
}
...
```

Reconfiguration WithSync field descriptions
rach-ConfigDedicated
Random access configuration to be used for the reconfiguration with sync (e.g. handover). The UE performs the RA
according to these parameters in the firstActiveUplinkBWP (see UplinkConfig).

### Next Quotation

### MsgA-ConfigCommon

The IE MsgA-Config Common is used to configure the PRACH and PUSCH resource for transmission of MsgA in 2-step random access type procedure.

### MsgA-ConfigCommon Information Element

| | |
|---|---|
| MsgA-ConfigCommon-r16 ::= | SEQUENCE { |
| rach-ConfigCommonTwoStepRA-r16 | RACH-ConfigCommonTwoStepRA-r16, |
| msgA-PUSCH-Config-r16 | MsgA-PUSCH-Config-r16 |

OPTIONAL -- Cond InitialBWPConfig
}
MsgA-ConfigCommon field descriptions
msgA-PUSCH-Config
Configuration of cell-specific MsgA PUSCH parameters which the UE uses for contention-based MsgA PUSCH
transmission of this BWP. If the field is not configured for the selected UL BWP, the UE shall use the MsgA PUSCH
configuration of initial UL BWP.
rach-ConfigCommon TwoStepRA
Configuration of cell specific random access parameters which the UE uses for contention based and contention free 2-
step random access type procedure as well as for 2-step RA type contention based beam failure recovery in this BWP.

### Next Quotation

### RACH-ConfigCommon

RACH-ConfigCommon information element

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S

| | |
|---|---|
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |
| ra-Msg3SizeGroupA | ENUMERATED {b56, b144, b208, b256, b282, b480, b640, |
| | b800, b1000, b72, spare6, spare5, spare4, |

spare3, spare2, spare1},

| | |
|---|---|
| messagePowerOffsetGroupB | ENUMERATED { minusinfinity, dB0, dB5, dB8, dB10, dB12, |

dB15, dB18},

| | |
|---|---|
| numberOfRA-PreamblesGroupA | INTEGER (1..64) |

}
OPTIONAL, -- Need R

| | |
|---|---|
| ra-ContentionResolutionTimer | ENUMERATED { sf8, sf16, sf24, sf32, sf40, sf48, sf56, |

sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-Root Sequence Index | CHOICE { |
| 1839 | INTEGER (0..837), |
| 1139 | INTEGER (0..137) |

},

| | |
|---|---|
| msg1-SubcarrierSpacing | SubcarrierSpacing |

OPTIONAL, -- Cond L139
...

| | |
|---|---|
| prach-RootSequenceIndex-r16 | CHOICE { |
| l571 | INTEGER (0..569) , |
| l1151 | INTEGER (0..1149) |

```
  } OPTIONAL -- Need R
  ...
```

| | |
|---|---|
| featureCombinationPreamblesList-r17 | SEQUENCE (SIZE(1..maxFeatureCombPreamblesPerRACHResource- |

r17)) OF FeatureCombinationPreambles-r17 OPTIONAL -- Cond AdditionalRACH
}
RACH-ConfigCommon field descriptions
featureCombinationPreamblesList?
Specifies a series of preamble partitions each associated to a combination of features and 4-step RA. The network does?
not configure this list to have more than 16 entries.?
messagePowerOffsetGroupB?
Threshold for preamble selection. Value is in dB. Value minusinfinity corresponds to -infinity. Value dBO corresponds to 0?
dB, dB5 corresponds to 5 dB and so on. (see TS 38.321, clause 5.1.2)?
msg1-SubcarrierSpacing?
Subcarrier spacing of PRACH (see TS 38.211, clause 5.3.2).
... If absent, the UE applies the SCS as derived from the prach-ConfigurationIndex in RACH-ConfigGeneric (see tables
Table 6.3.3.1-1, Table 6.3.3.1-2, Table 6.3.3.2-2 and Table 6.3.3.2-3, TS 38.211 +8 16 + 9). The value also applies to
contention free random access (RACH-ConfigDedicated), to SI-request and to contention-based beam failure recovery
(CB-BFR). But it does not apply for contention free beam failure recovery (CF-BFR) (see BeamFailureRecoveryConfig).
The number of CB preambles per SSB in group A. This determines implicitly the number of CB preambles per SSB
available in group B. (see TS 38.321, clause 5.1.1). The setting should be consistent with the setting of ssb-perRACH-
OccasionAndCB-PreamblesPerSSB.
prach-RootSequenceIndex
PRACH root sequence index (see TS 38.211, clause 6.3.3.1). The value range depends on whether L+32 839 or L+32 139 or
L+32 571 or L+32 1151. The length of the root sequence corresponding with the index indicated in this IE should be consistent
with the one indicated in prach-ConfigurationIndex in the RACH-ConfigDedicated (if configured). If prach-
RootSequenceIndex-r16 is signalled, UE shall ignore the prach-RootSequenceIndex (without suffix).
ra-ContentionResolutionTimer
The initial value for the contention resolution timer (see TS 38.321, clause 5.1.5). Value sf8 corresponds to 8 subframes,
value sf16 corresponds to 16 subframes, and so on.
ra-Msg3SizeGroupA
Transport Blocks size threshold in bits below which the UE shall use a contention-based RA preamble of group A. (see
TS 38.321, clause 5.1.2).
rach-ConfigGeneric
RACH parameters for both regular random access and beam failure recovery.
rsrp-ThresholdSSB
UE may select the SS block and corresponding PRACH resource for path-loss estimation and (re)transmission based on
SS blocks that satisfy the threshold (see TS 38.213).
ssb-perRACH-OccasionAndCB-PreamblesPerSSB
The meaning of this field is twofold: the CHOICE conveys the information about the number of SSBs per RACH
occasion. Value oneEighth corresponds to one SSB associated with 8 RACH occasions, value oneFourth corresponds to
one SSB associated with 4 RACH occasions, and so on. The ENUMERATED part indicates the number of Contention
Based preambles per SSB. Value n4 corresponds to 4 Contention Based preambles per SSB, value n8 corresponds to 8
Contention Based preambles per SSB, and so on. The total number of CB preambles in a RACH occasion is given by
CB-preambles-per-SSB * max(1, SSB-per-rach-occasion). See TS 38.213.
totalNumberOfRA-Preambles
Total number of preambles used for contention based and contention free 4-step or 2-step random access in the RACH
resources defined in RACH-ConfigCommon, excluding preambles used for other purposes (e.g. for SI request). If the
field is absent, all 64 preambles are available for RA. The setting should be consistent with the setting of ssb-perRACH-
OccasionAndCB-PreamblesPerSSB, i.e. it should be a multiple of the number of SSBs per RACH occasion.
. . .

### RACH-ConfigCommonTwoStepRA

The IE RACH-ConfigCommonTwoStepRA is used to specify cell specific 2-step random-access type parameters.

RACH-ConfigCommonTwoStepRA information element

| | |
|---|---|
| RACH-ConfigCommonTwoStepRA-r16 ::= | SEQUENCE { |
| rach-ConfigGenericTwoStepRA-r16 | RACH-ConfigGenericTwoStepRA-r16, |
| msgA-TotalNumberOfRA-Preambles-r16 | INTEGER (1..63) |

OPTIONAL, -- Need S

| | |
|---|---|
| msgA-SSB-PerRACH-OccasionAndCB-PreamblesPerSSB-r16 | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| eight | INTEGER (1..8), |
| sixteen | INTEGER (1..4) |

}
OPTIONAL, -- Cond 2StepOnly

| | |
|---|---|
| msgA-CB-PreamblesPerSSB-PerSharedRO-r16 | INTEGER (1..60) |

OPTIONAL, -- Cond SharedRO

| | |
|---|---|
| msgA-SSB-SharedRO-MaskIndex-r16 | INTEGER (1..15) |

OPTIONAL, -- Need S

| | |
|---|---|
| groupB-ConfiguredTwoStepRA-r16 | GroupB-ConfiguredTwoStepRA-r16 |

OPTIONAL, -- Need S

| | |
|---|---|
| msgA-PRACH-RootSequence Index-r16 | CHOICE { |
| l839 | INTEGER (0..837), |
| l139 | INTEGER (0..137), |
| l571 | INTEGER (0..569), |
| l1151 | INTEGER (0..1149) |

}
OPTIONAL, -- Cond 2StepOnly

| | |
|---|---|
| msgA-TransMax-r16 | ENUMERATED {n1, n2, n4, n6, n8, n10, n20, |

n50, n100, n200} OPTIONAL, -- Need R

| | |
|---|---|
| msgA-RSRP-Threshold-r16 | RSRP-Range |

OPTIONAL, -- Cond 2Step4Step

| | |
|---|---|
| msgA-RSRP-ThresholdSSB-r16 | RSRP-Range |

OPTIONAL, -- Need R

| | |
|---|---|
| msgA-SubcarrierSpacing-r16 | SubcarrierSpacing |

OPTIONAL, -- Cond 2StepOnlyL139
...

| | |
|---|---|
| ra-ContentionResolutionTimer-r16 | ENUMERATED {sf8, sf16, sf24, sf32, s40, |

```
sf48, sf56, sf64} OPTIONAL, -- Cond 2StepOnly
  ...
  featureCombinationPreamblesList-r17 SEQUENCE (SIZE(1..maxFeatureCombPreamblesPerRACHResource-
r17)) OF FeatureCombinationPreambles-r17 OPTIONAL -- Cond AdditionalRACH
}
```

| | |
|---|---|
| GroupB-ConfiguredTwoStepRA-r16 ::= | SEQUENCE { |
| ra-MsgA-SizeGroupA | ENUMERATED {b56, b144, b208, b256, b282, |
| b480, b640, b800, | b1000, b72, spare6, spare5, |

spare4, spare3, spare2, spare1},

| | |
|---|---|
| messagePowerOffsetGroupB | ENUMERATED {minusinfinity, dB0, dB5, dB8, |

dB10, dB12, dB15, dB18},

| | |
|---|---|
| numberOfRA-PreamblesGroupA | INTEGER (1..64) |

}
RACH-ConfigCommonTwoStepRA field descriptions
featureCombinationPreamblesList
Specifies a series of preamble partitions each associated to a combination of features and 2-step RA. The network does
not configure this list to have more than 16 entries.
groupB-ConfiguredTwoStepRA
Preamble grouping for 2-step random access type. If the field is absent then there is only one preamble group configured
and only one msgA PUSCH configuration.
msgA-CB-PreamblesPerSSB-PerSharedRO
Number of contention-based preambles used for 2-step RA type from the non-CBRA 4-step type preambles associated
with each SSB for RO shared with 4-step type RA. . . .
msgA-PRACH-RootSequenceIndex
PRACH root sequence index. If the field is not configured in RACH-ConfigCommonTwoStepRA which is configured
directly within a BWP (i.e., not within AdditionalRACH-Config), the UE applies the value in field prach-
RootSequenceIndex in RACH-ConfigCommon in the configured BWP. If the field is absent in RACH-
ConfigCommon TwoStepRA in AdditionalRACH-Config, the UE applies the corresponding value of prach-
RootSequenceIndex in RACH-ConfigCommon in the same AdditionalRACH-Config. When both 2-step and 4-step type
random access is configured, this field is only configured for the case of separate ROs between 2-step and 4-step type
random access.
. . .
msgA-SSB-PerRACH-OccasionAndCB-PreamblesPerSSB
The meaning of this field is twofold: the CHOICE conveys the information about the number of SSBs per RACH
occasion. Value oneEight corresponds to one SSB associated with 8 RACH occasions, value oneFourth corresponds to
one SSB associated with 4 RACH occasions, and so on. The ENUMERATED part indicates the number of Contention
Based preambles per SSB. Value n4 corresponds to 4 Contention Based preambles per SSB, value n8 corresponds to 8
Contention Based preambles per SSB, and so on. The total number of CB preambles in a RACH occasion is given by
CB-preambles-per-SSB * max(1, SSB-per-rach-occasion). If the field is not configured in RACH-
ConfigCommon TwoStepRA which is configured directly within a BWP (i.e. not within AdditionalRACH-Config) and both 2-
step and 4-step are configured for the BWP, the UE applies the value in the field ssb-perRACH-OccasionAndCB-
PreamblesPerSSB in RACH-ConfigCommon. If the field is not configured in AdditionalRACH-Config and both 2-step and
4-step are configured in AdditionalRACH-Config, the UE applies the value in the field ssb-perRACH-OccasionAndCB-
PreamblesPerSSB in RACH-ConfigCommon in the same AdditionalRACH-Config. The field is not present when RACH
occasions are shared between 2-step and 4-step type random access in the BWP.
msgA-SSB-SharedRO-MaskIndex
Indicates the subset of 4-step type ROs shared with 2-step random access type for each SSB. This field is configured
when there is more than one RO per SSB. If the field is absent, and 4-step and 2-step has shared ROs, then all ROs are
shared.
msgA-SubcarrierSpacing
Subcarrier spacing of PRACH (see TS 38.211, clause 5.3.2).
. . . If the field is absent, the UE applies the SCS as derived from the msgA-PRACH-ConfigurationIndex in RACH-
ConfigGenericTwoStepRA (see tables Table 6.3.3.1-1, Table 6.3.3.1-2, Table 6.3.3.2-2 and Table 6.3.3.2-3, TS 38.211)
in case of 2-step only BWP, otherwise the UE applies the same SCS as Msg1 derived from RACH-ConfigCommon. The
value also applies to contention free 2-step random access type (RACH-ConfigDedicated).
msgA-TotalNumberOfRA-Preambles
Indicates the total number of preambles used for contention-based and contention-free 2-step random access type when
ROs for 2-step are not shared with 4-step. If the field is absent, and 2-step and 4-step does not have shared ROs, all 64
preambles are available for 2-step random access type.
msgA-TransMax
Max number of MsgA preamble transmissions performed before switching to 4-step random access (see TS 38.321,
clauses 5.1.1). This field is only applicable when 2-step and 4-step RA type are configured and switching to 4-step type
RA is supported. If the field is absent, switching from 2-step RA type to 4-step RA type is not allowed.
ra-ContentionResolutionTimer
The initial value for the contention resolution timer for fallback RAR in case no 4-step random access type is configured
(see TS 38.321, clause 5.1.5). Value sf8 corresponds to 8 subframes, value sf16 corresponds to 16 subframes, and so
on. If both 2-step and 4-step random access type resources are configured on the BWP, then this field is absent. If the
field is absent in RACH-ConfigCommonTwoStepRA in AdditionalRACH-Config, the UE shall apply the corresponding
value in RACH-ConfigCommon in the same AdditionalRACH-Config.
rach-ConfigGenericTwoStepRA
2-step random access type parameters for both regular random access and beam failure recovery.
. . .

### RACH-ConfigDedicated

The IE RACH-ConfigDedicated is used to specify the dedicated random access parameters.

RACH-ConfigDedicated information element

| | |
|---|---|
| RACH-ConfigDedicated ::= | SEQUENCE { |
| cfra | CFRA |

OPTIONAL, -- Need S

| | |
|---|---|
| ra-Prioritization | RA-Prioritization |

OPTIONAL, -- Need N
...,

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

OPTIONAL -- Need S
}

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

```
    }
  },
  totalNumberOfRA-Preambles INTEGER (1..63)
OPTIONAL -- Cond Occasions
}
```

| | |
|---|---|
| CFRA-TwoStep-r16 ::= | SEQUENCE { |
| occasionsTwoStepRA-r16 | SEQUENCE { |
| rach-ConfigGenericTwoStepRA-r16 | RACH-ConfigGenericTwoStepRA-r16, |
| ssb-PerRACH-OccasionTwoStepRA-r16 | ENUMERATED {oneEighth, oneFourth, oneHalf, one, |
| | two, four, eight, sixteen} |
| } | |

OPTIONAL, -- Need S

| | |
|---|---|
| msgA-CFRA-PUSCH-r16 | MsgA-PUSCH-Resource-r16, |
| msgA-TransMax-r16 | ENUMERATED {n1, n2, n4, n6, n8, n10, n20, n50, n100, |

n200} OPTIONAL, -- Need S

| | |
|---|---|
| resourcesTwoStep-r16 | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

```
  },
  ...
}
```

| | |
|---|---|
| CFRA-SSB-Resource ::= | SEQUENCE { |
| ssb | SSB-Index, |
| ra-PreambleIndex | INTEGER (0..63), |
| msgA-PUSCH-Resource-Index-r16 | INTEGER (0..3071) OPTIONAL -- Cond 2StepCFRA |

}

| | |
|---|---|
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) OF INTEGER (0..maxRA- |

Occasions-1),

| | |
|---|---|
| ra-PreambleIndex | INTEGER (0..63), |

...
}
CFRA-CSIRS-Resource field descriptions
csi-RS
The ID of a CSI-RS resource defined in the measurement object associated with this serving cell.
ra-OccasionList
RA occasions that the UE shall use when performing CF-RA upon selecting the candidate beam identified by this CSI-
RS. The network ensures that the RA occasion indexes provided herein are also configured by prach-ConfigurationIndex
and msg1-FDM. Each RACH occasion is sequentially numbered, first, in increasing order of frequency resource indexes
for frequency multiplexed PRACH occasions; second, in increasing order of time resource indexes for time multiplexed
PRACH occasions within a PRACH slot and Third, in increasing order of indexes for PRACH slots.
CFRA field descriptions
occasions
RA occasions for contention free random access. If the field is absent, the UE uses the RA occasions configured in
RACH-ConfigCommon in the first active UL BWP.
ra-ssb-OccasionMaskIndex
Explicitly signalled PRACH Mask Index for RA Resource selection in TS 38.321. The mask is valid for all SSB resources
signalled in ssb-ResourceList.
rach-ConfigGeneric
Configuration of contention free random access occasions for CFRA. The UE shall ignore
preamble ReceivedTargetPower, preambleTransMax, powerRampingStep, ra-ResponseWindow signaled within this field
and use the corresponding values provided in RACH-ConfigCommon.
ssb-perRACH-Occasion
Number of SSBs per RACH occasion.
totalNumberOfRA-Preambles
Total number of preambles used for contention free random access in the RACH resources defined in CFRA, excluding
preambles used for other purposes (e.g. for SI request). If the field is absent but the field occasions is present, the UE
may assume all the 64 preambles are for RA. The setting should be consistent with the setting of ssb-perRACH-
Occasion, if present, i.e. it should be a multiple of the number of SSBs per RACH occasion.
CFRA-SSB-Resource field descriptions
msgA-PUSCH-Resource-Index
Identifies the index of the PUSCH resource used for MSGA CFRA. The PUSCH resource index indicates a valid PUSCH
occasion (as specified in TS 38.213, clause 8.1A) and the associated DMRS resources corresponding to a PRACH slot.
ssb
The ID of an SSB transmitted by this serving cell.
CFRA-TwoStep field descriptions
msgA-CFRA-PUSCH
PUSCH resource configuration(s) for msgA CFRA.
msgA-TransMax
Max number of MsgA preamble transmissions performed before switching to 4-step type random access (see TS 38.321,
clauses 5.1.1). This field is only applicable when 2-step and 4-step RA type are configured and switching to 4-step type
RA is supported. If the field is absent in cfra-TwoStep, switching from 2-step RA type to 4-step RA type is not allowed.
occasions TwoStepRA
RA occasions for contention free random access. If the field is absent, the UE uses the RA occasions configured in
RACH-ConfigCommonTwoStepRA in the first active UL BWP.
ra-SSB-OccasionMaskIndex
Explicitly signalled PRACH Mask Index for RA Resource selection in TS 38.321. The mask is valid for all SSB resources
signalled in ssb-ResourceList.
rach-ConfigGenericTwoStepRA
Configuration of contention free random access occasions for CFRA 2-step random access type.
ssb-PerRACH-Occasion TwoStep
Number of SSBs per RACH occasion for 2-step random access type.
RACH-ConfigDedicated field descriptions
cfra
Parameters for contention free random access to a given target cell. If this field and cfra-TwoStep are absent, the UE
performs contention based random access.
cfra-TwoStep
Parameters for contention free 2-step random access type to a given target cell. Network ensures that cfra and cfra-
TwoStep are not configured at the same time. If this field and cfra are absent, the UE performs contention based random
access. This field may only be present if msgA-ConfigCommon is configured on the BWP.
ra-prioritization
Parameters which apply for prioritized random access procedure to a given target cell (see TS 38.321, clause 5.1.1).
ra-PrioritizationTwoStep
Parameters which apply for prioritized 2-step random access type procedure to a given target cell (see TS 38.321, clause
5.1.1).
. . .

### RACH-ConfigGeneric

The IE RACH-ConfigGeneric is used to specify the random-access parameters both for regular random access as well as for beam failure recovery.

RACH-ConfigGeneric information element

| | |
|---|---|
| RACH-ConfigGeneric ::= | SEQUENCE { |
| prach-ConfigurationIndex | INTEGER (0..255) , |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER (0..15), |
| preambleReceivedTargetPower | INTEGER (−202..−60), |
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED {scf1, scf2, scf4, scf8, scf16, scf32, scf64} |

OPTIONAL, -- Need R

| | |
|---|---|
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { sl60, sl160} |

OPTIONAL, -- Need R

| | |
|---|---|
| prach-ConfigurationIndex-v1610 | INTEGER (256..262) |

OPTIONAL -- Need R
]],

| | |
|---|---|
| ra-ResponseWindow-v1700 | ENUMERATED {sl240, sl320, sl640, sl960, sl1280, |

sl1920, sl2560} OPTIONAL -- Need R
}
RACH-ConfigGeneric field descriptions
msg1-FDM
The number of PRACH transmission occasions FDMed in one time instance. (see TS 38.211, clause 6.3.3.2).
msg1-FrequencyStart
Offset of lowest PRACH transmission occasion in frequency domain with respective to PRB 0. The value is configured so
that the corresponding RACH resource is entirely within the bandwidth of the UL BWP. (see TS 38.211, clause 6.3.3.2).
powerRampingStep
Power ramping steps for PRACH (see TS 38.321, 5.1.3).
prach-ConfigurationIndex
PRACH configuration index. For prach-ConfigurationIndex configured under beamFailureRecoveryConfig, the prach-
ConfigurationIndex can only correspond to the short preamble format, (see TS 38.211, clause 6.3.3.2). If the field prach-
ConfigurationIndex-v1610 is present, the UE shall ignore the value provided in prach-ConfigurationIndex (without suffix).
preambleReceivedTargetPower
The target power level at the network receiver side (see TS 38.213, clause 7.4, TS 38.321, clauses 5.1.2, 5.1.3). Only
multiples of 2 dBm may be chosen (e.g. −202, −200, −198, . . .).
preamble TransMax
Max number of RA preamble transmission performed before declaring a failure (see TS 38.321, clauses 5.1.4, 5.1.5).
ra-ResponseWindow
Msg2 (RAR) window length in number of slots. The network configures a value lower than or equal to 10 ms when Msg2
is transmitted in licensed spectrum and a value lower than or equal to 40 ms when Msg2 is transmitted with shared
spectrum channel access (see TS 38.321, clause 5.1.4). UE ignores the field if included in SCellConfig. If ra-
ResponseWindow-v1610 or ra-Response Window-v1700 is signalled, UE shall ignore the ra-Response Window (without
suffix). The field ra-ResponseWindow-v1700 is applicable to SCS 480 kHz and SCS 960 kHz.
zeroCorrelationZoneConfig
N-CS configuration, see Table 6.3.3.1-5 in TS 38.211.

### RACH-ConfigGenericTwoStepRA

The IE RACH-ConfigGenericTwoStepRA is used to specify the 2-step random access type parameters.

RACH-ConfigGenericTwoStepRA information element

| | |
|---|---|
| RACH-ConfigGenericTwoStepRA-r16 ::= | SEQUENCE { |
| msgA-PRACH-ConfigurationIndex-r16 | INTEGER (0..262) |

OPTIONAL, -- Cond 2StepOnly

| | |
|---|---|
| msgA-RO-FDM-r16 | ENUMERATED {one, two, four, eight} |

OPTIONAL, -- Cond 2StepOnly

| | |
|---|---|
| msgA-RO-FrequencyStart-r16 | INTEGER (0..maxNrofPhysicalResourceBlocks-1) |

OPTIONAL, -- Cond 2StepOnly

| | |
|---|---|
| msgA-ZeroCorrelationZoneConfig-r16 | INTEGER (0..15) |

OPTIONAL, -- Cond 2StepOnly

| | |
|---|---|
| msgA-PreamblePowerRampingStep-r16 | ENUMERATED {dB0, dB2, dB4, dB6} |

OPTIONAL, -- Cond 2StepOnlyNoCFRA

| | |
|---|---|
| msgA-PreambleReceivedTargetPower-r16 | INTEGER (−202..−60) |

OPTIONAL, -- Cond 2StepOnlyNoCFRA

| | |
|---|---|
| msgB-ResponseWindow-r16 | ENUMERATED {sl1, sl2, sl4, sl8, sl10, sl20, sl40, sl80, |

sl160, sl320}
OPTIONAL, -- Cond NoCFRA

| | |
|---|---|
| preambleTransMax-r16 | ENUMERATED {n3, n4, n5, n6, n7, n8, n10, n20, n50, n100, |

n200} OPTIONAL, -- Cond 2StepOnlyNoCFRA
...,

| | |
|---|---|
| msgB-ResponseWindow-v1700 | ENUMERATED {sl240, sl640, sl960, sl1280, sl1920, sl2560} |

OPTIONAL -- Cond NOCFRA2
}
RACH-ConfigGenericTwoStepRA field descriptions
msgA-PreamblePowerRampingStep
Power ramping steps for msgA PRACH. If the field is absent in RACH-ConfigCommonTwoStepRA in AdditionalRACH-
Config, the UE shall apply the corresponding value in RACH-ConfigCommon in the same AdditionalRACH-Config. If the
field is absent in other cases, UE shall use the value of powerRampingStep in RACH-ConfigGeneric in the configured
BWP (see TS 38.321, 5.1.3). This field may only be present if no 4-step type RA is configured in the BWP or in the case
of separate ROs with 4-step type RA. The field is absent if RACH-ConfigGeneric TwoStepRA is included in CFRA-
TwoStep in RACH-ConfigDedicated and then the UE uses the value of msgA-PreamblePowerRampingStep in RACH-
ConfigGenericTwoStepRA configured for CBRA.
msgA-PreambleReceivedTargetPower
The target power level at the network receiver side (see TS 38.213, clause 7.1.1 and TS 38.321 [3], clause 5.1.1). Only
multiples of 2 dBm may be chosen (e.g −202, −200, −198, . . .). If the field is absent, UE shall use the value of
preambleReceivedTargetPower in RACH-ConfigGeneric in the configured BWP. This field may only be present if no 4-
step type RA is configured in the BWP. The field is absent if RACH-ConfigGenericTwoStepRA is included in CFRA-
TwoStep in RACH-ConfigDedicated and then the UE uses the value of msgA-PreambleReceivedTargetPower in RACH-
ConfigGenericTwoStepRA configured for CBRA.
msgA-PRACH-ConfigurationIndex
Cell-specific PRACH configuration index for 2-step RA type. If the field is absent in RACH-ConfigCommon TwoStepRA
which is configured directly within a BWP (i.e. not within AdditionalRACH-Config), the UE shall use the value of
corresponding 4-step random access parameter in the configured BWP. If the field is absent in RACH-
ConfigCommon TwoStepRA in AdditionalRACH-Config, the UE shall apply the corresponding value in RACH-
ConfigCommon in the same AdditionalRACH-Config. If the value is in the range of 256 to 262, the field prach-
ConfigurationIndex-v1610 should be considered configured (see TS 38.211, clause 6.3.3.2). This field may only be
present if no 4-step type RA is configured in the BWP or in the case of separate ROs with 4-step type RA.
msgA-RO-FDM
The number of msgA PRACH transmission occasions Frequency-Division Multiplexed in one time instance. If the field is
absent in RACH-ConfigCommon TwoStepRA which is configured directly within a BWP (i.e. not within AdditionalRACH-
Config), UE shall use value of msg1-FDM in RACH-ConfigGeneric in the configured BWP. If the field is absent in RACH-
ConfigCommon TwoStepRA in AdditionalRACH-Config, the UE shall apply the value of msg1-FDM in RACH-
ConfigCommon in the same AdditionalRACH-Config (see TS 38.211, clause 6.3.3.2). This field may only be present if no
4-step type RA is configured in the BWP or in the case of separate ROs with 4-step type RA.
msgA-RO-FrequencyStart
Offset of lowest PRACH transmissions occasion in frequency domain with respect to PRB 0. If the field is absent in
RACH-ConfigCommonTwoStepRA which is configured directly within a BWP (i.e. not within AdditionalRACH-Config), UE
shall use value of msg1-FrequencyStart in RACH-ConfigGeneric in the configured BWP. If the field is absent in RACH-
ConfigCommon TwoStepRA in AdditionalRACH-Config, the UE shall apply the value of msg1-FrequencyStart in RACH-
ConfigCommon in the same AdditionalRACH-Config (see TS 38.211, clauses 5.3.2 and 6.3.3.2). This field may only be
present if no 4-step type RA is configured in the BWP or in the case of separate ROs with 4-step type RA.
msgA-ZeroCorrelationZoneConfig
N-CS configuration for msgA preamble, see Table 6.3.3.1-5 in TS 38.211. If the field is absent in RACH-
ConfigCommon TwoStepRA in AdditionalRACH-Config, the UE shall apply the corresponding value in RACH-
ConfigCommon in the same AdditionalRACH-Config. If the field is absent in other cases, UE shall use value
zeroCorrelationZoneConfig in RACH-ConfigGeneric in the configured BWP. This field may only be present if no 4-step
type RA is configured in the BWP or in the case of separate ROs with 4-step type RA.
msgB-ResponseWindow
MsgB monitoring window length in number of slots. The network configures a value lower than or equal to 40 ms (see TS
38.321, clause 5.1.1). The network does not configure msgB-ResponseWindow-r16 simultaneously with msgB-
ResponseWindow-v1700, and if both fields are absent, the UE uses the value of msgB-ResponseWindow in RACH-
ConfigGeneric TwoStepRA configured for CBRA.

### Quotation End

The cell selection and reselection procedures are specified in TS 38.304 ([8] 3GPP TS 38.304 V 17.5.0, “NR, UE procedures in Idle mode and RRC Inactive state”):

### Quotation Start [8]

### 5.3.1 Cell Status and Cell Reservations

Cell status and cell reservations are indicated in the MIB or SIB1 message as specified in TS 38.331 by means of following fields:
cellBarred (IE type: “barred” or “not barred”)
Indicated in MIB message. In case of multiple PLMNs or NPNs indicated in SIB1, this field is common for all PLMNs and NPNs. This field is ignored by UEs supporting NTN while cellBarredNTN is included in SIB1.
cellBarredNTN (IE type: “barred” or “not barred”)
Indicated in SIB1 message. In case of multiple PLMNs indicated in SIB1, this field is common for all PLMNs. This field is ignored if the UE does not support NTN connectivity.
cellBarredRedCap1Rx (IE type: “barred” or “not barred”)
Indicated in SIB1 message. In case of multiple PLMNs or NPNs indicated in SIB1, this field is common for all PLMNs and NPNs. This field is only applicable to RedCap UEs.
cellBarredRedCap2Rx (IE type: “barred” or “not barred”)
Indicated in SIB1 message. In case of multiple PLMNs or NPNs indicated in SIB1, this field is common for all PLMNs and NPNs. This field is only applicable to RedCap UEs.
cellReservedForOperatorUse (IE type: “reserved” or “not reserved”)
Indicated in SIB1 message. In case of multiple PLMNs or NPNs indicated in SIB1, this field is specified per PLMN or per SNPN.
cellReservedForOtherUse (IE type: “true”)
Indicated in SIB1 message. In case of multiple PLMNs indicated in SIB1, this field is common for all PLMNs.
cellReservedForFutureUse (IE type: “true”)
Indicated in SIB1 message. In case of multiple PLMNs or NPNs indicated in SIB1, this field is common for all PLMNs and NPNs.

. . .
halfDuplexRedCapAllowed (IE type: “true”)
Indicated in SIB1 message. In case of multiple PLMNs or NPNs indicated in SIB1, this field is common for all PLMNs and NPNs. This field is only applicable to RedCap UEs.
iab-Support (IE type: “true”)
Indicated in SIB1 message. In case of multiple PLMNs or NPNs indicated in SIB1, this field is specified per PLMN or per SNPN.

When cell status is indicated as “not barred” and “not reserved” for operator use and not “true” for other use and not “true” for future use,
UEs shall treat this cell as candidate during the cell selection and cell reselection procedures.

. . . When cellBarredNTN is not broadcast in this cell,
For NTN access, the UE shall treat this cell as if cell status is “barred”.

When halfDuplexRedCapAllowed is not broadcast in this cell,
The RedCap UE only capable of operating in half-duplex for FDD shall treat this cell as if cell status is “barred”.

When cell status is indicated as “not barred” and “reserved” for operator use for any PLMN/SNPN and not “true” for other use and not “true” for future use,
UEs assigned to Access Identity 11 or 15 operating in their HPLMN/EHPLMN shall treat this cell as candidate during the cell selection and reselection procedures if the field cellReservedForOperatorUse for that PLMN set to “reserved”.
UEs assigned to Access Identity 11 or 15 shall treat this cell as candidate during the cell selection and reselection procedures if the field cellReservedForOperatorUse for selected/registered SNPN is set to “reserved”.
UEs assigned to an Access Identity 0, 1, 2 and 12 to 14 shall behave as if the cell status is “barred” in case the cell is “reserved for operator use” for the registered PLMN/SNPN or the selected PLMN/SNPN.
UEs assigned to Access Identity 3 shall behave as if the cell status is “barred” in case the cell is “reserved for operator use” for the registered PLMN or the selected PLMN.

. . .

When cell status “barred” is indicated or to be treated as if the cell status is “barred”,
The UE is not permitted to select/reselect this cell, not even for emergency calls.
The UE shall select another cell according to the following rule:
If the cell is to be treated as if the cell status is “barred” due to being unable to acquire the MIB:
   the UE may exclude the barred cell as a candidate for cell selection/reselection for up to 300 seconds.
   the UE may select another cell on the same frequency if the selection criteria are fulfilled.
else:
   . . .
   If the UE is not a RedCap UE, or if the UE is a RedCap UE and intraFreqReselectionRedCap in SIB1 is available:
      If the field intraFreqReselection in MIB message is set to “allowed”:
         the UE may select another cell on the same frequency if re-selection criteria are fulfilled;
         If the cell is to be treated as if the cell status is “barred” due to being unable to acquire the SIB1:
         the UE may exclude the barred cell as a candidate for cell selection/reselection for up to 300 seconds;
         else:
         the UE shall exclude the barred cell as a candidate for cell selection/reselection for 300 seconds.
      If the field intraFreqReselection in MIB message is set to “not allowed”:
         If the cell is to be treated as if the cell status is “barred” due to being unable to acquire the SIB1:
         the UE may exclude the barred cell as a candidate for cell selection/reselection for up to 300 seconds;
         If the cell operates in licensed spectrum:
         the UE shall not re-select to another cell on the same frequency as the barred cell and exclude such cell(s) as candidate(s) for cell selection/reselection for 300 seconds;
         else:
         the UE may select to another cell on the same frequency if the reselection criteria are fulfilled.
         else:
         If the cell operates in licensed spectrum, or if this cell belongs to a PLMN which is indicated as being equivalent to the registered PLMN or the selected PLMN of the UE, or if this cell belongs to the registered SNPN or the selected SNPN of the UE:
         the UE shall not re-select to another cell on the same frequency as the barred cell and exclude such cell(s) as candidate(s) for cell selection/reselection for 300 seconds;
         else:
         the UE may select to another cell on the same frequency if the reselection criteria are fulfilled.
         the UE shall exclude the barred cell as a candidate for cell selection/reselection for 300 seconds.

The cell selection of another cell may also include a change of RAT.

### Quotation End

Some procedures for RRC connection control (e.g., reconfiguration with sync, re-establishment) are specified in TS 38.331 ([4] 3GPP TS 38.331 V 17.5.0, “NR, RRC protocol specification”) as below:

### Quotation Start [4]

5.3.5.8.3 T304 Expiry (Reconfiguration with Sync Failure) or T420 Expiry (Path Switch Failure)

The UE shall:
1> if T304 of the MCG expires; or
1> if T420 expires; or,
1> if the target L2 U2N Relay UE (i.e., the UE indicated by targetRelayUE-Identity in the received RRCReconfiguration message containing reconfigurationWithSync indicating path switch as specified in 5.3.5.5.2) changes its serving PCell before path switch:
   2> release dedicated preambles provided in rach-ConfigDedicated if configured;
   2> release dedicated msgA PUSCH resources provided in rach-ConfigDedicated if configured;
   . . .
      3> revert back to the UE configuration used in the source PCell;
      3> if the associated T304 was not initiated upon cell selection performed while timer T311 was running, as defined in clause 5.3.7.3:
         4> store the handover failure information in VarRLF-Report as described in the clause 5.3.10.5;
      3> initiate the connection re-establishment procedure as specified in clause 5.3.7.

NOTE 1: In the context above, “the UE configuration” includes state variables and parameters of each radio bearer.

. . .
1> else if T304 expires when RRCReconfiguration is received via other RAT (HO to NR failure):
   2> reset MAC;
   2> perform the actions defined for this failure case as defined in the specifications applicable for the other RAT.

NOTE 2: In this clause, the term ‘handover failure’ has been used to refer to ‘reconfiguration with sync failure’.

### Next Quotation

### 5.3.7 RRC Connection Re-Establishment

### 5.3.7.1 General

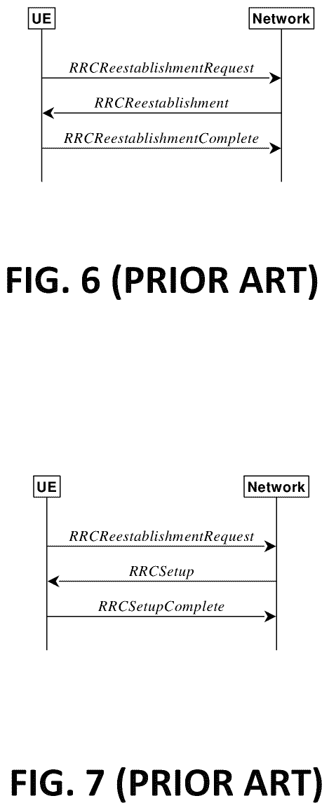

FIG. 6 is a Reproduction of FIG. 5.3.7.1-1: RRC Connection Re-Establishment, Successful, from 3GPP TS 38.331 V 17.5.0, “NR, RRC Protocol Specification”.
FIG. 7 is a Reproduction of FIG. 5.3.7.1-2: RRC Re-Establishment, Fallback to RRC Establishment, Successful, from 3GPP TS 38.331 V 17.5.0, “NR, RRC Protocol Specification”.

The purpose of this procedure is to re-establish the RRC connection. A UE in RRC_CONNECTED, for which AS security has been activated with SRB2 and at least one DRB/multicast MRB setup or, for IAB, SRB2, may initiate the procedure in order to continue the RRC connection. The connection re-establishment succeeds if the network is able to find and verify a valid UE context or, if the UE context cannot be retrieved, and the network responds with an RRCSetup according to clause 5.3.3.4.

The network applies the procedure e.g as follows:
When AS security has been activated and the network retrieves or verifies the UE context:
   to re-activate AS security without changing algorithms;
   to re-establish and resume the SRB1;
When UE is re-establishing an RRC connection, and the network is not able to retrieve or verify the UE context:
   to discard the stored AS Context and release all RBs and BH RLC channels and Uu Relay RLC channels;
   to fallback to establish a new RRC connection.

### Next Quotation

### 5.3.10.3 Detection of Radio Link Failure

The UE shall:
. . .
   2> upon T310 expiry in PCell; or
   2> upon T312 expiry in PCell; or
   2> upon random access problem indication from MCG MAC while neither T300, T301, T304, T311 nor T319 are running and SDT procedure is not ongoing; or
   2> upon indication from MCG RLC that the maximum number of retransmissions has been reached while SDT procedure is not ongoing; or
   . . .
   2> upon consistent uplink LBT failure indication from MCG MAC while T304 is not running:
      . . .
         4> consider radio link failure to be detected for the MCG, i.e. MCG RLF;
         4> discard any segments of segmented RRC messages stored according to 5.7.6.3;
         4> if AS security has not been activated:
         5> perform the actions upon going to RRC_IDLE as specified in 5.3.11, with release cause ‘other’;
         4> else if AS security has been activated but SRB2 and at least one DRB or multicast MRB or, for IAB, SRB2, have not been setup:
         5> store the radio link failure information in the VarRLF-Report as described in clause 5.3.10.5;
         5> perform the actions upon going to RRC_IDLE as specified in 5.3.11, with release cause ‘RRC connection failure’;
         4> else:
         5> store the radio link failure information in the VarRLF-Report as described in clause 5.3.10.5;
         5> if T316 is configured; and
         5> if SCG transmission is not suspended; and
         5> if the SCG is not deactivated; and
         5> if neither PSCell change nor PSCell addition is ongoing (i.e. timer T304 for the NR PSCell is not running in case of NR-DC or timer T307 of the E-UTRA PSCell is not running as specified in TS 36.331, clause 5.3.10.10, in NE-DC):
         6> initiate the MCG failure information procedure as specified in 5.7.3b to report MCG radio link failure.
         5> else:
         6> initiate the connection re-establishment procedure as specified in 5.3.7.

### Next Quotation

### 5.3.11 UE Actions Upon Going to RRC_IDLE

The UE shall:
1> reset MAC;
. . .
1> if going to RRC_IDLE was triggered by reception of the RRCRelease message including a waitTime:
   2> if T302 is running:
      3> stop timer T302;
   2> start timer T302 with the value set to the waitTime;
   2> inform upper layers that access barring is applicable for all access categories except categories ‘0’ and ‘2’.
1> else:
   2> if T302 is running:
      3> stop timer T302;
      3> perform the actions as specified in 5.3.14.4;
1> if T390 is running:
   2> stop timer T390 for all access categories;
   2> perform the actions as specified in 5.3.14.4;
1> if the UE is leaving RRC_INACTIVE:
   2> if going to RRC_IDLE was not triggered by reception of the RRCRelease message:
      3> if stored, discard the cell reselection priority information provided by the cellReselectionPriorities;
      3> stop the timer T320, if running;
   2> if T319a is running:
      3> stop timer T319a;
      3> consider SDT procedure is not ongoing;
1> stop all timers that are running except T302, T320, T325, T330, T331, T400 and T430;
1> discard the UE Inactive AS context, if any;
1> release the suspendConfig, if configured;
1> remove all the entries within the MCG and the SCG VarConditionalReconfig, if any;
1> for each measId, if the associated reportConfig has a reportType set to condTriggerConfig:
   2> for the associated reportConfigId:
      3> remove the entry with the matching reportConfigId from the reportConfigList within the VarMeasConfig;
   2> if the associated measObjectId is only associated to a reportConfig with reportType set to condTriggerConfig:
      3> remove the entry with the matching measObjectId from the measObjectList within the VarMeasConfig;
   2> remove the entry with the matching measId from the measIdList within the VarMeasConfig;
1> discard the K_{gNB} key, the S-K_{gNB} key, the S-K_{eNB} key, the K_{RRCenc} key, the K_{RRCint} key, the K_{UPint} key and the K_{UPenc} key, if any;
1> release all radio resources, including release of the RLC entity, the BAP entity, the MAC configuration and the associated PDCP entity and SDAP for all established RBs (except for broadcast MRBs), BH RLC channels, Uu Relay RLC channels, PC5 Relay RLC channels and SRAP entity;
1> indicate the release of the RRC connection to upper layers together with the release cause;
1> inform upper layers about the release of all application layer measurement configurations;
1> discard any application layer measurement reports which were not yet submitted to lower layers for transmission;
1> discard any segments of segmented RRC messages stored according to 5.7.6.3;
1> except if going to RRC_IDLE was triggered by inter-RAT cell reselection while the UE is in RRC_INACTIVE or RRC_IDLE or when selecting an inter-RAT cell while T311 was running or when selecting an E-UTRA cell for EPS fallback for IMS voice as specified in 5.4.3.5:
   . . .
      3> enter RRC_IDLE and perform cell selection as specified in TS 38.304;

### Quotation End

The RA procedure including power control is specified in TS 38.321 ([3] 3GPP TS 38.321 V 17.5.0, “NR, MAC protocol specification”) as below:

### Quotation Start [3]

5.1.1 Random Access Procedure Initialization The Random Access procedure described in this clause is initiated by a PDCCH order, by the MAC entity itself, or by RRC for the events in accordance with TS 38.300. There is only one Random Access procedure ongoing at any point in time in a MAC entity. The Random Access procedure on an SCell shall only be initiated by a PDCCH order with ra-PreambleIndex different from 0b000000.

. . .

When a Random Access procedure is initiated, UE selects a set of Random Access resources as specified in clause 5.1.1b and initialises the following parameters for the Random Access procedure according to the values configured by RRC for the selected set of Random Access resources:
prach-ConfigurationIndex: the available set of PRACH occasions for the transmission of the Random Access Preamble for Msg1. These are also applicable to the MSGA PRACH if the PRACH occasions are shared between 2-step and 4-step RA types;
. . .
msgA-PRACH-ConfigurationIndex: the available set of PRACH occasions for the transmission of the Random Access Preamble for MSGA in 2-step RA type;
preambleReceivedTargetPower: initial Random Access Preamble power for 4-step RA type;
msgA-PreambleReceivedTargetPower: initial Random Access Preamble power for 2-step RA type;
rsrp-ThresholdSSB: an RSRP threshold for the selection of the SSB for 4-step RA type. If the Random Access procedure is initiated for beam failure recovery, rsrp-ThresholdSSB used for the selection of the SSB within candidateBeamRSList refers to rsrp-ThresholdSSB in BeamFailureRecoveryConfig IE;
rsrp-ThresholdCSI-RS: an RSRP threshold for the selection of CSI-RS for 4-step RA type. If the Random Access procedure is initiated for beam failure recovery, rsrp-ThresholdCSI-RS is equal to rsrp-ThresholdSSB in BeamFailureRecoveryConfig IE;
msgA-RSRP-ThresholdSSB: an RSRP threshold for the selection of the SSB for 2-step RA type;
rsrp-ThresholdSSB-SUL: an RSRP threshold for the selection between the NUL carrier and the SUL carrier;
msgA-RSRP-Threshold: an RSRP threshold for selection between 2-step RA type and 4-step RA type when both 2-step and 4-step RA type Random Access Resources are configured in the UL BWP;
rsrp-ThresholdMsg3: an RSRP threshold for Msg3 repetition (see clause 5.1.1b);
FeatureCombination: feature or a combination of features associated with a set of Random Access resources;
. . .
candidateBeamRSList: a list of reference signals (CSI-RS and/or SSB) identifying the candidate beams for recovery and the associated Random Access parameters;
recoverySearchSpaceId: the search space identity for monitoring the response of the beam failure recovery request;
powerRampingStep: the power-ramping factor;
msgA-PreamblePowerRampingStep: the power ramping factor for MSGA preamble;
powerRampingStepHighPriority: the power-ramping factor in case of prioritized Random Access procedure;
scalingFactorBI: a scaling factor for prioritized Random Access procedure;
ra-PreambleIndex: Random Access Preamble;
ra-ssb-OccasionMaskIndex: defines PRACH occasion(s) associated with an SSB in which the MAC entity may transmit a Random Access Preamble (see clause 7.4);
msgA-SSB-SharedRO-MaskIndex: Indicates the subset of 4-step RA type PRACH occasions shared with 2-step RA type PRACH occasions for each SSB. If 2-step RA type PRACH occasions are shared with 4-step RA type PRACH occasions and msgA-SSB-SharedRO-MaskIndex is not configured, then all 4-step RA type PRACH occasions are available for 2-step RA type (see clause 7.4);
ssb-SharedRO-MaskIndex: defines PRACH occasions, on which preambles are allocated for a feature or a combination of features, associated with an SSB in which the MAC entity may transmit a Random Access Preamble (see clause 7.4);
ra-OccasionList: defines PRACH occasion(s) associated with a CSI-RS in which the MAC entity may transmit a Random Access Preamble;
ra-PreambleStartIndex: the starting index of Random Access Preamble(s) for on-demand SI request;
startPreambleForThisPartition: the first preamble associated with the set of Random Access Resources applicable to the Random Access procedure;
preambleTransMax: the maximum number of Random Access Preamble transmission;
ssb-perRACH-OccasionAndCB-PreamblesPerSSB: defines the number of SSBs mapped to each PRACH occasion for 4-step RA type and the number of contention-based Random Access Preambles mapped to each SSB;
msgA-CB-PreamblesPerSSB-PerSharedRO: defines the number of contention-based Random Access Preambles for 2-step RA type mapped to each SSB when the PRACH occasions are shared between 2-step and 4-step RA types;
msgA-SSB-PerRACH-OccasionAndCB-PreamblesPerSSB: defines the number of SSBs mapped to each PRACH occasion for 2-step RA type and the number of contention-based Random Access Preambles mapped to each SSB;
. . .
if Random Access Preambles group B is configured for 4-step RA type:
   ra-Msg3SizeGroupA: the threshold to determine the groups of Random Access Preambles for 4-step RA type;
   msg3-DeltaPreamble: Δ_{PREAMBLE_Msg3} in TS 38.213;
   messagePowerOffsetGroupB: the power offset for preamble selection included in groupBconfigured;
   numberOfRA-PreamblesGroupA: defines the number of Random Access Preambles in Random Access Preamble group A for each SSB included in groupBconfigured.
if Random Access Preambles group B is configured for 2-step RA type:
   msgA-DeltaPreamble: Δ_{MsgA_PUSCH} in TS 38.213;
   messagePowerOffsetGroupB: the power offset for preamble selection included in GroupB-ConfiguredTwoStepRA;
   numberOfRA-PreamblesGroupA: defines the number of Random Access Preambles in Random Access Preamble group A for each SSB included in GroupB-ConfiguredTwoStepRA;
   ra-MsgA-SizeGroupA: the threshold to determine the groups of Random Access Preambles for 2-step RA type.
the set of Random Access Preambles and/or PRACH occasions for SI request, if any;
the set of Random Access Preambles and/or PRACH occasions for beam failure recovery request, if any;
the set of Random Access Preambles and/or PRACH occasions for reconfiguration with sync, if any;
ra-ResponseWindow: the time window to monitor RA response(s) (SpCell only);
ra-ContentionResolutionTimer: the Contention Resolution Timer (SpCell only);
msgB-ResponseWindow: the time window to monitor RA response(s) for 2-step RA type (SpCell only).

. . .

When the Random Access procedure is initiated on a Serving Cell, the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;
1> set POWER_OFFSET_2STEP_RA to 0 dB;
. . .
1> select the set of Random Access resources applicable to the current Random Access procedure according to clause 5.1.1b;
. . .
1> if RA_TYPE is set to 2-stepRA:
   2> perform the Random Access Resource selection procedure for 2-step RA type (see clause 5.1.2a).
1> else:
   2> perform the Random Access Resource selection procedure (see clause 5.1.2).

### 5.1.1a Initialization of Variables Specific to Random Access Type

The MAC entity shall:
1> if RA_TYPE is set to 2-stepRA:
   2> set PREAMBLE_POWER_RAMPING_STEP to msgA-PreamblePowerRampingStep;
   . . .
   2> else if ra-PrioritizationForSlicingTwoStep for a NSAG-ID is configured for the selected carrier; and
   2> if the MAC entity is provided by upper layers with this NSAG-ID:
      3> if powerRampingStepHighPriority is configured in the ra-PrioritizationForSlicingTwoStep for this NSAG-ID:
         4> set PREAMBLE_POWER_RAMPING_STEP to the powerRampingStepHighPriority.
      . . .
1> else (i.e. RA_TYPE is set to 4-stepRA):
   2> set PREAMBLE_POWER_RAMPING_STEP to powerRampingStep;
   . . .
   2> set preambleTransMax to preambleTransMax included in the RACH-ConfigGeneric;
   2> if the Random Access procedure was initiated for SpCell beam failure recovery (as specified in clause 5.17); and
   2> if beamFailureRecoveryConfig is configured for the active UL BWP of the selected carrier:
      3> start the beamFailureRecoveryTimer, if configured;
      3> apply the parameters powerRampingStep, preambleReceivedTargetPower, and preambleTransMax configured in the beamFailureRecoveryConfig.
   2> if the Random Access procedure was initiated for beam failure recovery (as specified in clause 5.17); and
   2> if beamFailureRecoveryConfig is configured for the active UL BWP of the selected carrier; and
   2> if ra-Prioritization is configured in the beamFailureRecoveryConfig:
      3> set PREAMBLE_POWER_RAMPING_STEP to the powerRampingStepHighPriority included in the ra-Prioritization in beamFailureRecoveryConfig;
      . . .
   2> if RA_TYPE is switched from 2-stepRA to 4-stepRA during this Random Access procedure:
      3> set POWER_OFFSET_2STEP_RA to (PREAMBLE_POWER_RAMPING_COUNTER−1)×(MSGA_PREAMBLE_POWER_RAMPING_STEP−PREAMBLE_POWER_RAMPING_STEP).

. . .

### 5.1.1b Selection of the Set of Random Access Resources for the Random Access Procedure

The MAC entity shall:
1> if the BWP selected for Random Access procedure is configured with both set(s) of Random Access resources with msg3-Repetitions set to true and set(s) of Random Access resources without msg3-Repetitions set to true and the RSRP of the downlink pathloss reference is less than rsrp-ThresholdMsg3; or
1> if the BWP selected for Random Access procedure is only configured with the set(s) of Random Access resources with msg3-Repetitions set to true:
   2> assume Msg3 repetition is applicable for the current Random Access procedure.
1> else:
   2> assume Msg3 repetition is not applicable for the current Random Access procedure.
. . .
1> if neither contention-free Random Access Resources nor Random Access Resources for SI request have been provided for this Random Access procedure and one or more of the features including RedCap and/or Slicing and/or SDT and/or MSG3 repetition is applicable for this Random Access procedure:
NOTE 2: The applicability of SDT is determined by MAC entity according to clause 5.27. The applicability of NSAG-ID is determined by upper layers when the Random Access procedure is initiated. The applicability of RedCap is also determined by upper layers when Random Access procedure is initiated and it is applicable to the Random Access procedures initiated by PDCCH orders and any Random Access procedure initiated by the MAC entity.
   2> if none of the sets of Random Access resources are available for any feature applicable to the current Random Access procedure (as specified in clause 5.1.1c):
      3> select the set(s) of Random Access resources that are not associated with any feature indication (as specified in clause 5.1.1c) for this Random Access procedure.
   2> else if there is one set of Random Access resources available which can be used for indicating all features triggering this Random Access procedure:
      3> select this set of Random Access resources for this Random Access procedure.
   2> else (i.e. there are one or more sets of Random Access resources available that are configured with indication(s) for a subset of all features triggering this Random Access procedure):
      3> select a set of Random Access resources from the available set(s) of Random Access resources based on the priority order indicated by upper layers as specified in clause 5.1.1d for this Random Access Procedure.
1> else if contention-free Random Access Resources have been provided for this Random Access procedure and RedCap is applicable for the current Random Access procedure and there is one set of Random Access resources available that is only configured with RedCap indication:
   2> select this set of Random Access resources for this Random Access procedure.
1> else:
   2> select the set of Random Access resources that are not associated with any feature indication (as specified in clause 5.1.1c) for the current Random Access procedure.

. . .

5.1.3 Random Access Preamble Transmission

The MAC entity shall, for each Random Access Preamble:
1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
1> if SSB or CSI-RS selected is not changed from the selection in the last Random Access Preamble transmission:
   2> increment PREAMBLE_POWER_RAMPING_COUNTER by 1.
1> select the value of DELTA_PREAMBLE according to clause 7.3;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.
. . .

### 5.1.3a MSGA Transmission

The MAC entity shall, for each MSGA:
1> if PREAMBLE_TRANSMISSION_COUNTER is greater than one; and
1> if the notification of suspending power ramping counter has not been received from lower layers; and
1> if LBT failure indication was not received from lower layers for the last MSGA Random Access Preamble transmission; and
1> if SSB selected is not changed from the selection in the last Random Access Preamble transmission:
   2> increment PREAMBLE_POWER_RAMPING_COUNTER by 1.
1> select the value of DELTA_PREAMBLE according to clause 7.3;
1> set PREAMBLE_RECEIVED_TARGET_POWER to msgA-PreambleReceivedTargetPower+DELTA_PREAMBLE+(PREAMBLE_POWER_RAMPING_COUNTER−1)×PREAMBLE_POWER_RAMPING_STEP;
. . .
1> compute the MSGB-RNTI associated with the PRACH occasion in which the Random Access Preamble is transmitted;
1> instruct the physical layer to transmit the MSGA using the selected PRACH occasion and the associated PUSCH resource of MSGA (if the selected preamble and PRACH occasion is mapped to a valid PUSCH occasion), using the corresponding RA-RNTI, MSGB-RNTI, PREAMBLE_INDEX, PREAMBLE_RECEIVED_TARGET_POWER, msgA-PreambleReceivedTargetPower, and the amount of power ramping applied to the latest MSGA preamble transmission (i.e. (PREAMBLE_POWER_RAMPING_COUNTER−1)×PREAMBLE_POWER_RAMPING_STEP);
. . .

### 5.1.4 Random Access Response Reception

Once the Random Access Preamble is transmitted and regardless of the possible occurrence of a measurement gap, the MAC entity shall:
. . .
1> if ra-ResponseWindow configured in BeamFailureRecoveryConfig expires and if a PDCCH transmission on the search space indicated by recoverySearchSpaceId addressed to the C-RNTI has not been received on the Serving Cell where the preamble was transmitted; or
1> if ra-ResponseWindow configured in RACH-ConfigCommon expires, and if the Random Access Response containing Random Access Preamble identifiers that matches the transmitted PREAMBLE_INDEX has not been received:
   2> consider the Random Access Response reception not successful;
   2> increment PREAMBLE_TRANSMISSION_COUNTER by 1;
   2> if PREAMBLE_TRANSMISSION_COUNTER=preambleTransMax+1:
      3> if the Random Access Preamble is transmitted on the SpCell:
         4> indicate a Random Access problem to upper layers;
         4> if this Random Access procedure was triggered for SI request:
         5> consider the Random Access procedure unsuccessfully completed.
      3> else if the Random Access Preamble is transmitted on an SCell:
         4> consider the Random Access procedure unsuccessfully completed.
   2> if the Random Access procedure is not completed:
      3> select a random backoff time according to a uniform distribution between 0 and the PREAMBLE_BACKOFF;
      3> if the criteria (as defined in clause 5.1.2) to select contention-free Random Access Resources is met during the backoff time:
         4> perform the Random Access Resource selection procedure (see clause 5.1.2).
      . . .
         4> perform the Random Access Resource selection procedure (see clause 5.1.2) after the backoff time.

. . .

### 5.1.4a MSGB Reception and Contention Resolution for 2-Step RA Type

Once the MSGA preamble is transmitted, regardless of the possible occurrence of a measurement gap, the MAC entity shall:
1> start the msgB-ResponseWindow at the PDCCH occasion as specified in TS 38.213, clause 8.2A;
1> monitor the PDCCH of the SpCell for a Random Access Response identified by MSGB-RNTI while the msgB-ResponseWindow is running;
1> if C-RNTI MAC CE was included in the MSGA:
   2> monitor the PDCCH of the SpCell for Random Access Response identified by the C-RNTI while the msgB-ResponseWindow is running.
. . .
1> if msgB-ResponseWindow expires, and the Random Access Response Reception has not been considered as successful based on descriptions above:
   2> increment PREAMBLE_TRANSMISSION_COUNTER by 1;
   2> if PREAMBLE_TRANSMISSION_COUNTER=preambleTransMax+1:
      3> indicate a Random Access problem to upper layers;
      . . .
   2> if the Random Access procedure is not completed:
      3> if msgA-TransMax is applied (see clause 5.1.1a) and PREAMBLE_TRANSMISSION_COUNTER=msgA-TransMax+1:
         4> set the RA_TYPE to 4-stepRA;
         4> perform initialization of variables specific to Random Access type as specified in clause 5.1.1a;
         4> if the Msg3 buffer is empty:
         5> obtain the MAC PDU to transmit from the MSGA buffer and store it in the Msg3 buffer;
         4> flush HARQ buffer used for the transmission of MAC PDU in the MSGA buffer;
         4> discard explicitly signalled contention-free 2-step RA type Random Access Resources, if any;
         4> perform the Random Access Resource selection procedure as specified in clause 5.1.2.
      3> else:
         4> select a random backoff time according to a uniform distribution between 0 and the PREAMBLE_BACKOFF;
         4> if the criteria (as defined in clause 5.1.2a) to select contention-free Random Access Resources is met during the backoff time:
         5> perform the Random Access Resource selection procedure for 2-step RA type Random Access (see clause 5.1.2a).
         4> else:
         5> perform the Random Access Resource selection procedure for 2-step RA type Random Access (see clause 5.1.2a) after the backoff time.

### Quotation End

The definition, calculation and usage of TA information/value are specified in TS 38.211 ([10] 3GPP TS 38.211 V 17.5.0, “NR, Physical channels and modulation”) and TS 38.213 ([9] 3GPP TS 38.213 V 17.5.0, “NR, Physical layer procedures for control”) as below:

### Quotation Start [10]

### 4.3 Frame Structure

### 4.3.1 Frames and Subframes

. . .

There is one set of frames in the uplink and one set of frames in the downlink on a carrier.

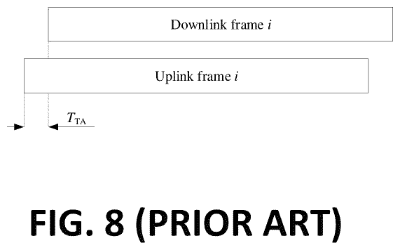

Uplink frame number i for transmission from the UE shall start T_{TA}=(N_{TA}+N_{TA,offset}+N_{TA,adj}^{common}+N_{TA,adj}^{UE})T_{c} before the start of the corresponding downlink frame at the UE where
N_{TA} and N_{TA,offset} are given by clause 4.2 of [TS 38.213], except for msgA transmission on PUSCH where N_{TA}=0 shall be used;
N_{TA,adj}^{common} given by clause 4.2 of [TS 38.213] is derived from the higher-layer parameters ta-Common, ta-CommonDrift, and ta-CommonDriftVariant if configured, otherwise N_{TA,adj}^{common}=0;
N_{TA,adj}^{UE} given by clause 4.2 of [TS 38.213] is computed by the UE based on UE position and serving-satellite-ephemeris-related higher-layers parameters if configured, otherwise N_{TA,adj}^{UE}=0.
   FIG. 8 is a Reproduction of FIG. 4.3.1-1: Uplink-Downlink Timing Relation, from 3GPP TS 38.211 V 17.5.0, “NR, Physical Channels and Modulation”.

### Quotation End

### Quotation Start [9]

### 4.2 Transmission Timing Adjustments

A UE can be provided a value N_{TA,offset} of a timing advance offset for a serving cell by n-TimingAdvanceOffset for the serving cell. If the UE is not provided n-TimingAdvanceOffset for a serving cell, the UE determines a default value N_{TA,offset} of the timing advance offset for the serving cell as described in [TS 38.133].

If a UE is configured with two UL carriers for a serving cell, a same timing advance offset value N_{TA,offset} applies to both carriers.

Upon reception of a timing advance command for a TAG, the UE adjusts uplink timing for PUSCH/SRS/PUCCH transmission on all the serving cells in the TAG based on a value N_{TA,offset} that the UE expects to be same for all the serving cells in the TAG and based on the received timing advance command where the uplink timing for PUSCH/SRS/PUCCH transmissions is the same for all the serving cells in the TAG.

. . .

For a SCS of 29-15 kHz, the timing advance command for a TAG indicates the change of the uplink timing relative to the current uplink timing for the TAG in multiples of 16·64·T_{c}/2^{μ}. The start timing of the random access preamble is described in [TS 38.211].

A timing advance command [TS 38.321] in case of random access response or in an absolute timing advance command MAC CE, T_{A}, for a TAG indicates N_{TA} values by index values of T_{A}=0, 1, 2, . . . , 3846, where an amount of the time alignment for the TAG with SCS of 2^{μ}·15 kHz is N_{TA}=T_{A}·16·64/2^{μ}. N_{TA} is defined in [TS 38.211] and is relative to the SCS of the first uplink transmission from the UE after the reception of the random access response or absolute timing advance command MAC CE.

In other cases, a timing advance command [TS 38.321], T_{A}, for a TAG indicates adjustment of a current N_{TA} value, N_{TA} old, to the new N_{TA} value, N_{TA_new}, by index values of T_{A}=0, 1, 2, . . . , 63, where for a SCS of 2^{μ}·15 kHz, N_{TA_new}=N_{TA_old}+(T_{A}−31)·16·64/2^{μ}.

. . .

Adjustment of an N_{TA} value by a positive or a negative amount indicates advancing or delaying the uplink transmission timing for the TAG by a corresponding amount, respectively.

For a timing advance command received on uplink slot n and for a transmission other than a PUSCH scheduled by a RAR UL grant or a fallbackRAR UL grant as described in clause 8.2A or 8.3, or a PUCCH with HARQ-ACK information in response to a successRAR as described in clause 8.2A, the corresponding adjustment of the uplink transmission timing applies from the beginning of uplink slot n+k+1+2^{μ}·K_{offset} where k=┌Nₛₗₒₜ^{subframe,μ}·(N_{T,1}+N_{T,2}+N_{TA,max}+0.5)/T_{sf}┐, N_{T,1} is a time duration in msec of N₁ symbols corresponding to a PDSCH processing time for UE processing capability 1 when additional PDSCH DM-RS is configured, N_{T,2} is a time duration in msec of N₂ symbols corresponding to a PUSCH preparation time for UE processing capability 1 [TS 38.214], N_{TA,max} is the maximum timing advance value in msec that can be provided by a TA command field of 12 bits, Nₛₗₒₜ^{subframe,μ} is the number of slots per subframe, T_{sf} is the subframe duration of 1 msec, and K_{offset}=K_{cell,offset}−K_{UE,offset}, where K_{cell,offset} is provided by cellSpecificKoffset and K_{UE,offset} is provided by a Differential K_{offset} MAC CE command [11, TS 38.321]; otherwise, if not respectively provided, K_{cell,offset}=0 or K_{UE,offset}=0. N₁ and N₂ are determined with respect to the minimum SCS among the SCSs of all configured UL BWPs for all uplink carriers in the TAG and of all configured DL BWPs for the corresponding downlink carriers. For μ=0, the UE assumes N_{1,0}=14 [6, TS 38.214]. Slot n and Nₛₗₒₜ^{subframe,μ} are determined with respect to the minimum SCS among the SCSs of all configured UL BWPs for all uplink carriers in the TAG. N_{TA,max} is determined with respect to the minimum SCS among the SCSs of all configured UL BWPs for all uplink carriers in the TAG and for all configured initial UL BWPs provided by initialUplinkBWP. The uplink slot n is the last slot among uplink slot(s) overlapping with the slot(s) of PDSCH reception assuming T_{TA}=0, where the PDSCH provides the timing advance command and T_{TA} is defined in [TS 38.211].

. . .

If the received downlink timing changes and is not compensated or is only partly compensated by the uplink timing adjustment without timing advance command as described in [TS 38.133], the UE changes N_{TA} accordingly.

If two adjacent slots overlap due to a TA command, the latter slot is reduced in duration relative to the former slot. The UE does not change N_{TA} during an actual transmission time window for a PUSCH or a PUCCH transmission [TS 38.214].

Using higher-layer ephemeris parameters for a serving satellite, if provided, a UE pre-compensates the two-way transmission delay on the service link based on N_{TA,adj}^{UE} that the UE determines using the serving satellite position and its own position. To pre-compensate the two-way transmission delay between the uplink time synchronization reference point and the serving satellite, the UE determines N_{TA,adj}^{common} [TS 38.211] based on one-way propagation delay Delay_{common}(t) that the UE determines as:

$${Delay}_{common} ( t ) = \frac{{TA}_{Common}}{2} + \frac{{TA}_{CommonDrift}}{2} \times ( t - {t}_{epoch} ) + \frac{{TA}_{CommonDriftVariant}}{2} \times {( t - {t}_{epoch} )}^{2}$$

where TA_{Common}, TA_{CommonDrift}, and TA_{CommonDriftVariant} are respectively provided by ta-Common, ta-CommonDrift, and ta-CommonDriftVariant and t_{epoch} is the epoch time of TA_{Common}, TA_{CommonDrift}, and TA_{CommonDriftVariant} [TS 38.331]. Delay_{common}(t) provides a distance at time t between the serving satellite and the uplink time synchronization reference point divided by the speed of light. The uplink time synchronization reference point is the point where DL and UL are frame aligned with an offset given by N_{TA,offset}.

### Next Quotation

### 8.2 Random Access Response—Type-1 Random Access Procedure

In response to a PRACH transmission, a UE attempts to detect a DCI format 1_0 with CRC scrambled by a corresponding RA-RNTI during a window controlled by higher layers [TS 38.321]. The window starts at the first symbol of the earliest CORESET the UE is configured to receive PDCCH for Type1-PDCCH CSS set, as defined in clause 10.1, that is at least one symbol, after the last symbol of the PRACH occasion corresponding to the PRACH transmission, where the symbol duration corresponds to the SCS for Type1-PDCCH CSS set as defined in clause 10.1. If N_{TA,adj}^{UE} or N_{TA,adj}^{common}, as defined in [TS 38.211], is not zero, the window starts after an additional T_{TA}+k_{mac} msec where T_{TA} is defined in [TS 38.211] and k_{mac} is provided by kmac or k_{mac}=0 if kmac is not provided. The length of the window in number of slots, based on the SCS for Type1-PDCCH CSS set, is provided by ra-ResponseWindow.

. . .

### 8.2a Random Access Response—Type-2 Random Access Procedure

In response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers [TS 38.321]. The window starts at the first symbol of the earliest CORESET the UE is configured to receive PDCCH for Type1-PDCCH CSS set, as defined in clause 10.1, that is at least one symbol, after the last symbol of the PUSCH occasion corresponding to the PRACH transmission, where the symbol duration corresponds to the SCS for Type1-PDCCH CSS set. If N_{TA,adj}^{UE} or N_{TA,adj}^{common}, as defined in [TS 38.211], is not zero, the window starts after an additional T_{TA}+k_{mac} msec where T_{TA} is defined in [TS 38.211] and k_{mac} is provided by kmac or k_{mac}=0 if kmac is not provided. The length of the window in number of slots, based on the SCS for Type1-PDCCH CSS set, is provided by msgB-ResponseWindow.

### Quotation End

The TA maintenance (for N_{TA}) in MAC entity and the application for UE-gNB RTT are specified in TS 38.321 ([3] 3GPP TS 38.321 V 17.5.0, “NR, MAC protocol specification”) as below:

### Quotation Start [3]

### 3.1 Definitions

. . .

Non-terrestrial network: An NG-RAN consisting of gNBs, which provide non-terrestrial NR access to UEs by means of an NTN payload embarked on an airborne or space-borne NTN vehicle and an NTN Gateway.

. . .

Serving Cell: A PCell, a PSCell, or an SCell in TS 38.331.

. . .

Timing Advance Group: A group of Serving Cells that is configured by RRC and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs.

UE-gNB RTT: For non-terrestrial networks, the sum of the UE's Timing Advance value (see TS 38.211 clause 4.3.1) and kmac.

### Next Quotation

### 5.1.5 Contention Resolution

Once Msg3 is transmitted the MAC entity shall:
1> if the Msg3 transmission (i.e. initial transmission or HARQ retransmission) is scheduled with PUSCH repetition Type A:
   2> if Msg3 is transmitted on a non-terrestrial network:
      3> start or restart the ra-ContentionResolution Timer in the first symbol after the end of all repetitions of the Msg3 transmission plus the UE-gNB RTT.
      . . .
1> else if Msg3 transmission (i.e. initial transmission or HARQ retransmission) is transmitted on a non-terrestrial network:
   2> start or restart the ra-ContentionResolutionTimer in the first symbol after the end of the Msg3 transmission plus the UE-gNB RTT.
   . . .
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated for SpCell beam failure recovery or for beam failure recovery of both BFD-RS sets of SpCell (as specified in clause 5.17) and the PDCCH transmission is addressed to the C-RNTI; or
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         5> if this Random Access procedure was initiated for SI request:
         6> indicate the reception of an acknowledgement for SI request to upper layers.
         5> else:
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.
1> if ra-ContentionResolutionTimer expires:
   2> if Msg3 transmission was transmitted on a non-terrestrial network:
      3> if no PDCCH addressed to TC-RNTI indicating uplink grant for a Msg3 retransmission is received after the start of the ra-ContentionResolutionTimer:
         4> discard the TEMPORARY_C-RNTI;
         4> consider the Contention Resolution not successful.
   2> else:
      3> discard the TEMPORARY_C-RNTI;
      3> consider the Contention Resolution not successful.
1> if the Contention Resolution is considered not successful:
   2> flush the HARQ buffer used for transmission of the MAC PDU in the Msg3 buffer;
   2> increment PREAMBLE_TRANSMISSION_COUNTER by 1;
   2> if PREAMBLE_TRANSMISSION_COUNTER=preambleTransMax+1:
      3> indicate a Random Access problem to upper layers.
      3> if this Random Access procedure was triggered for SI request:
         4> consider the Random Access procedure unsuccessfully completed.
   2> if the Random Access procedure is not completed:
      3> if the RA_TYPE is set to 4-stepRA:
         4> select a random backoff time according to a uniform distribution between 0 and the PREAMBLE_BACKOFF;
         4> if the criteria (as defined in clause 5.1.2) to select contention-free Random Access Resources is met during the backoff time:
         5> perform the Random Access Resource selection procedure (see clause 5.1.2);
         4> else:
         5> perform the Random Access Resource selection procedure (see clause 5.1.2) after the backoff time.
      3> else (i.e. the RA_TYPE is set to 2-stepRA):
         4> if msgA-TransMax is applied (see clause 5.1.1a) and PREAMBLE_TRANSMISSION_COUNTER=msgA-TransMax+1:
         5> set the RA_TYPE to 4-stepRA;
         5> perform initialization of variables specific to Random Access type as specified in clause 5.1.1a;
         5> flush HARQ buffer used for the transmission of MAC PDU in the MSGA buffer;
         5> discard explicitly signalled contention-free 2-step RA type Random Access Resources, if any;
         5> perform the Random Access Resource selection as specified in clause 5.1.2.
         4> else:
         5> select a random backoff time according to a uniform distribution between 0 and the PREAMBLE_BACKOFF;
         5> if the criteria (as defined in clause 5.1.2a) to select contention-free Random Access Resources is met during the backoff time:
         6> perform the Random Access Resource selection procedure for 2-step RA type as specified in clause 5.1.2a.
         5> else:
         6> perform the Random Access Resource selection for 2-step RA type procedure (see clause 5.1.2a) after the backoff time.

### Next Quotation

### 5.2 Maintenance of Uplink Time Alignment

RRC configures the following parameters for the maintenance of UL time alignment:
timeAlignmentTimer (per TAG) which controls how long the MAC entity considers the Serving Cells belonging to the associated TAG to be uplink time aligned;
. . .

The MAC entity shall:
1> when a Timing Advance Command MAC CE is received, and if an N_{TA} (as defined in TS 38.211) has been maintained with the indicated TAG:
   2> apply the Timing Advance Command for the indicated TAG;
   . . .
      3> start or restart the timeAlignmentTimer associated with the indicated TAG.
1> when a Timing Advance Command is received in a Random Access Response message for a Serving Cell belonging to a TAG or in a MSGB for an SpCell:
   2> if the Random Access Preamble was not selected by the MAC entity among the contention-based Random Access Preamble:
      3> apply the Timing Advance Command for this TAG;
      3> start or restart the timeAlignmentTimer associated with this TAG.
   2> else if the timeAlignmentTimer associated with this TAG is not running:
      3> apply the Timing Advance Command for this TAG;
      3> start the timeAlignmentTimer associated with this TAG;
      3> when the Contention Resolution is considered not successful as described in clause 5.1.5; or
      . . .
         4> stop timeAlignmentTimer associated with this TAG.
      . . .
   2> else:
      3> ignore the received Timing Advance Command.
1> when an Absolute Timing Advance Command is received in response to a MSGA transmission including C-RNTI MAC CE as specified in clause 5.1.4a:
   2> apply the Timing Advance Command for PTAG;
   . . .
      3> start or restart the timeAlignmentTimer associated with PTAG.
. . .
1> when instruction from the upper layer has been received for starting the TimeAlignmentTimer associated with PTAG:
   2> start the TimeAlignmentTimer associated with PTAG.
1> when a timeAlignmentTimer expires:
   2> if the timeAlignmentTimer is associated with the PTAG:
      3> flush all HARQ buffers for all Serving Cells;
      3> notify RRC to release PUCCH for all Serving Cells, if configured;
      3> notify RRC to release SRS for all Serving Cells, if configured;
      3> clear any configured downlink assignments and configured uplink grants;
      3> clear any PUSCH resource for semi-persistent CSI reporting;
      3> consider all running timeAlignmentTimers as expired;
      3> maintain N_{TA} (defined in TS 38.211) of all TAGs.
      . . .

The MAC entity shall not perform any uplink transmission on a Serving Cell except the Random Access Preamble and MSGA transmission when the timeAlignmentTimer associated with the TAG to which this Serving Cell belongs is not running, CG-SDT procedure is not ongoing and SRS transmission in RRC_INACTIVE as in clause 5.26 is not on-going. Furthermore, when the timeAlignmentTimer associated with the PTAG is not running, CG-SDT procedure is not ongoing and SRS transmission in RRC_INACTIVE as in clause 5.26 is not ongoing, the MAC entity shall not perform any uplink transmission on any Serving Cell except the Random Access Preamble and MSGA transmission on the SpCell. The MAC entity shall not perform any uplink transmission except the Random Access Preamble and MSGA transmission when the cg-SDT-TimeAlignmentTimer is not running during the ongoing CG-SDT procedure as triggered in clause 5.27 and the inactivePosSRS-TimeAlignmentTimer is not running.

### Quotation End

In LTE, the NW could indicate N_{TA} via handover command as specified in TS 36.331 ([12] 3GPP TS 36.331 V 17.5.0, “E-UTRA, RRC protocol specification”):

### Quotation Start [12]

- RRCConnection Reconfiguration

...
RRCConnectionReconfiguration-r8-IEs :: = SEQUENCE {
...

| | | | |
|---|---|---|---|
| mobilityControlInfo | MobilityControlInfo | OPTIONAL, | -- Cond HO |

...
}

### Next Quotation

- MobilityControlInfo

...

| | |
|---|---|
| MobilityControlInfo ::= | SEQUENCE { |
| targetPhysCellId | PhysCellId, |

...

| newUE-Identity | C-RNTI, | |
|---|---|---|
| radioResourceConfigCommon | RadioResourceConfigCommon, | |
| rach-ConfigDedicated | RACH-ConfigDedicated | OPTIONAL, -- Need OP |

| | |
|---|---|
| ... | OPTIONAL, -- Need OR |

| | |
|---|---|
| rach-Skip-r14 | RACH-Skip-r14 |

...
}
...

| | |
|---|---|
| RACH-Skip-r14 ::= | SEQUENCE { |
| targetTA-r14 | CHOICE { |
| ta0-r14 | NULL, |
| mcg-PTAG-r14 | NULL, |
| scg-PTAG-r14 | NULL, |
| mcg-STAG-r14 | STAG-Id-r11, |
| scg-STAG-r14 | STAG-Id-r11 |

},

| | |
|---|---|
| ul-ConfigInfo-r14 | SEQUENCE { |
| numberOfConfUL-Processes-r14 | INTEGER (1..8), |
| ul-SchedInterval-r14 | ENUMERATED {sf2, sf5, sf10}, |
| ul-StartSubframe-r14 | INTEGER (0..9), |
| ul-Grant-r14 | BIT STRING (SIZE (16)) |

| | |
|---|---|
| } | OPTIONAL -- Need OR |

}
MobilityControlInfo field descriptions
rach-Skip
This field indicates whether random access procedure for the target PCell is skipped.
targetTA
This field refers to the timing adjustment indication, see TS 36.213, indicating the N_{TA} value which the UE shall use for
the target PTAG of handover or the target PSTAG of SCG change. ta0 corresponds to N_{TA} = 0. mcg-PTAG corresponds
to the latest N_{TA} value of the PTAG associated with MCG. scg-PTAG corresponds to the latest N_{TA} value of the PTAG
associated with SCG. mcg-STAG corresponds to the latest NTA value of a MCG STAG indicated by the STAG-Id. scg-
STAG corresponds to the latest N_{TA} value of a SCG STAG indicated by the STAG-Id.

### Quotation End

The general description of Location Services (LCS) and/or UE positioning in TN is specified in TS 38.305 ([11] 3GPP TS 38.305 V 17.5.0, “NG-RAN, Stage 2 functional specification of UE positioning in NG-RAN”) as below:

### Quotation Start [11]

### 4.1 Assumptions and Generalities

. . .

Positioning functionality provides a means to determine the geographic position and/or velocity of the UE based on measuring radio signals. The position information may be requested by and reported to a client (e.g., an application) associated with the UE, or by a client within or attached to the core network. The position information shall be reported in standard formats, such as those for cell-based or geographical co-ordinates, together with the estimated errors (uncertainty) of the position and velocity of the UE and, if available, the positioning method (or the list of the methods) used to obtain the position estimate.

### 4.2 Role of UE Positioning Methods

The NG-RAN may utilise one or more positioning methods in order to determine the position of an UE.

Positioning the UE involves two main steps:
signal measurements; and
position estimate and optional velocity computation based on the measurements.

The signal measurements may be made by the UE or by the serving ng-eNB or gNB. The basic signals measured for terrestrial position methods are typically the LTE or NR radio transmissions; however, other methods may make use of other transmissions such as general radio navigation signals including those from Global Navigation Satellites Systems (GNSSs).

. . .

The position estimate computation may be made by the UE or by the LMF.

### Quotation End

A non-terrestrial network (NTN) in 3GPP could provide non-terrestrial access to User Equipment (UE) by means of an NTN payload embarked on an airborne or space-borne NTN vehicle and an NTN Gateway. NTN could offer a wide-area coverage and provide Network (NW) access in the scenario when terrestrial network is unfeasible (e.g., desert, polar area, and/or on an airplane). A UE may connect to the NTN that involves airborne/spaceborne for transmission and/or reception. The NTN may comprise various platforms, including low earth orbit (LEO) satellite, medium earth orbit (MEO) satellite, highly elliptical orbit (HEO) satellite, geostationary earth orbit (GEO) satellite, geostationary synchronous orbit (GSO) satellite, non-geostationary synchronous orbit (NGSO) satellite, and/or high altitude platform station (HAPS). A LEO satellite could have an earth-fixed beam (e.g., the beam is temporarily fixed on a location during a time period) or an earth-moving beam (e.g., the beam is continuously moving along with the satellite). A LEO satellite could serve/provide earth moving cells (e.g., with an earth-fixed beam) and/or (quasi-)earth fixed cells (e.g., with an earth-moving beam).

Currently (in 3GPP release 18 and before), it is assumed that the UEs supporting NTN are Global Navigation Satellite System (GNSS)-capable. The UE could compensate Uplink (UL) timing and frequency based on UE location obtained via GNSS. The UE could have valid a location via GNSS and receive some NTN information (e.g., ephemeris, common Timing Advance (TA), parameters configured in NTN-Config in TS 38.331 ([4] 3GPP TS 38.331 V 17.5.0)) to pre-compensate the TA value and/or frequency shift. The assumption restricts the applicability of 3GPP NTN. For example, some UEs may not have GNSS capability. And some UEs may not always receive a GNSS signal or acquire a GNSS position, e.g., due to the radio environment. It has been observed that it is possible that GNSS may not be available in some cases. Moreover, GNSS handling may cause delays to the UE operation due to positioning acquisition time and additional energy consumption. For improvement, the GNSS independent mechanism could be introduced to improve energy efficiency and reduce dependency on GNSS service availability. The GNSS independent mechanism has been discussed in RAN meetings to improve UL robustness and reduce dependency on GNSS service availability. The UE without GNSS (capability) would be able to access NTN in the future releases. Throughout the disclosure, the following may be interchangeable: GNSS independent, GNSS-less, non-GNSS.

To support GNSS independent operation, some enhancements on the Physical Random Access Channel (PRACH) resources and/or Random Access (RA) schemes may be needed for the UEs without GNSS capability. According to TR 38.821 ([1] 3GPP TR 38.821 V 16.1.0), it would be possible for the network to configure separate RA resources based on GNSS capabilities. It is assumed that Random Access Channel (RACH) resources or configurations are separated between the UEs with and without GNSS.

Throughout the disclosure, the UE with GNSS may be a UE with GNSS capability. The UE with GNSS may be a first UE has or is configured/equipped with a GNSS device/receiver. The UE with GNSS may be (referred to as) a GNSS-based UE, GNSS UE, or GNSS dependent UE. The UE with GNSS may mean that the UE is capable of GNSS operation. The UE with GNSS may mean that the UE provides capability information indicating that the UE is capable of GNSS operation. The UE with GNSS may mean that the UE has UE location information (currently). The UE with GNSS may mean that the UE has (enough/valid) GNSS information (currently). The GNSS information may be UE location information derived (or obtained) via GNSS. The GNSS information may be GNSS signal(s) received by the UE. The GNSS information may be satellite information provided by the NW. The UE with GNSS may be a first type UE (e.g., as specified below). The GNSS operation may be or comprise at least receiving a GNSS signal and/or obtaining location information via GNSS.

Throughout the disclosure, the UE without GNSS may be a UE without GNSS capability. The UE without GNSS may be a UE (with or without GNSS capability) not acquiring GNSS information. The UE without GNSS may be a second UE that does not have or is not configured/equipped with a GNSS device/receiver. The UE without GNSS may be a third UE that has or is configured/equipped with a GNSS device/receiver. The third UE may not receive/acquire/derive/have (sufficient) GNSS signal or information. The third UE may not access GNSS satellite(s). The third UE may be in a time duration of a GNSS measurement gap. The GNSS measurement validity duration may not be long enough for the third UE to acquire GNSS. The received GNSS signal may not be strong enough for the third UE to acquire GNSS position. The third UE may in an indoor scenario. The third UE may turn off its GNSS operator, e.g., for saving power. The third UE may be a first UE fulfilling a first condition (e.g., as specified below). The UE without GNSS may be (referred to as) a GNSS-less UE, non-GNSS UE, or GNSS independent UE. The UE without GNSS may mean that the UE is not capable of GNSS operation. The UE without GNSS may mean that the UE provides capability information indicating that the UE is not capable of GNSS operation. The UE without GNSS may mean that the UE has no UE location information (currently). The UE without GNSS may mean that the UE has no (enough/valid) GNSS information (currently). The GNSS information may be UE location information derived (or obtained) via GNSS. The GNSS information may be GNSS signal(s) received by the UE. The GNSS information may be satellite information provided by the NW. The UE without GNSS may be a second type UE (e.g., as specified below).

Throughout the disclosure, a first type UE may be a UE with GNSS (capability). The first type UE may be a UE knowing its location. The first type UE may be configured/equipped with a GNSS device/receiver. The first type UE may be able to receive a GNSS signal or information. The first type UE may be able to acquire/have/know its location and/or GNSS position. The first type UE may have capability for pre-compensation of timing and frequency offset. The first type UE may (be able to) pre-compensate TA and/or frequency shift via UE location and NTN information. The first type UE may (be able to) maintain UL synchronization based on UE location and NTN information. The first type UE may not know its location (at least for a moment, e.g., upon RA resource selection). The first type UE may not acquire GNSS position (at least for a moment, e.g., upon RA resource selection). The first type UE may not (be able to) pre-compensate TA and/or frequency shift (at least for a moment, e.g., upon RA resource selection). The first type UE may not (be able to) maintain UL synchronization (at least for a moment, e.g., upon RA resource selection). The first type UE may (or may not) fulfil the first condition (e.g., as specified below). The GNSS position, GNSS information, and/or NTN information of the first type UE may be valid. The GNSS signal of the first type UE may be qualified (e.g., the strength of received GNSS signal is equal to or above a threshold). The GNSS signal of the first type UE may be available.

Throughout the disclosure, a second type UE may be a UE without GNSS (capability). The second type UE may be a UE not knowing its location. The second type UE may be configured/equipped with a GNSS device/receiver. The second type UE may not be configured/equipped with a GNSS device/receiver. The second type UE may not be able to receive GNSS signal or information. The second type UE may not be able to acquire/have/know its location and/or GNSS position. The second type UE may have capability for pre-compensation of timing and frequency offset. The second type UE may not have capability for pre-compensation of timing and frequency offset. The second type UE may not (be able to) pre-compensate TA and/or frequency shift via UE location and NTN information. The second type UE may not (be able to) maintain UL synchronization based on UE location and NTN information. The second type UE may know its location (at least for a moment, e.g., upon RA resource selection). The second type UE may (be able to) pre-compensate TA and/or frequency shift (at least for a moment, e.g., upon RA resource selection). The second type UE may (be able to) maintain UL synchronization (at least for a moment, e.g., upon RA resource selection). The second type UE may (or may not) fulfil the first condition (e.g., as specified below). The GNSS position, GNSS information, and/or NTN information of the second type UE may be out-of-date and/or not valid. The GNSS signal of the second type UE may be not qualified (e.g., the strength of received GNSS signal is equal to or below a threshold). The GNSS signal of the second type UE may be not available.

Throughout the disclosure, a UE with or without GNSS could be based on GNSS status (e.g., strength/available of GNSS signal and/or validity of GNSS information) and/or the first condition (e.g., as specified below).

The NW may configure a first type RA (resources) and/or a second type RA (resources) to the UE. The NW may indicate (or provide a configuration) that a cell allows (or is capable of) the first type RA (resources) and/or the second type RA (resources). The UE may access the cell via the first type RA (resources) or the second type RA (resources). The first type RA (resources) may be different from the second type RA (resources). The first type RA (resources) may be (designed/configured) for the UE with GNSS (e.g., the first type UE). The second type RA (resources) may be (designed/configured) for the UE without GNSS (e.g., the second type UE).

Throughout the disclosure, the RA (resources) may be, be referred to, and/or comprise RA resource(s), RA configuration(s), RA format(s), and/or RA scheme(s). The RA resources may be or may comprise (part of) parameters of RACH-ConfigGeneric and/or RACH-ConfigGenericTwoStepRA in TS 38.331 ([4] 3GPP TS 38.331 V 17.5.0). Throughout the disclosure, the following may be interchangeable: RA, RACH and PRACH. The “RA” may be, be referred to, correspond to, be supplemented with, and/or be replaced by “RACH” and/or “PRACH”.

The first type RA (resources) and the second type RA (resources) may be configured as or may correspond to RA mode A and RA mode B, respectively. The first type RA (resources) and the second type RA (resources) may be configured as or may correspond to RA type 1 and RA type 2, respectively. The first type RA (resources) may be current (or legacy) RA resources configured for NTN as specified in TS 38.331 ([4] 3GPP TS 38.331 V 17.5.0). The second type RA (resources) may be additional (e.g., a new type, extended) RA (resources) other than the first type RA (resources). For example, the NW may configure the second type RA (resources) in the first type RA (resources) (e.g., RACH-ConfigGeneric, RACH-ConfigGenericTwoStepRA. For example, the NW may configure the second type RA (resources) and/or the first type RA (resources) in a common RA configuration (e.g., RA CH-Config Common, RACH-ConfigCommonTwoStepRA). The first type RA (resources) and the second type RA (resources) may be configured for NTN. The first type RA (resources) may be designed for the UE with GNSS. The second type RA (resources) may be designed for the UE without GNSS.

The first type RA (resources) and the second type RA (resources) may comprise (RA resources for) 4-step RA and/or 2-step RA. The first type RA (resources) and the second type RA (resources) may comprise (RA resources for) Contention-Based Random Access (CBRA) and/or Contention-Free Random Access (CFRA). The second type RA (resources) may not comprise 4-step RA, 2-step RA, CBRA, and/or CFRA. The first type RA (resources) and/or the second type RA (resources) may be common RA resources (for a cell). The first type RA (resources) and/or the second type RA (resources) may be dedicated RA resources (for a UE). The NW may indicate (or provide a configuration of) the first type RA (resources) and/or the second type RA (resource) via a broadcast signaling (e.g., system information).

The first type RA (resources) and the second type RA (resources) may be configured on a same cell. The first type RA (resources) and the second type RA (resources) may be configured on different cells. A cell may allow/configure/be capable of both the first type RA (resources) and the second type RA (resources). A cell may allow/configure/be capable of the first type RA (resource) but not the second type RA (resources). A cell may allow/configure/be capable of the second type RA (resource) but not the first type RA (resources). A cell providing a configuration (or indication) related to the first type RA (resources) may allow (or be capable of) a UE access via the first type RA (resources). A cell providing a configuration (or indication) related to the second type RA (resources) may allow (or be capable of) a UE access via the second type RA (resources). A cell not providing a configuration (or indication) related to the first type RA (resources) may not allow (or be not capable of) a UE access via the first type RA (resources). A cell not providing a configuration (or indication) related to the second type RA (resources) may not allow (or be not capable of) a UE access via the second type RA (resources).

The UE may (determine to) access the cell via the first type RA (resources) and/or the second type RA (resources) based on (at least) the NW indication (or configuration). For example, the UE is allowed to access the cell via the first type RA (resources) if (at least) the NW allows (or is capable of) the first type RA (resources). The UE is allowed to access the cell via the second type RA (resources) if (at least) the NW allows (or is capable of) the second type RA (resources). The UE is not allowed to access the cell via the first type RA (resources) if (at least) the NW allows (or is not capable of) the first type RA (resources). The UE is not allowed to access the cell via the second type RA (resources) if (at least) the NW allows (or is not capable of) the second type RA (resources).

The first type RA (resources) and the second type RA (resources) may be differentiated by PRACH sequences (e.g., Zadoff-Chu (ZC) sequence, m-sequence, Gold sequence), PRACH formats, repetition scheme, Subcarrier Spacing (SCS), time (adjustment) offsets/indications, frequency (adjustment) offsets/indications, and/or RA response window. The first type RA (resources) and the second type RA (resources) may have (or be configured with) different PRACH sequences (e.g., ZC sequence, m-sequence, Gold sequence) and/or PRACH formats. The first type RA (resources) and the second type RA (resources) may have (or be configured with) different repetition schemes, e.g., for PRACH. The first type RA (resources) may not have (or be configured with) repetition scheme. The second type RA (resources) may have (or be configured with) repetition scheme. The second type RA (resources) may have (or be configured with) more repetitions than the first type RA (resources). The first type RA (resources) and the second type RA (resources) may have (or be configured with) different SCS, e.g., for PRACH. The second type RA (resources) may have (or be configured with) larger SCS than the first type RA (resources). The first type RA (resources) and the second type RA (resources) may have (or be configured with) different TA and/or frequency (adjustment) offsets/indications, e.g., for PRACH occasions, for Physical Downlink Control Channel (PDCCH) occasions, for RA timers (e.g., ra-ResponseWindow, msgB-ResponseWindow, ra-ContentionResolutionTimer). The first type RA (resources) may not have (or be configured with) TA and/or frequency (adjustment) offset/indication. The second type RA (resources) may have (or be configured with) (additional/specific) TA and/or frequency (adjustment) offset/indication. The first type RA (resources) and the second type RA (resources) may have (or be configured with) different RA response windows (e.g., ra-ResponseWindow, msgB-ResponseWindow). The second type RA (resources) may have (or be configured with) longer RA response windows (e.g., ra-ResponseWindow, msgB-ResponseWindow) than the first type RA (resources). The RA response windows (e.g., ra-ResponseWindow, msgB-ResponseWindow) are used to receive an RA response (e.g., Msg2, Random Access Response (RAR), MSGB), e.g., for RA preamble.

Throughout the disclosure, the first condition may be based on, be related to, or comprise (at least) one or more of the following (e.g., headings):

### GNSS Operation

In one example, the first condition may be (based on related to) whether the UE could complete a (triggered) GNSS measurement or GNSS fix operation. The first condition may be fulfilled if the UE is not able to complete a (triggered) GNSS measurement or GNSS fix operation. The first condition may be not fulfilled if the UE completes a (triggered) GNSS measurement or GNSS fix operation. The GNSS measurement or GNSS fix operation is triggered by the NW or the UE.

In one example, the first condition may be (based on/related to) whether the GNSS position of the UE becomes out-of-date. The first condition may be fulfilled if the GNSS position becomes (or has become) out-of-date. The first condition may be not fulfilled if the GNSS position does not become out-of-date. The first condition may be not fulfilled if the GNSS position is valid.

In one example, the first condition may be (based on/related to) whether the GNSS position fix (or GNSS-based UE location) is available/acquired by the UE. The first condition may be fulfilled if the GNSS position fix (or GNSS-based UE location) is/becomes not available for the UE. The first condition may be fulfilled if the UE does not have/acquire/obtain/maintain a (valid) GNSS position fix (or GNSS-based UE location). The first condition may be fulfilled if the UE loses (valid) GNSS position fix (or GNSS-based UE location). The first condition may be not fulfilled if the GNSS position fix (or GNSS-based UE location) is/becomes available for the UE. The first condition may be not fulfilled if the UE has/acquires/obtains/maintains a (valid) GNSS position fix (or GNSS-based UE location). In one example, the first condition may be (based on/related to) whether the UE has operation with GNSS. The first condition may be fulfilled if the UE does not have operation with GNSS. The first condition may be not fulfilled if the UE has operation with GNSS.

### GNSS Validity Duration

In one example, the first condition may be (based on/related to) whether the length of (remaining time of) GNSS validity duration is equal to or above a threshold (e.g., a time threshold). The first condition may be fulfilled if the length of (remaining time of) GNSS validity duration is equal to or below the threshold (e.g., a time threshold). The first condition may be not fulfilled if the length of (remaining time of) GNSS validity duration is equal to or above the threshold (e.g., a time threshold).

In one example, the first condition may be (based on/related to) whether the GNSS validity duration expires. The first condition may be fulfilled if the GNSS validity duration expires. The first condition may be fulfilled in response to the GNSS validity duration expiry/expiration. The first condition may be not fulfilled if the GNSS validity duration is ongoing.

### GNSS Signal Strength

In one example, the first condition may be (based on/related to) whether the received GNSS signal is qualified/sufficient/strong enough. For example, the first condition may be (based on/related to) whether the strength of received GNSS signal is equal to or above a threshold (e.g., GNSS threshold, Reference Signal Received Power (RSRP) threshold, a threshold related to radio condition). The first condition may be fulfilled if the strength of received GNSS signal is not qualified/not sufficient/not strong enough, e.g., equal to or below the threshold (e.g., GNSS threshold, RSRP threshold, a threshold related to radio condition). The first condition may be not fulfilled if the strength of received GNSS signal is qualified/sufficient/strong enough, e.g., equal to or above the threshold (e.g., GNSS threshold, RSRP threshold, a threshold related to radio condition).

In one example, the first condition may be (based on/related to) whether the GNSS signal could be detected or is available. The first condition may be fulfilled if the GNSS signal could not be detected or is not available. The first condition may be not fulfilled if the GNSS signal could be detected or is available.

The GNSS signal may be received/derived/detected from one or more GNSS satellites.

RA Resource(s), RA Format(s) and/or RA Configuration(s)

In one example, the first condition may be (based on/related to) whether a type of RA resources is configured or indicated, e.g., on a cell, to the UE. The first condition may be fulfilled if the first type RA resources is not configured or indicated (on a cell and/or to the UE). The first condition may be fulfilled if the second type RA resources is configured or indicated (on a cell and/or to the UE). The first condition may be fulfilled if the first type RA resources is not available to use (on a cell and/or to the UE). The first condition may be not fulfilled if the first type RA resources is configured or indicated (on a cell and/or to the UE). The first condition may be not fulfilled if the second type RA resources is not configured or indicated (on a cell and/or to the UE). The first condition may be not fulfilled if the first type RA resources is available to use (on a cell and/or to the UE).

In one example, the first condition may be (based on/related to) which type of RA resources could be used earlier (e.g., based on the next PRACH occasion). The first condition may be fulfilled if the second type RA resources could be used earlier than the first type RA resources. The first condition may be fulfilled if the next PRACH occasion of the second type RA resources is earlier than the next PRACH occasion of the first type RA resources. The first condition may be fulfilled if the second type RA resources is/becomes available earlier than the first type RA resources. The first condition may be not fulfilled if the first type RA resources could be used earlier than the second type RA resources. The first condition may be not fulfilled if the next PRACH occasion of the first type RA resources is earlier than the next PRACH occasion of the second type RA resources. The first condition may be not fulfilled if the first type RA resources is/becomes available earlier than the second type RA resources.

The descriptions about RA resource(s) above may represent RA resource(s), RA format(s), and/or RA configuration(s).

### NW Indication

In one example, the first condition may be (based on/related to) whether the network indicating available of GNSS, e.g., for a group of UEs, for the UEs in a cell. The first condition may be fulfilled if the network indicates that GNSS is not available. The first condition may be not fulfilled if the network indicates that GNSS is available.

In one example, the first condition may be (based on/related to) whether the GNSS satellite(s) are accessible. The first condition may be fulfilled if the network indicates that (at least one of) the GNSS satellite(s) are not accessible. The first condition may be not fulfilled if the network indicates that (at least an among of) the GNSS satellite(s) are accessible.

In one example, the first condition may be (based on/related to) whether the GNSS measurement is triggered/configured. The first condition may be fulfilled if the network indicates that GNSS measurement is not triggered/configured for the UE. The first condition may be not fulfilled if the network indicates that GNSS measurement is triggered/configured for the UE.

In one example, the first condition may be (based on/related to) whether an indication (or a parameter) is configured. The first condition may be fulfilled if indication (or a parameter) is not configured. The first condition may be not fulfilled if the indication (or a parameter) is configured.

The indication (or parameter) may be a timer or time duration. The timer may be started with length of the time duration. The timer may be started at a specific time indicated by the NW. The UE may start or restart the timer in response to receiving the indication (or parameter). When the timer is running, the UE may consider GNSS, GNSS signal, GNSS position, UE location, TA value, and/or that the first type RA resources is valid. When the timer expires or is not running, the UE may consider GNSS, GNSS signal, GNSS position, UE location, TA value, and/or that the first type RA resources is invalid. The first condition may be fulfilled if the timer is not running or expires. The first condition may be not fulfilled if the timer is running.

The indication (or parameter) may be an indication of GNSS. The indication (or parameter) may be configured when the indication (or parameter) is present, e.g., in an NTN configuration. The indication (or parameter) may be not configured when the indication (or parameter) is absent, e.g., in an NTN configuration. The indication (or parameter) may be configured when the indication (or parameter) is set to TRUE, enabled, or available, e.g., in an NTN configuration. The indication (or parameter) may be not configured when the indication (or parameter) is set to FALSE, not enabled, or not available, e.g., in an NTN configuration.

The indication (or parameter) may be provided in a dedicated signal and/or a common signal. The indication (or parameter) may be provided for a UE, a group of UEs, or all UEs in the same cell. The indication (or parameter) may be provided for a cell or a group of cells. The indication (or parameter) may be provided in a system information, Radio Resource Control (RRC) message, Medium Access Control (MAC) Control Element (CE), and/or Downlink Control Information (DCI). The indication (or parameter) may be provided or associated with the RA resources, GNSS information, and/or NTN information.

### Power Mode

In one example, the first condition may be (based on/related to) whether the UE is in a power saving mode. The first condition may be fulfilled if the UE is in a power saving mode. The first condition may be not fulfilled if the UE is not in the power saving mode.

### Available/Knowledge of UE Location/GNSS Position/TA Value

In one example, the first condition may be (based on) user consent for location. The first condition may be fulfilled if the UE does not have user consent for location. The first condition may be not fulfilled if the UE has user consent for location.

In one example, the first condition may be (based on/related to) positioning mechanism. The first condition may be fulfilled if the UE could not perform positioning. The first condition may be not fulfilled if the UE could perform positioning.

In one example, the first condition may be (based on/related to) available of UE location/position. The first condition may be fulfilled if the UE does not have/acquire/know its location/position. The first condition may be not fulfilled if the UE has/acquires/knows its location/position. The first condition may be fulfilled if the UE could not use serving satellite position and/or its own position, e.g., to pre-compensate transmission delay. The first condition may be not fulfilled if the UE could use serving satellite position and/or its own position, e.g., to pre-compensate transmission delay.

In one example, the first condition may be (based on/related to) available of GNSS position. The first condition may be fulfilled if the UE does not have/acquire/know its GNSS position. The first condition may be not fulfilled if the UE has/acquires/knows its GNSS position.

In one example, the first condition may be (based on/related to) available of TA value. The first condition may be fulfilled if the UE does not have/acquire/know its TA value. The first condition may be not fulfilled if the UE has/acquires/knows its TA value. The TA value may be a timing advance to be pre-compensated by the UE, e.g., due to UE-Next Generation Node B (gNB) Round-Trip Time (RTT) in NTN.

Validity of NTN Information and/or GNSS Information

In one example, the first condition may be (based on/related to) validity of NTN information and/or GNSS information. The first condition may be fulfilled if the NTN information and/or GNSS information becomes/is invalid. The first condition may be not fulfilled if the NTN information and/or GNSS information becomes/is valid.

The validity of NTN information and/or GNSS information may be maintained by a timer (e.g., T430). The NTN information and/or GNSS information may become invalid when the timer is not running or expires. The timer may be started with length of a time duration, e.g., indicated by NW. The timer may be started at a specific time, e.g., indicated by the NW. The UE may start or restart the timer in response to receiving or being configured with the timer.

(Capability of) Pre-Compensating TA Value, UE-gNB RTT, and/or Frequency Shift

In one example, the first condition may be (based on/related to) the UE's capability. The first condition may be (based on/related to) capability for (or whether the UE is capable of) pre-compensating the TA value. The first condition may be (based on/related to) capability for (or whether the UE is capable of) pre-compensating or calculating the UE-gNB RTT. The first condition may be (based on/related to) capability for (or whether the UE is capable of) maintaining UL synchronization. The first condition may be (based on/related to) capability for (or whether the UE is capable of) pre-compensating frequency shift. The first condition may be fulfilled if the UE does not have the capability. The first condition may be not fulfilled if the UE has the capability.

In one example, the first condition may be (based on/related to) whether the UE could pre-compensate transmission delay, e.g., on the service link. The transmission delay may be (two-way) transmission delay between an uplink time synchronization reference point and a serving satellite. The uplink time synchronization reference point is the point where Downlink (DL) and UL are frame aligned with an offset given by N_{TA,offset}. The first condition may be fulfilled if the UE could not pre-compensate the transmission delay, e.g., on the service link. The first condition may be not fulfilled if the UE could pre-compensate the transmission delay, e.g., on the service link.

### Cause/Purpose/Trigger for RA

In one example, the first condition may be (based on/related to) triggering of an RA procedure. The first condition may be (based on) usage/reason/cause/purpose for an RA procedure. The first condition may be fulfilled if the RA procedure is triggered by a first cause. The first condition may be not fulfilled if the RA procedure is triggered by a second cause (or not triggered by the first cause). The first cause and/or the second cause may (at least) be (or include): initial access, reconfiguration of sync, UL synchronization, request for UL resources, Beam Failure Recovery (BFR), and/or System Information (SI) request. The initial access may be or comprise RRC connection establishment, RRC connection resume, and/or RRC connection reestablishment. The reconfiguration of sync may be or comprise Handover (HO), Conditional Handover (CHO), Primary Cell (PCell)/Primary Secondary Cell (PSCell) change, and/or Secondary Cell (SCell)/Secondary Cell Group (SCG) addition.

### RRC State

In one example, the first condition may be (based on/related to) a current RRC state. The first condition may be fulfilled if the UE is in a first RRC state. The first condition may be not fulfilled if the UE is in a second RRC state (or not in the first RRC state). The RRC state may be or comprise RRC idle state/mode, RRC inactive state/mode, and/or RRC connected state/mode.

### Availability of Parameters (e.g., Related to TA)

In one example, the first condition may be (based on/related to) whether the UE could receive, acquire, calculate, derive, and/or determine a parameter. The parameter may be ephemeris parameters for a serving satellite. The parameter may be N_{TA,adj}^{UE}. The parameter may be N_{TA,adj}^{common}. The parameter may be Delay_{common}(t). The parameter may be TA_{Common}, TA_{CommonDrift}, t_{epoch} and/or TA_{CommonDriftVariant}. The parameter may be ta-Common, ta-CommonDrift, and/or ta-CommonDriftVariant and/or t_{epoch}. The parameter may be a parameter specified and/or used in section 4.2 in TS 38.213 ([9] 3GPP TS 38.213 V 17.5.0). The parameter may be a common TA value. The parameter may be a cell-specific TA value. The parameter may be a UE specific TA value (which is calculated by the UE). The parameter may be a parameter received in NTN-Config, as specified in TS 38.331 ([4] 3GPP TS 38.331 V 17.5.0). The first condition may be fulfilled if the UE could not receive, acquire, calculate, derive, and/or determine the parameter. The first condition may be not fulfilled if the UE could receive, acquire, calculate, derive, and/or determine the parameter.

The current design of RA may not be feasible for a non-GNSS UE. For example, the current design of RA assumes that the UE could pre-compensate TA and/or frequency shift based on UE location obtained via GNSS, which cannot be achieved by a non-GNSS UE. To support non-GNSS UEs (e.g., the second type UE) in NTN, a new type of RA (e.g., the second type RA) different from the current design of RA (e.g., the first type RA) would be needed considering different characteristics between the second type UE and the first type UE, e.g., capability of pre-compensation of timing and frequency offset.

Generally, the NW could provide suitable RA resources (or configuration) to a UE, e.g., based on information provided by the UE (e.g., the capability information). For example, when the NW detects that a UE is a first type UE and/or the UE with GNSS capability, the NW would provide the first type RA resources to the UE. For example, after initial access, the UE enters RRC connected state and connects to a first cell. The UE could indicate its capability for GNSS to the NW. Then the NW would provide RA resources based on the capability. For a UE with GNSS capability, the NW would provide (dedicated) first type RA resources to the UE, e.g., for reconfiguration with sync, CHO, BFR.

However, it is also possible that the applicability of RA resource is dependent on some UE status, which may be changed from time to time. For example, the UE may move to an indoor area. The UE may lose connection to GNSS satellite(s). The UE may turn off GNSS operation for power saving. The UE would not or could not receive GNSS signal and/or perform GNSS operation after receiving the RA resources, e.g., before/upon/during an RA procedure. The UE could not know its own location and/or could not pre-compensate TA value/transmission delay, e.g., before/upon/during an RA procedure. The UE would fulfill a first condition, e.g., before/upon/during an RA procedure. For the case that NW configures a dedicated RA resource (e.g., the first type RA) to the UE (e.g., for CHO, for BFR), the UE status may change such that the UE would become unable to use the first type RA resources to perform the RA (e.g., handover, CHO, BFR) since the configured RA resource is (or becomes) not applicable to the UE. A UE may be a first type UE at a first timing and becomes a second type UE at a second timing.

To support GNSS independent mechanism in NTN, some enhancements on PRACH transmission would be introduced for UL pre-compensation in case GNSS availability or accuracy is reduced. A new type of RA may be defined for the non-GNSS UEs (in addition to the legacy type of RA for GNSS UEs). It is assumed that the first type RA resources (for UE with GNSS) and second type RA resources (for UE without GNSS) would be defined for NTN. Moreover, even for the UE with GNSS capability, the UE location may not be always available since the GNSS status could change from time to time.

In one example, upon initiation of an RA procedure, if a UE has obtained UE location via GNSS, it could select the first type RA resources for the RA procedure. During the RA procedure, if the GNSS status of the UE is lost, the RA procedure is likely to fail if the UE continues to use the first type RA resources without GNSS.

To solve the issue, a UE could perform a first action in response to the first condition. If the first condition is fulfilled, the UE may perform the first action. If the first condition is not fulfilled, the UE may not perform the first action. If the first condition is not fulfilled, the UE may perform a second action. The UE may check the first condition and/or determine whether to perform a first action and/or second action in response to a first event. When/if/after the first event occurs, the UE may check the first condition, perform the first action, and/or perform the second action. The first action may be a fallback action. The second action may be a legacy action in response to the first event.

The first event may be one or more of the following:
The UE receives an RRC message (e.g., RRCReconfiguration);
The UE receives a PDCCH order;
The UE receives a handover command or indication to trigger handover or CHO;
The UE receives dedicated RA resources (e.g., RACH-ConfigDedicated);
The UE triggers/initiates an RRC connection procedure;
The UE triggers/initiates an RA procedure;
The UE performs a handover or CHO;
The UE executes a reconfiguration with sync;
The UE performs conditional reconfiguration evaluation;
The UE requests a system information;
The UE detects beam failure;
The UE performs BFR;
The UE selects (set of) RA resources;
The UE transmits an Msg1 or MSGA;
Expiration of a timer (e.g., ra-ResponseWindow, msgB-ResponseWindow, ra-ContentionResolutionTimer, T430, T304).

The first action may be one or more of the following:
The UE does not initiate an RRC connection procedure;
The UE does not initiate an RA procedure;
The UE considers failure for an RRC connection;
The UE considers failure for an RA procedure;
The UE considers failure for reconfiguration with sync;
The UE considers radio link failure;
The UE stops/aborts an ongoing RRC connection procedure;
The UE stops/aborts an ongoing RA procedure;
The UE performs fallback during an ongoing RA procedure;
The UE initiates an RRC connection procedure, e.g., not using the RA resources provided in the first event;
The UE initiates a Contention-Based (CB) RA procedure;
The UE uses common RA resources;
The UE does not use dedicated RA resources;
The UE does not use the RA resources provided in the first event;
The UE releases/discards first type RA resources;
The UE releases/discards dedicated RA resources;
The UE acquires second type RA resources;
The UE (re)acquires a system information (e.g., a System Information Block (SIB) related to NTN or GNSS);
The UE transmits an indication to the NW;
The UE performs GNSS fix operation and/or GNSS measurement;
The UE requires GNSS signal/information;
The UE suspends UL/DL transmission;
The UE considers UL synchronization is lost;
The UE initiates an RRC connection re-establishment procedure;
The UE performs cell reselection;
The UE releases radio resources;
The UE discards measurement report(s);
The UE resets MAC entity;
The UE flushes Hybrid Automatic Repeat Request (HARQ) buffer(s);
The UE suspends radio bearer(s);
The UE enters RRC idle state;
The UE stops a timer (e.g., validity timer, RA timer); and/or
The UE (re)starts a timer (e.g., RRC timer, failure timer).

The common RA resources may be cell-specific RA resources. The common RA resources may be provided (or configured) by system information. The common RA resources may be contention-based. The common RA resources may not be dedicated to the UE. The common RA resources may be a first type RA. The common RA resources may be a second type RA.

The UE may transmit an indication to the NW to indicate that a first condition is fulfilled or occurs. The UE may transmit an indication to the NW to indicate that a failure occurs during an RA procedure or RRC connection procedure. The UE may transmit an indication to the NW to indicate that GNSS information becomes invalid. The UE may transmit an indication to the NW to indicate that the first type RA resources become unavailable. The UE may transmit an indication to the NW to indicate that the UE becomes, switches to, or is considered as a second type UE. The UE may transmit an indication to the NW to require second type RA resources. The indication may be an RRC message, MAC CE, and/or UE assistance information.

The second action may be one or more of the following:
The UE initiates an RRC connection procedure, e.g., using the RA resources provided in the first event;
The UE initiates an RA procedure, e.g., using the RA resources provided in the first event;
The UE initiates a CFRA procedure, e.g., using the RA resources provided in the first event;
The UE stops a timer (e.g., failure timer); and/or
The UE (re)starts a timer (e.g., validity timer).

For example, if GNSS status is lost during the RA procedure, the UE may determine to reselect another cell, based on no second type RA resources could be selected. For example, if GNSS status is lost during the RA procedure, the UE may determine to perform RA resource reselection (e.g., select the second type RA) and/or re-initiate the RA procedure.

In the following four examples, the UE may initiate a first RA procedure in a first cell. The first RA procedure may be triggered for handover, initial access, RRC reconfiguration (with sync), RRC connection establishment, RRC connection resume UL/DL data arrival, request for UL resources, and/or UL synchronization. In response to, upon, and/or after initiating the first RA procedure, the UE may determine (e.g., evaluate, measure) whether GNSS status of the UE is qualified or not. The UE may determine (e.g., evaluate, measure) the GNSS status of the UE upon initiation of the first RA procedure or RA resources (set) selection. The UE may determine (e.g., evaluate, measure) the GNSS status of the UE during the RA procedure. The UE may determine (e.g., evaluate, measure) the GNSS status of the UE before RA resources (set) selection and/or RA preamble transmission (e.g., Msg1, MSGA transmission). The GNSS status of the UE may be not qualified if the strength of GNSS signal is below or equal to a threshold, GNSS signal is not available, and/or GNSS information is invalid. The GNSS status of the UE may be qualified if the strength of the GNSS signal is above or equal to the threshold, the GNSS signal is available, and/or the GNSS information is valid. The determination of the GNSS status of the UE may comprise evaluating, measuring, deriving, calculating, monitoring and/or comparing the (strength of) GNSS signal and/or GNSS information, e.g. received by the UE. In response to, upon, and/or after initiating the first RA procedure, the UE may determine whether second type RA resources are available or not. The UE may determine the second type RA resources upon initiation of the first RA procedure or RA resources (set) selection. The second type RA resources may be available if the first cell is configured with the second type RA resources (for the UE). The second type RA resources may be not available if the first cell is not configured with the second type RA resources (for the UE). The second type RA resources may be available if the UE is provided the second type RA resources (in the first cell). The second type RA resources may be not available if the UE is not provided the second type RA resources (in the first cell).

In a first example, the UE may determine the GNSS status of the UE is qualified. The first cell may be configured with first type RA resources. The first cell may not be configured with second type RA resources. The UE may continue the first RA procedure (e.g., perform RA resources selection). The UE may select the first type RA resources based on the GNSS status of the UE is qualified.

In a second example, the UE may determine the GNSS status of the UE is qualified. The first cell may be configured with the first type RA resources. The first cell may be configured with the second type RA resources. The UE may continue the first RA procedure (e.g., perform RA resources selection). The UE may select the first type RA resources, e.g., based on the GNSS status of the UE is qualified. The UE may select the second type RA resources based on the second type RA resources could be used earlier than the first type RA resources.

In a third example, the UE may determine the GNSS status of the UE is not qualified. The first cell may be configured with the first type RA resources. The first cell may not be configured with the second type RA resources. If the UE determines the GNSS status of the UE is not qualified, the UE may determine whether second type RA resources are available or not. If the UE determines the second type RA resources are not available, the UE may not continue the first RA procedure. The UE may perform (at least) the following actions based on (at least) the GNSS status of the UE is not qualified and/or the second type RA resources are not available: stop the first RA procedure, initiate an RRC re-establishment procedure, re-select a second cell, select a second cell, and/or initiate a second RA procedure on a second cell. The second cell is configured with the second type RA resources.

In a fourth example, the UE may determine the GNSS status of the UE is not qualified. The first cell may be configured with the first type RA resources. The first cell may be configured with the second type RA resources. If the UE determines the GNSS status of the UE is not qualified, the UE may determine whether second type RA resources are available or not. If the UE determines the second type RA resources are available, the UE may continue the first RA procedure (e.g., perform RA resources selection). The UE may select second type RA resources based on the GNSS status of the UE is not qualified and/or second type RA resources are available.

The above examples could be combined, in whole or in part. In the above examples, the first type RA resources are different from the second type RA resources. The first type RA resources and the second type RA resources may comprise different time and/or frequency resources for the UE to perform RA and/or transmit the RA preamble. The first type RA resources may be designed for the UE with GNSS. The second type RA resources may be designed for the UE without GNSS.

Additionally and/or alternatively, the UE may initiate a first RA procedure on a first cell. The first RA procedure may be triggered for handover, initial access, RRC reconfiguration (with sync), RRC connection establishment, RRC connection resume UL/DL data arrival, request for UL resources, and/or UL synchronization. In response to, upon, and/or after initiating the first RA procedure, the UE may determine the GNSS status of the UE is qualified. The UE may determine the GNSS status of the UE upon initiation of the first RA procedure or RA resources (set) selection. The UE may determine the GNSS status of the UE before RA resources (set) selection and/or RA preamble transmission (e.g., Msg1, MSGA transmission). The GNSS status of the UE may be qualified if the strength of the GNSS signal is above or equal to the threshold, the GNSS signal is available, and/or the GNSS information is valid. The determination of the GNSS status of the UE may comprise evaluating, measuring, deriving, calculating, monitoring and/or comparing the (strength of) GNSS signal and/or GNSS information, e.g. received by the UE. The first cell may be configured with the first type RA resources. The first cell may be configured with the second type RA resources. The UE may continue the first RA procedure (e.g., perform RA resources selection). The UE may select the first type RA resources, e.g., based on the GNSS status of the UE is qualified. The UE may select RA resources (e.g., RA resources set, RA preamble group, RA preamble, PRACH occasions, and/or Physical Uplink Shared Channel (PUSCH) occasions) based on the first type RA resources. The UE may transmit an Msg1 or MSGA after RA resources selection. In response to transmitting the Msg1 or MSGA, the UE may monitor PDCCH for a NW response. The UE may determine that the GNSS status of the UE becomes not qualified during the first RA procedure. The UE may determine that the GNSS status of the UE becomes not qualified after, when, upon, and/or in response to the RA resources selection, Msg1 transmission, MSGA transmission, receiving the NW response, and/or not receiving the NW response (e.g., upon a RA timer expiry). In response to (determining that) the GNSS status of the UE becomes/becoming not qualified, the UE may perform (at least) the following actions. The UE may perform (at least) the following actions based on (at least) the GNSS status of the UE is not qualified (during the first RA procedure) and/or the second type RA resources are available. The UE may stop the first RA procedure. The UE may initiate a second RA procedure. The UE may not stop the first RA procedure. The UE may perform (and/or backoff/fallback to) RA resources selection in the first RA procedure or the second RA procedure. The UE may (re)select the second type RA resources, e.g., in the first RA procedure or the second RA procedure. The first type RA resources are different from the second type RA resources. The first type RA resources and the second type RA resources may comprise different time and/or frequency resources for the UE to perform RA and/or transmit the RA preamble. The first type RA resources may be designed for the UE with GNSS. The second type RA resources may be designed for the UE without GNSS.

Additionally and/or alternately, the UE could reuse a power ramping counter when the UE performs a first action. In the following description and/or throughout the disclosure, the power ramping counter may be PREAMBLE_POWER_RAMPING_COUNTER. The UE may not (re)set the power ramping counter to 1 when the UE performs a first action. The UE may set the power ramping counter to a stored value when the UE performs a first action.

Additionally and/or alternately, the NW could (always) provide both types of RA resources, e.g., for first type UE, for BFR. The NW may provide both the first type RA resources and second type RA resources to a UE if (at least) one or more of the following second conditions is fulfilled:
The UE is a first UE;
The NW triggers a handover or CHO procedure for the UE;
The NW provides a handover command or indication to change serving cell of the UE;
The NW provides dedicated RA resources to the UE;
The NW provides RA resources for BFR for the UE;
The NW detects first condition for the UE; and/or
The NW receives an indication or assistance information from the UE.

The UE may determine to use which type of RA resource(s) based on applicability of the RA resource(s). The applicability may be dependent on some UE status (and/or capability), e.g., the first condition. For example, if a first type RA (and a second type RA) is configured to the UE and the first type RA is (or becomes) not applicable to the UE, the UE may use a second type RA (if the second type RA is applicable to the UE). If a second type RA (and a first type RA) is configured to the UE and the second type RA is (or becomes) not applicable to the UE, the UE may use a first type RA (if the first type RA is applicable to the UE). If all the configured RA resource(s) are not applicable, the UE may perform the first action (specified above).

Additionally and/or alternately, when a first type UE uses second type RA resources, the first type UE may or may not perform (some of) the first procedures. When a first type UE camps on/selects/reselects a cell without first type RA resources, the first type UE may or may not perform (some of) the first procedures. The first procedure may be performed by the UE with GNSS as in the current specification ([2] 3GPP TS 38.300 V 17.5.0, [3] 3GPP TS 38.321 V 17.5.0, [4] 3GPP TS 38.331 V 17.5.0). The first procedure may be related to GNSS, UE location, and/or TA pre-compensation. The first procedure may be performed for initial access. The first procedure may be or comprise TA reporting, TA pre-compensation, and/or UE-gNB RTT estimation.

The first type UE may determine whether to perform a first procedure based on whether the NW (or cell) provides first type RA resources. The first type UE may perform a first procedure if the NW (or cell) provides first type RA resources. The first type UE may not perform a first procedure if the NW (or cell) does not provide first type RA resources.

The first type UE may determine whether to perform a first procedure based on whether the first type UE selects/uses second type RA resources. The first type UE may perform a first procedure if the first type UE selects/uses first type RA resources. The first type UE may not perform a first procedure if the first type UE selects/uses second type RA resources.

The first type UE may determine whether to perform a first procedure based on whether the first type UE camps on/selects/reselects a cell with first type RA resources. The first type UE may perform a first procedure if the first type UE camps on/selects/reselects a cell with first type RA resources. The first type UE may not perform a first procedure if the first type UE camps on/selects/reselects a cell without first type RA resources.

Additionally and/or alternately, the first type UE may or may not indicate the NW whether it would use first type RA resources, e.g., after initial access. The first type UE may indicate the NW that it would not use first type RA resources if a first condition is fulfilled. The first type UE may indicate the NW that a first condition is fulfilled. The first type UE may provide assistance information related to the first condition and/or usage of RA resources to the NW. The assistance information may be a UE status related to the first condition. The assistance information may be (or include): selection of RA resources, GNSS status of the UE, awareness of UE location, and/or the like (e.g., preference on RA resources). The first type UE may report the assistance information if/when/upon/in response to change of the UE status, serving cell change, initial access, triggering/completing a RA procedure. The first type UE may report the assistance information via an RRC message and/or MAC CE.

One or more of the above and herein embodiments, concepts, methods, aspects, and/or examples could be combined, in whole or in part.

The UE may receive configurations related to NTN and/or GNSS, e.g., via a system information and/or RRC message. The UE may receive NTN information via SIB3, SIB19, SIB31 and/or SIBxx as in [7]R2-2306954. The UE may receive RA configurations and/or RA resources via a system information (e.g., SIB1) and/or RRC message (e.g., RRCReconfiguration, RRCResume, RRCSetup). The UE may receive configurations related to cell (re)selection, e.g., via a system information and/or RRC message. The UE may receive parameter(s) and/or indication(s) for cell (re)selection via an MIB, SIB1, SIB2, SIB3, SIB4, SIB5, SIB19, SIB31, and/or a new SIB related to NTN.

Throughout the disclosure, the “handover/CHO” may correspond to, may be supplemented with and/or may be replaced by “reconfiguration with sync”. The handover/CHO procedure may correspond to, may be supplemented with, and/or may be replaced by an RRC reconfiguration procedure and/or a procedure of reconfiguration with sync. A handover/CHO procedure may be triggered upon the UE receiving an RRC reconfiguration message (e.g., RRCReconfiguration). A handover/CHO procedure may be completed upon the UE transmitting an RRC message (e.g., RRCReconfigurationComplete) in response to an RRC reconfiguration message (e.g., RRCReconfigurtaion). A handover/CHO procedure may be completed upon the UE camping/linking to the target cell. A handover/CHO procedure may be completed upon a handover failure occurring (e.g., reconfiguration with sync failure occurs, T304 expiry).

The UE may be in a cell of an NTN. The UE may be connected to a cell of an NTN. The UE may camp on a cell of an NTN. The UE may be connected to an LEO, GEO, MEO, HEO, and/or HAPS. Throughout the disclosure, a cell may be/may refer to an NTN cell. A cell may be a serving cell. A cell may be a non-serving cell. A cell may be a neighbor cell and/or target cell.

The UE may be referred to the UE, an RRC layer of the UE or a MAC entity of the UE.

The UE may be a New Radio (NR) device. The UE may be an NR-light device. The UE may be a Long-Term Evolution (LTE) device. The UE may be a Narrowband Internet of Things (NB-IoT) device. The UE may be an Enhanced Machine-Type Communication (eMTC) device. The UE may be a reduced capability device. The UE may be a mobile phone. The UE may be a wearable device. The UE may be a sensor. The UE may be a stationary device.

The network may be a network node. The network may be a base station. The network may be an access point. The network may be an Evolved Node B (eNB). The network may be a gNB. The network may be a gateway.

Embodiments, concepts, methods, aspects, and/or examples of the present invention are described below.

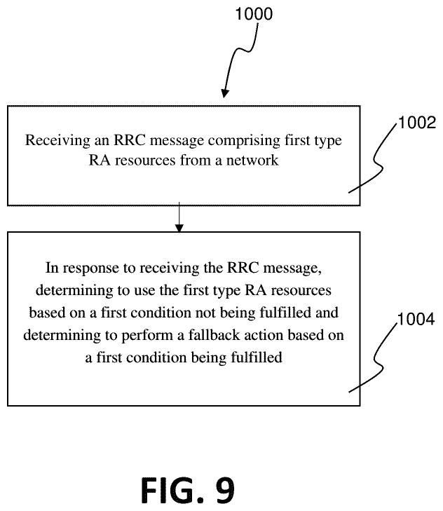

Referring to FIG. 9, with this and other concepts, systems, and methods of the present invention, a method 1000 for a UE comprises receiving an RRC message comprising first type RA resources from a network (step 1002), and in response to receiving the RRC message, determining to use the first type RA resources based on a first condition not being fulfilled and determining to perform a fallback action based on a first condition being fulfilled (step 1004).

In various embodiments, the UE is a UE with GNSS capability.

In various embodiments, the first type RA resources is for UE with GNSS capability.

In various embodiments, the first condition is that a GNSS (signal) is not available.

In various embodiments, the first condition is that UE location is not available.

In various embodiments, the first condition is that GNSS position is not available or not valid.

In various embodiments, the first condition is that a validity timer is not running.

In various embodiments, the fallback action is that the UE does not initiate an RA procedure using the first type RA.

In various embodiments, the fallback action is that the UE releases the first type RA resources.

In various embodiments, the fallback action is that the UE transmits an indication to the NW.

Referring back to FIGS. 3 and 4, in one or more embodiments from the perspective of a UE, the device 300 includes a program code 312 stored in memory 310 of the transmitter. The CPU 308 could execute program code 312 to: (i) receive an RRC message comprising first type RA resources from network; and (ii) in response to receiving the RRC message, determining to use the first type RA resources based on a first condition not being fulfilled and determining to perform a fallback action based on a first condition being fulfilled. Moreover, the CPU 308 can execute the program code 312 to perform all of the described actions, steps, and methods described above, below, or otherwise herein.

The first type RA resources and second type RA resources may be provided in different NTN cells. The coexistence between a first type UE (e.g., UE with GNSS) and a second type UE (e.g., UE without GNSS) in a cell or between cells should be considered. The first type RA resources may be provided on a first cell. The second type RA resources may be provided on a second cell. The first type RA resources may be or may not be provided on the second cell. The second type RA resources may be or may not be provided on the first cell. If a UE (e.g., the second type UE) cannot use a specific type RA (e.g., the first type RA), e.g., for initial access, although the UE can camp on a cell providing only the specific type RA (and/or not providing a type of RA that the UE can use), it cannot perform RA access to the cell.

To solve the issue, the UE could (determine whether to) access, camp on, and/or (re)select to an NTN cell (in RRC idle state and/or RRC inactive state) based on (at least) GNSS capability, a first condition (as described above), and/or whether a specific type of RA (resources) is supported/provided/configured in the NTN cell. For example, if a UE is a specific type of UE (e.g., the first type UE, the second type UE), the UE may (determine to or determine not to) access/camp on/select/reselect a cell based on (whether) the cell supports/provides/configures at least a type of RA that the UE can use, (whether) at least a specific type RA is supported/provided/configured in the cell, and/or an NW indication, such as whether the UE (or the specific type of UE) is barred (or allowed to access).

A first type UE could access/camp on/select/reselect a cell with first type RA (resources). A first type UE could access/camp on/select/reselect a cell with second type of RA (resources). A first type UE could access/camp on/select/reselect a cell without first type RA (resources). A first type UE could use first type RA (resources) or second type RA (resources). If a UE is a first type UE, the UE may use the first type RA. If a UE is a first type UE, the UE may or may not use the second type RA. If a UE is a first type UE, the UE may access/camp on/select/reselect a cell with first type RA (resources). If a UE is a first type UE, the UE may access/camp on/select/reselect a cell with second type RA (resources). If a UE is a first type UE, the UE may access/camp on/select/reselect a cell without first type RA (resources). A UE may perform the determination based on one or more of the above (e.g., check if one or more of the above conditions are fulfilled).

A second type UE could access/camp on/select/reselect a cell with second type RA (resources). A second type UE could not access/camp on/select/reselect a cell without second type RA (resources). A second type UE could use second type RA (resources). The second type UE could not use first type RA (resources). If a UE is a second type UE, the UE may use the second type RA. If a UE is a second type UE, the UE may or may not use the first type RA. If a UE is a second type UE, the UE may access/camp on/select/reselect a cell with first type RA (resources). If a UE is a second type UE, the UE may access/camp on/select/reselect a cell with second type RA (resources). If a UE is a second type UE, the UE may not access/camp on/select/reselect a cell without second type RA (resources). A UE may perform the determination based on one or more of the above (e.g., check if one or more of the above conditions are fulfilled).

The cell with first type of RA (resources) may be a cell configured with first type RA (resources). The cell with first type of RA (resources) may be a cell configured with second type RA (resources). The cell with first type of RA (resources) may be a cell not configured with second type RA (resources). The cell with first type of RA (resources) may not be a cell not configured with first type RA (resources). The cell with first type RA (resources) may be a cell configured for first type UE. The cell with first type RA (resources) may be a cell indicated for first type UE.

The cell with second type of RA (resources) may be a cell configured with second type RA (resources). The cell with second type of RA (resources) may be a cell configured with first type RA (resources). The cell with second type of RA (resources) may be a cell not configured with first type RA (resources). The cell with second type of RA (resources) may not be a cell not configured with second type RA (resources). The cell with second type RA (resources) may be a cell configured for second type UE. The cell with second type RA (resources) may be a cell indicated for second type UE.

A first type cell may be the cell with first type of RA (resources). The first type cell may be a cell indicated with GNSS (capability). The first type cell may be a cell indicated as prioritizing first type UE.

A second type cell may be the cell with second type of RA (resources). The second type cell may be a cell indicated without GNSS (capability). The second type cell may be a cell indicated as prioritizing second type UE.

The first type cell or the second type cell may be determined, configured or indicated by the NW, via system information, or RRC message. The UE may detect and/or determine whether a cell is a first type cell or second type cell based on RA resources. The UE may detect and/or determine whether a cell is a first type cell or second type cell based on a NW indication (e.g., barred bit).

Alternatively and/or additionally, the cell type differentiation could be based on (at least) the first condition. The first type UE and the second type UE may be differentiated by (at least) the first condition. For example, a first type cell may be associated to (or corresponding to) a first type UE. A second type cell may be associated to (or corresponding to) a second type UE. The association (or the correspondence) may be based on the first condition. The first type UE may be a UE not fulfilling the first condition. The second type UE may be a UE fulfilling the first condition. If a UE is a first type UE, the UE may use the first type RA. If a UE is a second type UE, the UE may use the second type RA. If a UE is a first type UE, the UE may or may not use the second type RA. If a UE is a second type UE, the UE may or may not use the first type RA.

Additionally and/or alternately, the first type UE could determine to camp on/select/reselect a second type cell based on (at least) the first condition. The first type UE may camp on/select/reselect a second type cell if/when/in response to fulfilling the first condition. The first type UE may be considered as, be, and/or become a second type UE based on (at least) the first condition. The first type UE could determine to camp on/select/reselect a second type cell based on other criterion and/or parameters for cell selection and/or reselection, as specified in TS 38.304 ([8] 3GPP TS 38.304 V 17.5.0). The first type UE could determine to prioritize a first type cell (or a second type cell) based on (at least) the first condition. The first type UE may prioritize a second type cell if/when/in response to not fulfilling the first condition. The first type UE may prioritize a second type cell if/when/in response to fulfilling a first condition. The first type UE may check the first condition before, upon, or in response to performing a cell (re)selection. The first type UE may check the first condition before, upon, or in response to entering RRC idle state.

For example, a first type UE may camp on/select/reselect a second type cell if a GNSS signal is not available, e.g., based on measuring radio condition, network indication. If the GNSS is not available when the first type UE performs measurement on neighbor cells, the first type UE camps on/selects/reselects a second type cell. If the GNSS is not available when the first type UE performs cell (re)selection, the first type UE camps on/selects/reselects a second type cell.

For example, a first type UE may camp on/select/reselect a second type cell if first type cell is not detected and/or is available. If the first type cell is not detected when the first type UE performs measurement on neighbor cells, the first type UE camps on/selects/reselects a second type cell. If the first type cell is not detected when the first type UE performs cell (re)selection, the first type UE camps on/selects/reselect a second type cell.

For example, a first type UE may camp on/select/reselect a second type cell if/when/in response to the first type UE has not acquired (or derived) a valid TA value, UE location, and/or GNSS position. The first type UE may receive NTN information (e.g., via system information, via RRC reconfiguration message) from the NW. The first type UE may acquire (or derive) UE location via GNSS. The first type UE may pre-compensate the TA value based on the NTN information and the UE location. The first type UE may fail to receive NTN information, acquire (or derive) UE location and/or pre-compensate the TA value. If/when/in response to the first type UE failing to receive NTN information, acquire (or derive) UE location, and/or pre-compensate the TA value, the first type UE camps on/selects/reselects a second type cell when the first type UE is in RRC idle/inactive state. If/when/in response to the first type UE failing to receive NTN information, acquire (or derive) UE location, and/or pre-compensate the TA value, the first type UE camps on/selects/reselects a second type cell when the first type UE performs measurement on neighbor cells. If/when/in response to the first type UE failing to receive NTN information, acquire (or derive) UE location, and/or pre-compensate the TA value, the first type UE camps on/selects/reselects a second type cell when the first type UE performs cell (re)selection.

For example, a first type UE may prioritize a first type cell (for cell reselection) if/when/in response to the first type UE has acquired (or derived) a valid TA value, UE location, and/or GNSS position. The first type UE may receive NTN information (e.g., via system information, via RRC reconfiguration message) from the NW. The first type UE may acquire (or derive) UE location via GNSS. The first type UE may pre-compensate the TA value based on the NTN information and UE location. If/when/in response to the first type UE having valid NTN information, UE location, and/or TA value, the first type UE prioritizes a first type cell (for cell reselection) when the first type UE is in RRC idle/inactive state. If/when/in response to the first type UE having valid NTN information, UE location, and/or TA value, the first type UE prioritizes a first type cell when the first type UE performs cell (re)selection.

Additionally and/or alternately, a UE (e.g., a specific type of UE, the first type UE, the second type UE) could be prevented from accessing/camping on/selecting/reselecting a first type cell based on one or more of following examples. A (NW) indication may be provided by a cell to indicate whether a UE (e.g., a specific type UE, the first type UE, the second type UE) is allowed to camp on/select/reselect the cell. The (NW) indication may be a barring bit. The (NW) indication may indicate whether the UE is barred by the cell.

For example, the second type UE could be prevented from camping on/selecting/reselecting a first type cell based on cell-ranking criterion, offset, and/or priority. The UE may receive one or more parameters related to cell (re)selection and/or first type cell. The UE may apply the parameter(s) for cell reselection criteria and/or measurement rules. The UE may apply the parameter(s) for access restrictions.

For example, the second type UE could be prevented from camping on/selecting/reselecting a first type cell based on an (NW) indication, e.g., a barring bit. The (NW) indication (e.g., the barring bit) may be configured or provided in a system information (e.g., MIB, SIB1). The (NW) indication (e.g., the barring bit) may be one of the current barring bits specified in TS 38.304 ([8] 3GPP TS 38.304 V 17.5.0). The (NW) indication (e.g., the barring bit) may be a different barring bit from the current barring bits specified in TS 38.304 ([8] 3GPP TS 38.304 V 17.5.0). The (NW) indication (e.g., the barring bit) may be a specific barring bit for GNSS and/or NTN. The (NW) indication (e.g., the barring bit) may be applied to or used by the second type UE. The (NW) indication (e.g., the barring bit) may not be applied to or used by the first type UE. The (NW) indication (e.g., the barring bit) may be applied to or used by an NTN UE. The (NW) indication (e.g., the barring bit) may not be applied to or used by a non-NTN UE.

Based on the (NW) indication (e.g., the barring bit), when cell status is indicated as “not barred”, “not reserved” for operator use, not “true” for other use, and/or not “true” for future use, the second type UE treats this cell as a candidate during the cell selection and/or cell reselection procedures. Based on the (NW) indication (e.g., the barring bit), when cell status is indicated as “barred”, “reserved” for operator use, “true” for other use, and/or “true” for future use, the second type UE does not treat this cell as a candidate during the cell selection and/or cell reselection procedures. If the (NW) indication (e.g., the barring bit) is omitted or not configured, the second type UE treats this cell as a candidate during the cell selection and/or cell reselection procedures. If the (NW) indication (e.g., the barring bit) is present or configured, the second type UE does not treat this cell as a candidate during the cell selection and/or cell reselection procedures. If the (NW) indication (e.g., the barring bit) is present or configured, the second type UE treats this cell as if the cell status is “barred”. When cell status “barred” is indicated or to be treated as if the cell status is “barred”, the second type UE may not select/reselect this cell.

For a second type cell, the (NW) indication (e.g., the barring bit) may be indicated as “not barred”, “not reserved” for operator use, not “true” for other use, and/or not “true” for future use. For a first type cell, the (NW) indication (e.g., the barring bit) may be indicated as “barred”, “reserved” for operator use, “true” for other use, and/or “true” for future use. For a second type cell, the (NW) indication (e.g., the barring bit) may not be configured. For a first type cell, the (NW) indication (e.g., the barring bit) may be configured. The second type UE may treat a second type cell as a candidate during a cell selection and/or cell reselection procedure. The second type UE may not treat a first type cell as a candidate during a cell selection and/or cell reselection procedure. The second type UE may exclude a first type cell as a candidate during a cell selection and/or cell reselection procedure. The second type UE may exclude a first type cell from a candidate list.

Additionally and/or alternately, the second type UE could perform a first action (as described above) if/when/in response to the second type UE does not camp on, select, reselect, access, and/or connect to a second type cell. The second type UE may perform the first action if/when/in response to the second type UE could not camp on, select, reselect, access, and/or connect to a second type cell (e.g., if/when/in response to the UE considering the cell as barred). The second type UE may perform the first action if/when/in response to the second type UE camps on, selects, reselects, accesses, and/or connects to a first type cell. The second type UE may perform the first action if/when/in response to the second type UE does not have available second type RA resources. The second type UE may perform the first action if/when/in response to the second type UE is not receiving second type RA resources. The first action may be a fallback action and/or a failure handing.

For example, the UE may receive RA resources and/or RA configurations from a system information of a first cell. The UE may initiate an RA procedure for initial access to the first cell. The UE may initiate an RRC connection establishment procedure to the first cell. The RA procedure may be triggered by the RRC connection establishment procedure. In response to triggering of the RA procedure and/or RRC connection establishment procedure, the UE may check/detect/determine whether the first cell is a second type cell. In response to triggering of the RA procedure and/or RRC connection establishment procedure, the UE may check/detect/determine whether second type RA resources is available. The UE may check/detect/determine that the first cell is not a second type cell. The RA resources and/or RA configurations may not be or comprise second type RA resources. Then the UE may perform cell reselection. The UE may not trigger the RA procedure. The UE may stop the RA procedure. The UE may stop the RRC connection establishment procedure. The UE may consider the RRC connection establishment procedure as a failure. The UE may be a second type UE. The UE may be in RRC idle state.

For example, the UE may receive dedicated RA resources from an RRC reconfiguration message in a first cell. The UE may initiate an RA procedure for handover to a second cell. The UE may initiate an RRC reconfiguration procedure to the second cell. The RA procedure may be triggered by/for the RRC reconfiguration procedure. In response to triggering of the RA procedure and/or RRC reconfiguration procedure, the UE may check/determine whether the dedicated RA resources are suitable. If the UE is a second type UE and the dedicated RA resources are second type RA resources, the dedicated RA resources are considered as suitable. If the UE is a second type UE and the dedicated RA resources are first type RA resources, the dedicated RA resources are considered as not suitable. If the RA resources are not suitable (for performing the handover), the UE may not perform the RRC reconfiguration procedure and/or RA procedure. The UE may stop the RRC reconfiguration procedure and/or the RA procedure. The UE may perform cell reselection. The UE may consider the RRC reconfiguration procedure as a failure. If the RA resources are not suitable (for performing the handover), the UE may use common RA resources other that the dedicated RA resources provided in the RRC reconfiguration message. The UE may perform the RA procedure and/or the RRC reconfiguration procedure using common RA resources. The UE may be in RRC connected state.

For example, the UE may initiate an RRC connection re-establishment procedure in RRC connected state. The UE may perform cell selection during the RRC connection re-establishment procedure. The UE may not select or detect a second type cell. The UE may enter RRC idle state, in response to not selecting or detecting a second type cell. The UE may be a second type UE.

The RA design for a non-GNSS UE (e.g., second type UE) may be non-backwards compatible. In order to provide access for both a first type UE (e.g., GNSS UE) and a second type UE (e.g., non-GNSS UE), both types of RA resources need to be provided (separately). According to TR 38.821 ([1] 3GPP TR 38.821 V 16.1.0), the RA resources may be separated based on GNSS capabilities of UEs. The legacy design of RA (e.g., the first type RA) provides access for the UE with GNSS capability. The new type of RA (e.g., the second type RA) provides access for the UE without GNSS capability. If a UE is with GNSS capability, it can only use the legacy design of RA (e.g., the first type RA). If a UE is without GNSS capability, it can only use the new type of RA (e.g., the second type RA). However, such RA differentiation based on GNSS capability results in resource inefficiency, since a UE can only use part of the RACH resources (e.g., the UE with GNSS capability cannot utilize the new type of RA (e.g., the second type RA)).

To solve the issue, the RA (resources) differentiation should not (at least) be (merely) based on GNSS capability of a UE. It should be allowed for a UE with GNSS capability to use the new type of RA (resources) (e.g., the second type RA). For example, a UE with GNSS capability, but cannot obtain its location and/or cannot pre-compensate TA and/or frequency shift (e.g., based on its UE location), may use the second type RA and/or not use the first type RA. Alternatively and/or additionally, a UE without GNSS capability, but can obtain its location and/or can pre-compensate TA and/or frequency shift (e.g., based on its UE location), may use the first type RA and/or not use the second type RA.

A first type UE may use second type RA (resources). A first type UE may use first type RA (resources) and/or second type RA (resources). A second type UE may use second type RA (resources). The second type UE may not use first type RA (resources). The second type RA (resources) may be shared by a first type UE and a second type UE.

The first type UE could use/determine to use/determine whether to use second type RA (resources) based on the first condition. For example, the UE with GNSS capability could use RA resources (or RA schemes) for UE without GNSS capability (the second type RA resources), e.g., based on a first condition. The first type UE could (determine to) use second type RA (resources) if/when/in response to fulfilling the first condition. The first type UE may not (or determine to not) use second type RA (resources) if/when/in response to not fulfilling the first condition. The first type UE may (determine to) use second type RA (resources) if/when/in response to not fulfilling the first condition. The first type UE may not (or determine not to) use second type RA (resources) if/when/in response to fulfilling the first condition. The first type UE may (determine to) use first type RA (resources) if/when/in response to not fulfilling the first condition. The first type UE may use first type RA (resources) regardless of the first condition. The first type UE may prioritize the first type RA (resources) over the second type RA (resources). The first type UE may check the first condition before or upon triggering an RA procedure. The first type UE may check the first condition during an RA procedure. The first type RA (resources) may be provided on a cell. The first type RA (resources) may not be provided on the cell. The second type RA (resources) may be provided on the cell.

Alternatively and/or additionally, the RA (resources) differentiation could be based on (at least) the first condition. The first type UE and the second type UE may be differentiated by (at least) the first condition. For example, a first type RA may be associated to (or corresponding to) a first type UE. A second type RA may be associated to (or corresponding to) a second type UE. The association (or the correspondence) may be based on the first condition. The first type UE may be a UE fulfilling the first condition. The second type UE may be a UE not fulfilling the first condition. The first type UE may be a UE not fulfilling the first condition. The second type UE may be a UE fulfilling the first condition. If a UE is a first type UE, the UE may use the first type RA. If a UE is a second type UE, the UE may use the second type RA. If a UE is a first type UE, the UE may or may not use the second type RA. If a UE is a second type UE, the UE may or may not use the first type RA.

The second type UE may not (be allowed to) use the first type RA, e.g., regardless of the first condition. Alternatively and/or additionally, the second type UE could determine to use first type RA (resources) based on the first condition. The second type UE could (determine to) use first type RA (resources) if/when/in response to fulfilling the first condition. The second type UE may not (or determine to not) use first type RA (resources) if/when/in response to not fulfilling the first condition. The second type UE may (determine to) use first type RA (resources) if/when/in response to not fulfilling the first condition. The second type UE may not (or determine not to) use first type RA (resources) if/when/in response to fulfilling the first condition. The second type UE may use second type RA (resources) regardless of the first condition. The second type UE may check the first condition before or upon triggering a RA procedure. The second type UE may check the first condition during an RA procedure. The second type RA (resources) may be provided on a cell. The second type RA (resources) may not be provided on the cell. The first type RA (resources) may be provided on the cell.

In one example, a first type UE may use second type RA (resources) if a GNSS signal is not available. GNSS signal not available (for a UE) may be that the UE is not capable of receiving the GNSS signal, the GNSS signal cannot be detected, the GNSS signal received by the UE is not qualified/sufficient/strong enough (e.g., to obtain GNSS location), and/or the UE cannot perform GNSS operation (e.g., GNSS measurement). The first type UE may trigger an RA procedure and/or an RRC connection procedure. The first type UE may check whether GNSS is available, e.g., based on measuring radio condition, network indication. If the GNSS is not available before/upon triggering the RA procedure and/or the RRC connection procedure, the first type UE uses second type RA (resources). If the GNSS is not available after or in response to triggering the RA procedure and/or the RRC connection procedure (for a duration of time), the first type UE uses second type RA (resources). If the GNSS is available before/upon triggering the RA procedure and/or the RRC connection procedure, the first type UE uses first type RA (resources). If the GNSS is available after or in response to triggering the RA procedure and/or the RRC connection procedure (within a duration of time), the first type UE uses the first type RA (resources).

In one example, a first type UE may use second type RA (resources) if first type RA (resources/format/configuration) is not provided and/or available, e.g., for initial access. The first type UE may trigger an RA procedure and/or an RRC connection procedure. The first type UE may check whether first type RA (resources) is configured and/or available. If the first type RA (resources) is not configured or is not available before/upon triggering the RA procedure and/or the RRC connection procedure, the first type UE uses second type RA (resources). The first type RA (resources) may be not available if the next PRACH occasion is too far, e.g., exceeding a time duration. If the first type RA (resources) is configured (and is available) before/upon triggering the RA procedure and/or the RRC connection procedure, the first type UE uses the first type RA (resources).

In one example, a first type UE may use second type RA (resources) if the first type UE has not acquired (or derived) a valid TA value, UE location and/or GNSS position. The first type UE may receive NTN information (e.g., via system information, via RRC reconfiguration message) from the NW. The first type UE may acquire (or derive) UE location via GNSS. The first type UE may pre-compensate a TA value based on the NTN information and UE location. The first type UE may fail to receive NTN information, acquire (or derive) UE location, and/or pre-compensate the TA value. The first type UE may trigger an RA procedure and/or an RRC connection procedure. If the first type UE fails to receive NTN information, acquire (or derive) UE location and/or pre-compensate a TA value, the first type UE uses second type RA (resources), in response to triggering the RA procedure and/or the RRC connection procedure.

In one example, a first type UE may use second type RA (resources) based on RA triggering and/or RRC state. The first type UE may trigger an RA procedure and/or an RRC connection procedure. If the RA procedure and/or the RRC connection procedure is for initial access, the first type UE uses second type RA (resources). If the RA procedure and/or the RRC connection procedure is not for initial access, the first type UE uses first type RA (resources). If the RA procedure and/or the RRC connection procedure is for handover, the first type UE uses second type RA (resources). If the RA procedure and/or the RRC connection procedure is not for handover, the first type UE uses first type RA (resources).

If the UE is a second type UE, the UE could use the second type RA (resources). If a UE is a second type UE, the UE could not use the first type RA (resources). If the UE is a first type UE, the UE could use the second type RA (resources). If the UE is a first type UE, the UE could use the first type RA (resources).

In one example, a second type UE could not use a first type RA (resources). The second type UE has GNSS capability. The second type UE is configured/equipped with a GNSS device/receiver. The second type UE does not receive/acquire/derive/have (sufficient) GNSS signal or information. The second type UE fulfils a first condition. The second type UE is not able to pre-compensate the TA value.

In one example, a second type UE could use a second type RA (resources). The second type UE has GNSS capability. The second type UE is configured/equipped with a GNSS device/receiver. The second type UE does not receive/acquire/derive/have (sufficient) GNSS signal or information. The second type UE fulfils a first condition. The second type UE is not able to pre-compensate a TA value.

In one example, for operation with GNSS, a UE could use the first type RA (resources). For operation with GNSS, a UE could use the second type RA (resources). For operation without GNSS, a UE could use the second type RA (resources). For operation without GNSS, a UE could not use the first type RA (resources).

For some cases (e.g., handover, reconfiguration with sync, BFR), the NW may provide dedicated RA resources for the UE. If the RA resources differentiation between the first type RA and the second type RA is based on (at least) the first condition (e.g., GNSS status, knowledge of UE location, GNSS signal strength), which may be changed from time to time, and it may not be known to the NW (at least not synchronously), the NW may not know how to provide dedicated RA resources to the UE, e.g., whether to provide the first type RA or the second type RA.

To solve the issue, the NW could (always) provide (dedicated) second type RA resources, e.g., on an NTN cell, to the first type UE. For initial access, since the NW does not know whether a UE has its own location or not (e.g., whether the UE is a first type UE or a second type UE), the NW could (always) provide second type RA resources for the UE. The NW may not provide (common) first type RA resources on an NTN cell. The NW may provide (common) second type RA resources on an NTN cell. The NW may provide (common) first type RA resources on an NTN cell. The NW may provide (dedicated) second type RA resources on an NTN cell. The NW may provide (dedicated) second type RA resources to a UE. The NW may not provide (common) second type RA resources on an NTN cell. The NW may not provide (common) first type RA resources on an NTN cell.

To solve the issue, the UE could provide assistance information related to the first condition to the NW. The assistance information may be a UE status related to the first condition. The assistance information may be (or include): GNSS status of the UE, awareness of UE location, and/or the like (e.g., preference on RA resources). The UE may report the assistance information if/when/upon/in response to change of the UE status, serving cell change, initial access, triggering/completing a RA procedure. The UE may be a first type UE.

The NW would provide NTN assistance information to the UE via a system information (e.g., SIB19 in NR, SIB31 in LTE) or a dedicated RRC message (e.g., RRCReconfiguration). The system information may be NTN-specific system information. The dedicated RRC message (e.g., RRCReconfiguration) may be provided in a handover procedure. The NW could broadcast NTN assistance information to the UEs in a serving cell. The NW could provide NTN assistance information to a UE when handing over the UE from the serving cell to a target cell.

The NTN assistance information may be satellite information of a serving cell and/or neighbor cell(s). The NTN assistance information and/or satellite information may be or comprise NTN configuration(s) (e.g., NTN-Config). The NTN configuration (e.g., NTN-Config) may comprise (at least) ephemeris information (e.g., ephemerisInfo), common TA information (e.g., ta-Info), K offset (e.g., cellSpecificKoffset), k mac (e.g., kmac), epoch time (e.g., epochTime), validity duration (e.g., ntn-UlSyncValidityDuration), and/or cell reference location (e.g., referenceLocation). The UE could use the NTN configuration (e.g., NTN-Config) to access a serving cell, adjust/compensate TA (e.g., for a serving cell), and/or perform measurement (e.g., on a serving cell, on a neighbor cell).

The ephemeris information may be ephemeris information of a (serving) satellite. The ephemeris information may comprise/indicate position, velocity, and/or orbit of the (serving) satellite. The common TA information may be, comprise, and/or be referred to as a common TA value (e.g., ta-Common), drift rate of a common TA (e.g., ta-CommonDrift), and/or drift rate variation of a common TA (e.g., ta-CommonDriftVariant). The common TA information may be the parameters used to derive the common TA, e.g., the TA between the satellite and a reference point. The K offset may be K_offset, K_{cell,offset}, or K_{offset}. The K offset may be a cell specific scheduling offset. The K offset may be the parameter used to derive K_{cell,offset}. The k mac may be kmac or k_{mac}. The k mac may be a satellite specific scheduling offset. The k mac may be the TA between the reference point and the gNB. The k mac may be the parameter used to derive k_{mac}.

In addition, the NW could provide RA resources and/or configuration to the UE. The NW could provide common RA resources and/or dedicated RA resources. The common RA resources may be cell-specific RA resources. The common RA resources may be provided (or configured) by system information. The common RA resources may be contention-based. The common RA resources may not be dedicated to the UE. The common RA resources may be 2-step RA or 4-step RA. The common RA resources and/or configuration may be RACH-ConfigCommon, RACH-ConfigCommonTwoStepRA. The dedicated RA resources may be provided (or configured) by an RRC reconfiguration message or a PDCCH order. The dedicated RA resources may be contention-free. The common RA resources may be dedicated to a UE. The dedicated RA resources may be 2-step RA or 4-step RA. The dedicated RA resources and/or configuration may be RACH-ConfigDedicated.

The UE would maintain a TA value for UL/DL transmission. The (full) TA value is T_{TA} as specified in TS 38.211 ([10] 3GPP TS 38.211). The T_{TA} is composed of N_{TA}, N_{TA,adj}^{common} and/or N_{TA,adj}^{UE} based on NW configuration. The N_{TA,offset} is configured by the NW, e.g., via n-TimingAdvanceOffset or a default value. The N_{TA} is indicated or adjusted by a TA command. In a Terrestrial Network (TN), the UE calculates T_{TA} with N_{TA} and N_{TA,offset}. The UE would receive N_{TA} via an RA response (e.g., RAR, MSGB) during an RA procedure. The UE would receive N_{TA} from a Timing Advance Command MAC CE in RRC connected mode. For RACH-less handover, the UE may be indicated N_{TA} as zero or identical to Primary Timing Advance Group (PTAG) via an RRC reconfiguration message (e.g., RRCConnectionReconfiguration).

In NTN, in addition to N_{TA} and N_{TA,offset}, the UE calculates/derives N_{TA,adj}^{common} and N_{TA,adj}^{UE} for T_{TA}. The N_{TA,adj}^{common} is derived from common TA information for the satellite (of a serving cell). And the N_{TA,adj}^{UE} is pre-compensated by the UE using UE location and satellite location based on ephemeris information. The N_{TA,adj}^{common} is a common TA value, a satellite specific TA value, and/or a cell specific TA value. The N_{TA,adj}^{UE} is a UE specific TA value. The UE would receive an NTN configuration and a pre-compensated TA value (e.g., T_{TA}) in NTN. The UE may calculate UE-gNB RTT as the sum of the TA value (e.g., T_{TA}) and kmac. The UE would delay the start of RA timers and/or DRX timers by UE-gNB RTT. The UE would report the TA value (e.g., T_{TA}) and/or UE location to the NW.

For non-GNSS UE in an NTN, the UE would not be able to acquire/derive its location via GNSS. And without the GNSS and the UE's location, the UE could not calculate a UE specific TA value in NTN (e.g., N_{TA,adj}^{UE}) and/or pre-compensate the TA value (e.g., T_{TA}). As a result, the UE may lose UL synchronization and may not be able to perform any transmission to the NW.

To solve the issue, a UE could use a first information provided by the NW to calculate TA parameter(s) and/or a UE specific TA value in NTN (e.g., N_{TA,adj}^{UE}). The UE may pre-compensate the TA value (e.g., T_{TA}) based on (at least) the first information. The UE may not calculate the UE specific TA value (e.g., N_{TA,adj}^{UE}) and/or pre-compensate the TA value (e.g., T_{TA}) based on GNSS position (obtained by the UE itself). The UE may not have a (valid) GNSS position. The NW could provide the first information to the UE. The first information may be related to the UE location and/or the UE specific TA. The first information may be dedicated to the UE. The first information may be the UE location. Throughout the disclosure, the following may be interchangeable: UE location, UE's location, UE position, GNSS position, GNSS location. The first information may be a UE specific TA value and/or TA parameter(s). The UE specific TA value may be, be composed of, comprise, or correspond to N_{TA,adj}^{UE},N_{TA,adj}^{common}+N_{TA,adj}^{UE}, transmission delay on the service link, T_{TA}, UE-gNB RTT, extended common TA, and/or a new TA value. The TA parameters may be used to derive and/or calculate the UE specific TA value. The first information may be derived, calculated, estimated, and/or acquired by the NW. The first information may be provided/transmitted/updated via an RRC message, MAC CE, and/or DCI. The first information may be provided/transmitted/updated during a handover procedure. The first information may be provided/transmitted/updated in RRC connected state.

To solve the issue, a UE could receive the UE location, the UE specific TA value, and/or the TA parameter(s) from the NW. The UE may not have GNSS. The UE may be a second type UE. The UE without GNSS could receive the UE location and/or the TA value from the NW.

For example, the UE may provide positioning measurements to the NW. The UE may perform UL transmission(s) to the NW, e.g., for positioning measurement, before (or after) receiving the first information from the NW. The NW may perform measurements for UE positioning, e.g., via reception of UL transmissions. The UE and/or the NW may perform positioning operation as specified in TS 38.305 ([11]3GPP TS 38.305 V 17.5.0), e.g., DL-Time Difference of Arrival (TDOA), UL-TDOA, multi-RTT. The NW may determine, derive, calculate, and/or estimate the UE location, e.g., based on a UE positioning mechanism (e.g., in TS 38.305 ([11] 3GPP TS 38.305 V 17.5.0)) and/or NW verification for the UE location (e.g., in Rel-18 NTN). The positioning operation may be triggered by the UE and/or the NW. The NW may calculate the UE specific TA value, e.g., based on the UE location. The NW may determine, derive, calculate, and/or estimate the UE location if the UE is a second type UE. The NW may determine, derive, calculate, and/or estimate the UE location if receiving a UE request and/or configuration. The NW may provide the first information to the UE based on (at least) the UL transmission(s), the positioning measurement, the positioning operation/mechanism, the UE location, and/or the UE specific TA value.

For example, the NW may provide the first information if the UE is a second type UE. The NW may provide the first information if the UE is not a first type UE. The NW may not provide the first information if the UE is a first type UE. The NW may not provide the first information if the UE is not a second type UE. The NW may provide the first information if receiving a UE request, e.g., for the first information. The NW may provide the first information if receiving a UE configuration/capability, e.g., indicating without GNSS.

For example, the NW may provide the first information to the UE for performing an RA procedure. The UE may receive the first information during (or before) an RA procedure. The UE may perform an RA procedure using the first information. The first information may be configured/provided with (dedicated) RA resources.

For example, the UE may receive the first information during a handover procedure. The first information may be configured/provided in a handover command. The first information may be configured/provided in a system information (e.g., NTN-specific system information). The first information may be configured/provided with NTN configuration (e.g., NTN-Config). The first information may be configured/provided with cell configuration.

For example, the UE may receive the first information in RRC connected mode. The first information may be configured/provided in a MAC CE (e.g., Timing Advance Command MAC CE). The first information may be related to a timer. The UE may start or restart the timer in response to receiving the first information. The NW may start or restart the timer in response to transmitting the first information. The timer may be a validity timer (e.g., T430). The timer may be a TA timer (e.g., timeAlignmentTimer). The timer may be associated to each UE. The timer may be associated to each TAG.

The UE may start or restart a TA timer (e.g., timeAlignmentTimer) when a Timing Advance Command MAC CE is received, if the first information is valid or has been received. The UE may not start or restart the TA timer (e.g., timeAlignmentTimer) if the UE does not have (valid) first information, e.g., when a Timing Advance Command MAC CE is received. The UE may stop the TA timer (e.g., timeAlignmentTimer) if the UE does not have (valid) first information, e.g., when a Timing Advance Command MAC CE is received. The UE may consider the TA timer (e.g., timeAlignmentTimer) as expired if the UE does not have (valid) first information, e.g., when a Timing Advance Command MAC CE is received.

For example, the UE may use the first information to derive, calculate, and/or estimate N_{TA,adj}^{UE}, transmission delay on the service link, T_{TA} and/or UE-gNB RTT. The UE may use the first information to pre-compensate TA. The UE may use the first information to perform UL transmission and/or measurements. The UE may use the first information on the serving cell, target cell and/or neighbor cell. The UE may use the first information to adjust the start or length of timers (e.g., ra-ResponseWindow, msgB-ResponseWindow, ra-ContentionResolutionTimer, HARQ-RTT-TimerDL-NTN, HARQ-RTT-TimerUL-NTN). The UE may use the first information to perform UL synchronization. The UE may use the first information to maintain a TA value. The UE may calculate T_{TA} based on the current formula in TS 38.211 ([10] 3GPP TS 38.211 V 17.5.0) and/or TS 38.213 ([9] 3GPP TS 38.213 V 17.5.0). The UE may calculate T_{TA} based on a new formula, e.g., specific for the second type UE.

For example, the NW may update the first information, e.g., when the last provided first information becomes invalid. The NW may update the first information based on the timer (specified above). The NW may update the first information in response to, when, or before the timer expires. The NW may update the first information based on a UE request. The UE may transmit a request and/or indication in response to, when, or before the timer expires. The UE may transmit a request and/or indication in response to an event and/or a threshold (e.g., distance threshold). The event may be based on the UE's motion and/or speed mode. The request and/or indication may be transmitted in an RRC message and/or MAC CE. The NW may update the first information when/if the UE enters, camps on, and/or links to a new cell. The NW may update the first information when/if the UE enters and/or transits/transitions to RRC connected state.

The UE may indicate (to the NW) that it requires NW assistance for calculating (or deriving) a TA parameter (e.g., N_{TA,adj}^{UE}), transmission delay, and/or UE-gNB RTT. The UE may request the NW to provide the first information (e.g., when or in response to UE movement). The NW may initiate a positioning mechanism (or operation) for the UE, e.g., in response to receiving the request (or indication). The NW may provide the first information to the UE, e.g., if the NW has received the request (or indication), and/or the NW has derived the (current) UE location and/or the first information for the UE.

For example, if the UE doesn't receive the first information, the UE may calculate (or derive) a TA parameter (e.g., N_{TA,adj}^{UE}), transmission delay, and/or UE-gNB RTT by itself (e.g., UE with GNSS). If the UE is capable of calculating (or deriving) a TA parameter (e.g., N_{TA,adj}^{UE}), transmission delay, and/or UE-gNB RTT by itself (e.g., UE with GNSS), the NW may not provide the first information to the UE. If the UE is capable of calculating (or deriving) a TA parameter (e.g., N_{TA,adj}^{UE}), transmission delay, and/or UE-gNB RTT by itself (e.g., UE with GNSS), the UE may calculate (or derive) the TA parameter (e.g., N_{TA,adj}^{UE}), transmission delay, and/or UE-gNB RTT without using the first information.

If the UE doesn't receive the first information, the UE may assume (or consider) the TA parameter (e.g., N_{TA,adj}^{UE}), transmission delay, and/or UE-gNB RTT as 0. If the UE doesn't receive the first information, the UE may not perform the pre-compensation of TA. If the UE doesn't receive the first information, the UE may not use the RA resources and/or configuration that requires the pre-compensation of TA. For example, the NW may not update the first information, e.g., for the same serving cell, for the same RRC connection. The NW may provide the first information to the UE when, after, or in response to the UE linking to a new cell and/or entering the RRC connected state. The NW may not provide another first information when the UE in the same cell and/or the same RRC connection state. The UE may receive the first information and derive T_{TA}. The NW may provide N_{TA} via MAC CE and/or an RA response after providing the first information. The UE may receive the N_{TA} and adjust T_{TA}.

The UE may (or may not) receive a TA command (e.g., Timing Advance Command MAC CE). The UE may use the TA command to derive a first TA parameter (e.g., N_{TA}). The UE may use the first information to derive a second TA parameter (e.g., N_{TA,adj}^{UE}). The first TA parameter and the second TA parameter may be different parameters. The UE may calculate a TA value (e.g., T_{TA}) based on the TA command and the first information. The UE may calculate a TA value (e.g., T_{TA}) based on the first TA parameter and the second TA parameter.

The NW may provide the first information to the UE for handover (or CHO) to a target cell. The UE may use the first information to calculate (or derive) a TA parameter (e.g., N_{TA,adj}^{UE}), transmission delay, and/or UE-gNB RTT for the target cell. The handover may not be a RACH-less HO. The handover may be a CHO. The UE may perform an RA procedure for the handover. The UE may use the first information for an RA procedure to the target cell.

For example, the UE may keep the first information when, after, and/or in response to transiting/transitioning to RRC inactive/idle state. The UE may not release or discard the first information when, after, and/or in response to transiting/transitioning to RRC inactive/idle state. The UE may release or discard the first information when, after, and/or in response to transiting/transitioning to RRC inactive/idle state.

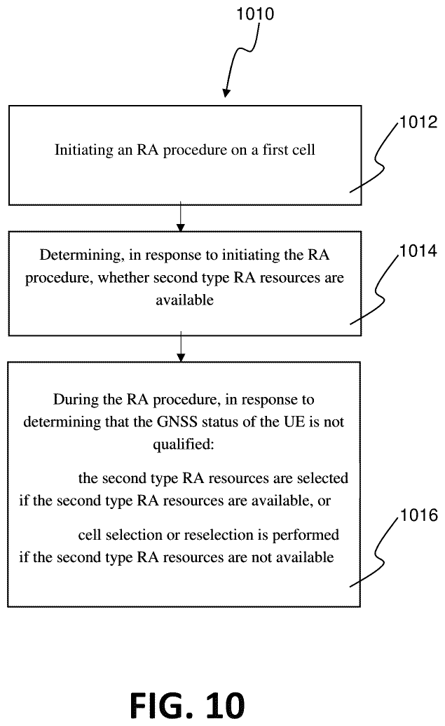

Referring to FIG. 10, with this and other concepts, systems, and methods of the present invention, a method 1010 for a UE comprises initiating an RA procedure in a first cell (step 1012), determining, in response to initiating the RA procedure, whether second type RA resources are available (step 1014), and during the RA procedure, in response to determining that the GNSS status of the UE is not qualified: the second type RA resources are selected if the second type RA resources are available, or cell selection or reselection is performed if the second type RA resources are not available (step 1016).

In various embodiments, first type RA resources are provided for the first cell.

In various embodiments, the GNSS status of the UE is not qualified if the strength of a GNSS signal is below or equal to a threshold, the GNSS signal is not available, and/or GNSS information is invalid.

In various embodiments, the cell selection or reselection is performed by at least one or more of: stopping the RA procedure, initiating an RRC re-establishment procedure, selecting a second cell, and/or initiating another RA procedure on the second cell using the second type RA resources.

In various embodiments, the method further comprises selecting, in response to determining that the GNSS status of the UE is qualified, first type RA resources or the second type RA resources.

Referring back to FIGS. 3 and 4, in one or more embodiments from the perspective of a UE, the device 300 includes a program code 312 stored in memory 310 of the transmitter. The CPU 308 could execute program code 312 to: (i) initiate an RA procedure in a first cell; (ii) determine, in response to initiating the RA procedure, whether second type RA resources are available; and (iii) during the RA procedure, in response to determining that the GNSS status of the UE is not qualified: the second type RA resources are selected if the second type RA resources are available, or cell selection or reselection is performed if the second type RA resources are not available. Moreover, the CPU 308 can execute the program code 312 to perform all of the described actions, steps, and methods described above, below, or otherwise herein.

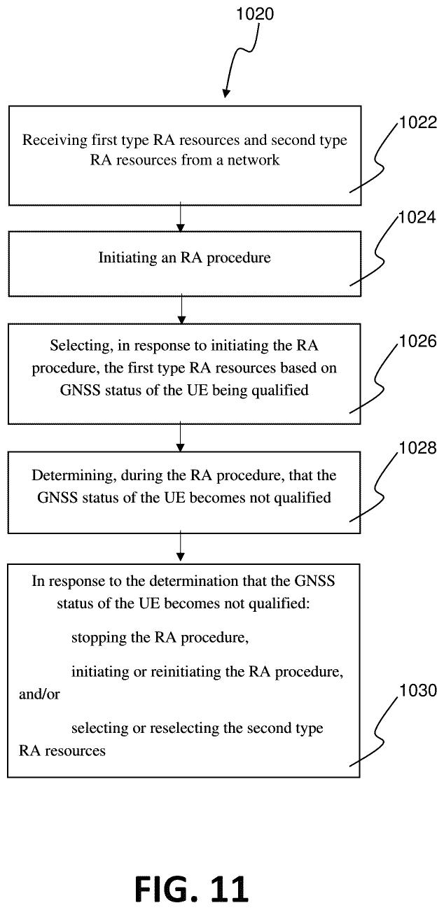

Referring to FIG. 11, with this and other concepts, systems, and methods of the present invention, a method 1020 for a UE comprises receiving first type RA resources and second type RA resources from a network (step 1022), initiating an RA procedure (step 1024), selecting, in response to initiating the RA procedure, the first type RA resources based on GNSS status of the UE being qualified (step 1026), determining, during the RA procedure, that the GNSS status of the UE becomes not qualified (step 1028), and in response to the determination that the GNSS status of the UE becomes not qualified: stopping the RA procedure, initiating or reinitiating the RA procedure, and/or selecting or reselecting the second type RA resources (step 1030).

In various embodiments, the GNSS status of the UE is not qualified if the strength of a GNSS signal is below or equal to a threshold, the GNSS signal is not available, and/or GNSS information is invalid.

In various embodiments, the determination is performed in response to transmitting a Msg1 or a MSGA.

In various embodiments, the first type RA resources are for the UE with GNSS.

In various embodiments, the second type RA resources are for the UE without GNSS.

Referring back to FIGS. 3 and 4, in one or more embodiments from the perspective of a UE, the device 300 includes a program code 312 stored in memory 310 of the transmitter. The CPU 308 could execute program code 312 to: (i) receive first type RA resources and second type RA resources from a network; (ii) initiate an RA procedure; (iii) select, in response to initiating the RA procedure, the first type RA resources based on GNSS status of the UE is qualified; (iv) determine, during the RA procedure, that the GNSS status of the UE becomes not qualified; and (v) in response to the determination that the GNSS status of the UE becomes not qualified: stopping the RA procedure, initiating or reinitiating the RA procedure, and/or selecting or reselecting the second type RA resources. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
initiating a Random Access (RA) procedure in a first cell;
determining, in response to initiating the RA procedure, whether second type RA resources are available;
during the RA procedure, in response to determining that Global Navigation Satellite System (GNSS) status of the UE is not qualified:
the second type RA resources are selected for the RA procedure if the second type RA resources are available; or
cell selection or reselection is performed if the second type RA resources are not available.

2. The method of claim 1, wherein first type RA resources are provided for the first cell.

3. The method of claim 1, wherein the GNSS status of the UE is not qualified if the strength of a GNSS signal is below or equal to a threshold, the GNSS signal is not available, and/or GNSS information is invalid.

4. The method of claim 1, wherein the cell selection or reselection is performed by at least one or more of:
stopping the RA procedure;
initiating an RRC re-establishment procedure;
selecting a second cell; and/or
initiating another RA procedure on the second cell using the second type RA resources.

5. The method of claim 1, further comprising:
selecting, in response to determining that the GNSS status of the UE is qualified, first type RA resources or the second type RA resources for the RA procedure.

6. A method for a User Equipment (UE), comprising:
receiving first type Random Access (RA) resources and second type RA resources from a network;
initiating an RA procedure;
selecting, in response to initiating the RA procedure, the first type RA resources based on Global Navigation Satellite System (GNSS) status of the UE being qualified;
determining, during the RA procedure, that the GNSS status of the UE becomes not qualified; and
in response to the determination that the GNSS status of the UE becomes not qualified:
stopping the RA procedure;
initiating or reinitiating the RA procedure; and/or
selecting or reselecting the second type RA resources.

7. The method of claim 6, wherein the GNSS status of the UE is not qualified if the strength of a GNSS signal is below or equal to a threshold, the GNSS signal is not available, and/or GNSS information is invalid.

8. The method of claim 6, wherein the determination is performed in response to transmitting a Msg1 or a MSGA.

9. The method of claim 6, wherein the first type RA resources are for the UE with GNSS.

10. The method of claim 6, wherein the second type RA resources are for the UE without GNSS.

11. A User Equipment (UE), comprising:
a memory; and
a processor operatively coupled with the memory, wherein the processor is configured to execute a program code to:
initiate a Random Access (RA) procedure in a first cell;
determine, in response to initiating the RA procedure, whether second type RA resources are available;
during the RA procedure, in response to determining that Global Navigation Satellite System (GNSS) status of the UE is not qualified:
the second type RA resources are selected for the RA procedure if the second type RA resources are available; or
cell selection or reselection is performed if the second type RA resources are not available.

12. The UE of claim 11, wherein first type RA resources are provided for the first cell.

13. The UE of claim 11, wherein the GNSS status of the UE is not qualified if the strength of a GNSS signal is below or equal to a threshold, the GNSS signal is not available, and/or GNSS information is invalid.

14. The UE of claim 11, wherein the cell selection or reselection is performed by at least one or more of:
stopping the RA procedure;
initiating an RRC re-establishment procedure;
selecting a second cell; and/or
initiating another RA procedure on the second cell using the second type RA resources.

15. The UE of claim 11, wherein the processor is further configured to execute the program code to:
select, in response to determining that the GNSS status of the UE is qualified, first type RA resources or the second type RA resources for the RA procedure.
